(19) United States
(12) Patent Application Publication
(10) Pub. No.: US 2024/0263273 A1
(43) Pub. Date: Aug. 8, 2024

(54) PRECIPITATION OF METALS

(71) Applicant: Pure Battery Technologies Pty Ltd, Brisbane, Queensland (AU)

(72) Inventors: William HAWKER, Brisbane, Queensland (AU); James William VAUGHAN, St Lucia, Queensland (AU); Harrison Michael HODGE, Brisbane, Queensland (AU); Weng FU, St Lucia, Queensland (AU); David Andrew MANN, St Lucia, Queensland (AU)

(21) Appl. No.: 18/548,723

(22) PCT Filed: Mar. 2, 2022
(86) PCT No.: PCT/AU2022/050167

§ 371 Date: Sep. 1, 2023

(30) Foreign Application Priority Data
Mar. 2, 2021 (AU) 2021900570
Mar. 2, 2021 (AU) 2021900571

(51) Int. Cl. C22B 3/00; C01G 53/00; C22B 3/22; C22B 3/42; C22B 7/00; C22B 47/00; H01M 10/54

(52) U.S. Cl. CPC C22B 23/0461; C01G 53/44; C22B 3/22; C22B 3/42; C22B 7/007; C22B 23/0415; C22B 47/00; H01M 10/54; C01P 2002/50; C01P 2006/40; C01P 2006/80

(57) ABSTRACT

The present invention relates, inter alia, to a method of producing a co-precipitate comprising nickel, manganese and/or cobalt, and to a co-precipitate produced by the method. The method may be a method of producing a co-precipitate comprising at least two metals selected from nickel, cobalt and manganese, and comprise: (i) providing an aqueous feed solution comprising said at least two metals and at least one impurity; and (ii) adjusting the pH of the feed solution to between about 6.2 and about 11, so as to provide: (a) a co-precipitate comprising said at least two metals; and (b) a supernatant comprising said at least one impurity.

### CROSS REFERENCE

The present application claims priority to Australian Provisional Patent Application No. 2021900570, filed 2 Mar. 2021, and to Australian Provisional Patent Application No. 2021900571, filed 2 Mar. 2021; the contents of these applications are incorporated herein by reference in their entirety.

### TECHNICAL FIELD

In one embodiment, the present invention relates to a method of producing a co-precipitate comprising nickel, manganese and/or cobalt, and to a co-precipitate produced by the method. In another embodiment, the present invention relates to a method of dissolving metals from a mixture for subsequent use in producing a co-precipitate.

### BACKGROUND ART

It will be clearly understood that, if a prior art publication is referred to herein, this reference does not constitute an admission that the publication forms part of the common general knowledge in the art in Australia or in any other country.

Lithium ion batteries make up a significant proportion of worldwide total portable battery sales, and battery sales more generally. Their high energy density, long lifespan and light weight frequently make them the battery of choice for diverse applications including electric vehicles, e-bikes and other electric powertrains, and power tools. A particularly common combination of active materials in such batteries is Nickel-Manganese-Cobalt, also called NMC (or NCM) materials. Different ratios of nickel, manganese and cobalt are used in different types of lithium ion batteries. The batteries can also use just one of these elements or combinations of any two of these three, or combinations of one, two or three of these elements with one or more additional elements such as aluminium and magnesium. Different ratios of all of these elements are used in different types of lithium ion batteries.

NMC material for a battery is typically produced by taking separate, highly pure, individual salts of nickel, cobalt and manganese and dissolving them all into a solution at specific ratios and purities. A precipitation process is then carried out on that solution so that the three metals co-precipitate as hydroxides, carbonates or hydroxy-carbonates. This is widely considered to be the only way to achieve the high purity precursor product composition required for acceptable electrochemical performance. A disadvantage of this procedure, however, is that impurity elements must be removed from the nickel, cobalt and manganese feed materials in order to use the nickel, cobalt and manganese in the production of battery material. For example, NMC material may require a purity level on the order of 150,000 moles of NMC to 1 mole of the impurity element. An exemplary nickel sulfate for use in batteries has, for example, 5 ppm or less of impurities such as copper, iron, cadmium, zinc and lead. Consequently, multiple separation and purification steps are required to produce the pure salts of nickel, cobalt and manganese, which can be intensive in time and materials (and therefore also cost).

Nickel ore deposits typically have a natural nickel:cobalt ratio in the range of 10:1 to 100:1, and consequently the relative proportions of nickel, cobalt and manganese in such deposits generally require modification before NMC materials can be produced. Nickel ore deposits also typically include a range of other minerals including for example iron, magnesium and silicate minerals and would therefore require significant processing before they can be used to produce NMC materials.

Another potential source of nickel, cobalt and manganese is from used lithium ion batteries. The disposal of lithium ion batteries is becoming an increasing concern from both an economic and environmental standpoint as the markets for the batteries expand. Environmentally, the spent batteries contain high concentrations of metals such as nickel, cobalt and manganese, as well as volatile fluorine containing electrolyte. With the growing demand for lithium ion batteries, and a greater push towards recycling of materials, there is an ever increasing need to find better methods for recovering the NMC materials from the cathode active material (CAM or black mass) of spent lithium ion batteries in sufficient purity to enable them to be recycled for use in new lithium ion batteries.

Lithium ion batteries typically have five major components: the casing, the electrolyte, the separator, the anode and the cathode. The casing is typically a steel shell which houses all other components and is of low economic value. The electrolyte is used to carry charge through the battery and is made of a lithium containing salt (typically lithium hexafluorophosphate or lithium tetrafluoroborate) dissolved in an aprotic organic solvent. The separator is typically a polymer membrane that separates the anode and cathode half-cells of the battery. Lithium ion batteries typically have a graphite anode which is connected to a copper current collector. The majority of the battery value comes from the cathode. Modern lithium ion batteries have a cathode coated with an electrochemically active lithium compound containing cobalt oxide or mixtures of nickel, cobalt and manganese (NMC). This cathode material is typically mixed with graphite and is adhered using a binder to an aluminium current collector.

Various conditions have been trialled to recover NMC materials from the cathode active material, but it is challenging to recover the nickel, cobalt and manganese, without also recovering a significant amount of undesired impurities. The vast majority of NMC material recycling attempts to date have had the aim of producing separate salts of nickel, cobalt and manganese for further use, or highly purified solutions for further use.

Some battery applications may also require use of materials that include only two of nickel, cobalt and manganese, for example, and the above considerations would also apply to such materials.

### SUMMARY OF INVENTION

In one embodiment, the present invention seeks to provide a method of producing a co-precipitate comprising at least two of nickel, manganese and cobalt, which may at least partially overcome or substantially ameliorate at least one of the abovementioned disadvantages or provide the consumer with a useful or commercial choice. Said co-precipitate may be suitable for preparation of lithium ion batteries. In another embodiment, the present invention seeks to provide a precursor for use in preparation of lithium ion batteries, for example a precipitate of one or two or all three of nickel, manganese and cobalt, which may be suitable for subsequent use in preparing an NMC material (especially a cathode active NMC material) or a material (especially a cathode active material) comprising at least two of nickel, manganese and cobalt. In another embodiment, the present invention seeks to provide a method of producing a solution which may (potentially after further processing) be suitable for use in generating a co-precipitate comprising nickel, manganese and cobalt, or which may at least partially overcome or substantially ameliorate at least one of the abovementioned disadvantages or provide the consumer with a useful or commercial choice.

According to a first aspect of the present invention there is provided a method of producing a co-precipitate comprising at least two metals selected from nickel, cobalt and manganese, the method comprising:
(i) providing an aqueous feed solution comprising said at least two metals; and
(ii) adjusting the pH of the feed solution to between about 6.2 and about 11, optionally between about 6.2 and about 10 or between about 6.2 and about 9.2, so as to co-precipitate said at least two metals from the feed solution.

The following options and embodiments may be used in conjunction with the first aspect, either individually or in any suitable combination.

The aqueous feed may comprise at least one impurity. Accordingly, the step of adjusting the pH of the feed solution may provide a supernatant which comprises said at least one impurity. Therefore, in one embodiment of the first aspect there is provided a method of producing a co-precipitate, wherein the co-precipitate comprises at least two metals selected from nickel, cobalt and manganese, the method comprising:
(i) providing an aqueous feed solution comprising said at least two metals and at least one impurity; and
(ii) adjusting the pH of the feed solution to between about 6.2 and about 11, optionally between about 6.2 and about 10 or between about 6.2 and about 9.2, so as to provide: (a) a co-precipitate comprising said at least two metals; and (b) a supernatant comprising said at least one impurity.

In one embodiment the method is a method of producing a co-precipitate, wherein the co-precipitate comprises at least two metals selected from nickel, cobalt and manganese, the method comprising:
(i) providing an aqueous feed solution comprising said at least two metals and at least one impurity, wherein said at least one impurity is selected from the group consisting of: arsenic, aluminium, barium, cadmium, carbon, calcium, magnesium, chromium, copper, lead, silicon, vanadium, lanthanum, lanthanides, actinium, actinides, titanium, scandium, iron, zinc, zirconium, silver, tungsten, molybdenum, platinum, rubidium, tin, antimony, selenium, bismuth, boron, yttrium, and niobium or a combination thereof; and
(ii) adjusting the pH of the feed solution to between about 6.2 and less than 10, so as to provide: (a) a co-precipitate comprising said at least two metals; and (b) a supernatant comprising said at least one impurity.

In one embodiment, the pH of the feed solution is adjusted to between about 6.2 and 11, or between about 6.2 and less than 11, or between about 6.2 and 10, or between about 6.2 and less than 10, or between about 6.2 and 9.2, or between about 6.2 and 8.5 or between about 6.2 and 7.5.

In one embodiment, the total amount of the at least two metals (or the total amount of nickel, cobalt and manganese) in the aqueous solution is less than 95%, especially less than 90%, or less than 85%, or less than 80%, or less than 75%, or less than 70%, or less than 65%, or less than 60%, or less than 55% or less than 50% of the total weight of the aqueous solution (especially the dry solids in the aqueous solution). In one embodiment, the total amount of metal complexes comprising the at least two metals (or the total amount of metal complexes comprising nickel, cobalt and manganese) in the aqueous solution is less than 95%, especially less than 90%, or less than 85%, or less than 80%, or less than 75%, or less than 70%, or less than 65%, or less than 60%, or less than 55% or less than 50% of the total weight of the dry solids in the aqueous solution. As used herein, the term “metal complexes” may include sulfates of nickel, cobalt or manganese, for example. In one embodiment, the total amount of the at least two metals (or the total amount of nickel, cobalt and manganese) in the aqueous solution is more than 1 ppb, especially more than 1 ppm, or more than 10 ppm, or more than 100 ppm, or more than 1,000 ppm, or more than 2,000 ppm, or more than 5,000 ppm, or more than 10,000 ppm, or more than 20,000 ppm or more than 50,000 ppm of the aqueous solution.

In this specification, reference to “metal” or to specific metals (e.g. nickel, cobalt or manganese) does not necessarily imply that they are in metallic (i.e. oxidation state 0) form. Such references include all possible oxidation states of the metal, including salts of the metal, unless the context indicates otherwise.

As used herein, the “at least one impurity” (which may be “at least one precipitation impurity”) is not nickel, cobalt, manganese, water, OH⁻, H⁺, H₃O⁺, sulfate or carbonate. However, in one embodiment, the at least one impurity is not a nickel, cobalt or manganese complex with an anion (such as a sulfate, carbonate or hydroxy-carbonate). In one embodiment, the at least one impurity is selected from the group consisting of arsenic, aluminium, barium, cadmium, carbon, calcium, magnesium, chromium, copper, lead, silicon, sodium, lithium, potassium, phosphorous, tetrafluoroborate, hexafluorophosphate, vanadium, lanthanum, ammonium, sulphite, fluorine, fluoride, chloride, titanium, scandium, iron, zinc, and zirconium, or a combination thereof. In one embodiment, the at least one impurity is selected form the group consisting of: arsenic, aluminium, barium, cadmium, carbon, calcium, magnesium, chromium, copper, lead, silicon, sodium, lithium, potassium, phosphorous, tetrafluoroborate, hexafluorophosphate, vanadium, lanthanum, lanthanides, actinium, actinides, titanium, ammonium, sulphite, fluorine, fluoride, chloride, scandium, iron, zinc and zirconium, silver, tungsten, vanadium, molybdenum, platinum, rubidium, tin, antimony, selenium, bismuth, boron, yttrium, lead, niobium or a combination thereof; especially arsenic, aluminium, barium, cadmium, carbon, calcium, magnesium, chromium, copper, lead, silicon, vanadium, lanthanum, lanthanides, actinium, actinides, titanium, scandium, iron, zinc, zirconium, silver, tungsten, molybdenum, platinum, rubidium, tin, antimony, selenium, bismuth, boron, yttrium, and niobium or a combination thereof. In one embodiment, the at least one impurity comprises or is: (i) calcium and/or magnesium; (ii) an alkaline earth metal; (iii) a metal or metalloid species (not including alkali metals); (iv) a metal or metalloid species not including alkali metals or anionic species (such as sulphate, sulphite, chloride, fluoride, nitrate and phosphate); or (v) a metal or metalloid species not including anionic species (such as sulphate, sulphite, chloride, fluoride, nitrate and phosphate).

In one embodiment, the at least one impurity is at least two impurities, or at least three impurities, or at least four impurities or at least five impurities, or at least six impurities. Such impurities may be as discussed in this specification.

In one embodiment, at least 1% of said at least one impurity, or at least 5%, or at least 10%, or at least 20%, or at least 30%, or at least 40%, or at least 50% of said at least one impurity, especially at least 60%, or at least 65%, or at least 70%, or at least 75% or at least 80%, or at least 85%, or at least 90%, or at least 95%, or at least 96%, or at least 97%, or at least 98% or at least 99% of said at least one impurity in the aqueous feed solution of step (i) or step (ii) may be in the supernatant after the co-precipitation, or in a wash solution after the co-precipitate is washed, or in the combination of both the supernatant and the wash solutions. The at least one impurity may be a combination of impurities. The amount of each impurity in the aqueous feed solution that may pass to the supernatant can be different for each impurity.

In one embodiment, the molar ratio (or mass ratio) in the aqueous feed solution of the at least two metals to the at least one impurity (or the at least one precipitation impurity) (or the molar ratio (or mass ratio) in the aqueous feed solution of the at least two metals to the total impurities) is less than 300,000,000:1, or less than 200,000,000:1, or less than 100,000,000:1, or less than 10,000,000:1, or less than 1,000,000:1 or less than 500,000:1, or less than 250,000:1, or less than 200,000:1, or less than 100,000:1 or less than 50,000:1, or less than 10,000:1, or less than 5,000:1, or less than 1,000:1, or less than 500:1, or less than 200:1, or less than 100:1, or less than 50:1, or less than 25:1, or less than 10:1, or less than 1:1 or less than 1:10. The molar ratio (or mass ratio) in the aqueous feed solution of the at least two metals to the at least one impurity (or the molar ratio (or mass ratio) in the aqueous feed solution of the at least two metals to the total impurities) may be at least about 2,000,000:1, or at least about 1,000,000:1, or at least about 100,000:1, or at least about 60,000:1, or at least about 30,000:1, or at least about 20,000:1, or at least about 10,000:1, or at least about 5,000:1 or at least about 1,000:1 or at least about 500:1, or at least about 200:1, or at least about 100:1, or at least about 50:1, or at least about 10:1. This refers to the sum of the molar amounts (or mass amounts) of the at least two metals, but may refer to any one of the at least one impurity or may refer to the sum of the molar amounts (or mass amounts) of all such impurities. At least one, optionally more than one, possibly all, of the impurities may be selected from the group consisting of calcium, magnesium, lithium, sodium, potassium and ammonium. In one embodiment, the at least one impurity in the aqueous feed is selected from the group consisting of: calcium, magnesium, iron, aluminium, copper, zinc, lead, sulfur, sodium, potassium, ammonium and lithium.

It should be understood that reference herein to a metal does not imply that the metal is in the 0 oxidation state unless the context indicates such. For example, reference to nickel may, depending on context, refer to any or all of Ni(0), Ni(II) and Ni(III). In one embodiment, the at least two metals selected from nickel, cobalt and manganese is all of nickel, cobalt and manganese. The nickel, cobalt and manganese may in any suitable oxidation state. In one embodiment, the at least two metals are selected from Ni(II), Co(II) and Mn(II).

In some embodiments, the feed solution of step (i) may be at a pH of less than 7.0, or less than 6.75, or less than 6.5, or less than 6.25, or less than 6.2, or less than 6.0, or less than 5.75, 5.50, 5.25, 5.0, 4.75, 4.50, 4.25, 4.0, 3.75, 3.50, 3.25, 3.0, 2.75, 2.50 or 2.0. The feed solution of step (i) may be at a pH of more than 2.0, or more than 2.25, 2.50, 2.75, 3.0, 3.25, 3.50, 3.75, 4.0, 4.25, 4.50, 4.75, 5.0, 5.25, 5.50, 5.75, 6.0, or 6.2. In certain embodiments, the feed solution of step (i) may be at a pH of from 1.0 to 4.0, 2.0 to 4.0, 4.0 to 6.0, 2.0 to 3.0, 3.0 to 4.0, 4.0 to 5.0 or 5.0 to 6.0, or 6.0 to 7.0. In some embodiments, the feed solution of step (i) may be at a pH of from 1.0 to 1.5, 1.5 to 2.0, 2.0 to 2.5, 2.5 to 3.0, 3.0 to 3.5, 3.5 to 4.0, 4.0 to 4.5, 4.5 to 5.0, 5.0 to 5.5, or 5.5 to 6.0, or 6.0 to 6.5, or 6.5 to 7.0. The pH of the feed solution of step (i) may be from about 2.5 to 3.5. It may be about 3.0.

The aqueous feed solution may be a leachate comprising at least two metals selected from nickel, cobalt and manganese. Step (i) may comprise producing the feed solution. It may comprise producing a leachate by a method in the present specification. In one embodiment the feed solution may be the leachate or the leachate may be used to provide the aqueous feed solution. In this embodiment the term “used to provide the aqueous feed solution” may mean that the leachate is used directly as the aqueous feed solution, or it may mean that the leachate is further processed or treated, and the subsequently processed or treated solution is aqueous feed solution of step (i).

Accordingly in an embodiment of the present invention prior to step (i) the method may comprise (or step (i) may comprise) the following steps:
A. providing a feed mixture comprising at least one metal selected from nickel, cobalt and manganese, said feed mixture being one of an oxidised feed, a reduced feed or an unoxidized feed, wherein:
   an oxidised feed has more of the at least one metal in an oxidation state greater than 2 than in an oxidation state less than 2;
   a reduced feed has more of the at least one metal in an oxidation state less than 2 than in an oxidation state greater than 2 or has substantially all of the at least one metal in an oxidation state of 2 and at least some of the at least one metal in the form of their sulfide; and
   an unoxidized feed has substantially all of the at least one metal in an oxidation state of 2 and substantially none of the at least one metal in the form of their sulfide;
B. treating the feed mixture with an aqueous solution to form a leachate comprising said at least one metal, wherein the pH of the aqueous solution is such that the leachate has a pH of between about −1 and about 7 (or between about −1 and about 6; or between about 1 and about 7, or between about 1 and about 6) and wherein:
   if the feed mixture is an oxidised feed, the treating additionally comprises adding a reagent which comprises a reducing agent; and
   if the feed mixture is a reduced feed, the treating additionally comprises adding a reagent which comprises an oxidising agent;
      whereby the leachate comprises the at least one metal in an oxidation state of 2.

In this embodiment, the phrase “has more of” (e.g. in the phrase “an oxidised feed has more of the at least one metal in an oxidation state greater than 2 than in an oxidation state less than 2”) should be taken as ‘has a greater molar concentration of”. The term “substantially all of” may refer to at least 90%, or at least 95% or at least 99% or at least 99.5% or at least 99%, each being on a molar basis. The various options and embodiments described below may be used either individually or in any suitable combination.

In one embodiment, the at least one metal may be at least two metals.

In one embodiment, step (i) comprises: providing a feed mixture comprising the at least two metals, said feed mixture being one of an oxidised feed, a reduced feed or an unoxidized feed, wherein:
an oxidised feed has more of the at least two metals in an oxidation state greater than 2 than in an oxidation state less than 2;
a reduced feed has more of the at least two metals in an oxidation state less than 2 than in an oxidation state greater than 2 or has substantially all of the at least two metals in an oxidation state of 2 and at least some of the at least two metals in the form of their sulfide; and
an unoxidized feed has substantially all of the at least two metals in an oxidation state of 2 and substantially none of the at least two metals in the form of their sulfide;
treating the feed mixture with an aqueous solution to form a leachate comprising said at least two metals, wherein the pH of the aqueous solution is such that the leachate has a pH of between about −1 and about 6 (or between about 1 and about 6) and wherein:
if the feed mixture is an oxidised feed, the treating additionally comprises adding a reagent which comprises a reducing agent; and if the feed mixture is a reduced feed, the treating additionally comprises adding a reagent which comprises an oxidising agent;
whereby the leachate comprises the at least two metals in an oxidation state of 2,
so as to provide the aqueous feed solution, said aqueous feed solution being the leachate.

Examples of oxidised feeds as defined above may include mixtures of Ni(II), Co(III) and Mn(0) in a molar ration of 5:2:1 or of Ni(III), Co(II) and Mn(III) in a ratio of 2:1:1 or of Ni(II) and Mn(III) in any ratio with no Co present. Examples of a reduced feed as defined above may include mixtures of Ni(II), Co(II) and Mn(II)S in any ratio, or of Ni(0), Mn(II) and Co(II) in a molar ratio of 5:2:1. It should be noted that in the present specification the oxidation state (II) may be referred to as an oxidation state of 2, or of +2 and these are used interchangeably. In one embodiment, the leachate comprises Co(II), Mn(II) and Ni(II).

In one embodiment, a nickel, cobalt and/or manganese laterite ore would typically be considered an oxidised feed. In another embodiment, a mixed hydroxide precipitate, a mixed carbonate precipitate, or an oxide or carbonate of nickel, cobalt and/or manganese would typically be considered to be an oxidised feed or an unoxidized feed. In one embodiment, nickel and/or cobalt sulfide ores or concentrates would typically be considered a reduced feed. In another embodiment, a mixed sulfide precipitate would typically be considered a reduced feed. In another embodiment, ferronickel, nickel pig iron and nickel, cobalt and/or manganese metal alloys would typically be considered a reduced feed. In a further embodiment, a recycled material from a lithium ion battery would typically be considered an oxidised feed.

In an embodiment the mixture comprises nickel, cobalt and manganese, whereby the aqueous solution comprises nickel, cobalt and manganese. In another embodiment one of these metals is not present in the mixture, whereby the aqueous solution comprises two of nickel, cobalt and manganese and not the other.

In an embodiment the feed mixture is an oxidised feed, and the reagent comprises a reducing agent. In another embodiment the feed mixture is a reduced feed and the reagent comprises an oxidising agent. In a further embodiment the feed mixture is an unoxidized feed and no reducing agent or oxidising agent is used.

Previously published processes employ a 4 M sulfuric acid solution for a leaching step, which is a very strong acid with a pH of below 0. This is an extremely corrosive acid and would lead to a significant dissolution of impurity elements including iron, aluminium and copper. If elements such as iron and aluminium are dissolved, this consumes more acid at a leaching stage, and their separation and/or removal in the precipitation or other impurity separation and/or removal stages would consume more base or other reagents.

In contrast, the leaching step described above comprises treating the mixture in an aqueous solution at a pH of from about 1 to about 7 or from about 1 to about 6 (a pH 1 solution of sulfuric acid is equivalent to about 0.05 M sulfuric acid). At this less acidic pH dissolution of iron, aluminium and to a lesser extent copper will be less favourable. Conversely, the nickel, cobalt and manganese are all soluble below a pH of about 6 when they are in their +2 oxidation state. Use of this step provides a surprisingly effective and cost effective method to prepare a solution suitable to co-precipitate at least two of Ni, Mn and Co with improved purity when compared to prior art approaches which utilise more acidic conditions. It should be noted that the skilled person can readily determine by routine experiment and/or theory the amount and concentration of a particular acid required to achieve a target pH.

The mixture may be a solid mixture. It may be a mixture in which at least a portion of the nickel, manganese and cobalt are in solid form (for example a slurry). In one embodiment, the mixture is a mixed hydroxide precipitate (or “MHP”). MHP is a solid mixed nickel-cobalt hydroxide precipitate which is a known intermediate product in the commercial processing of nickel containing ores. The MHP may be derived from a sulfide nickel ore, or a lateritic nickel ore. Such an MHP may provide an oxidised feed. This is because at least a small portion of the manganese and cobalt in the MHP may be in an oxidised form. The MHP may be derived from a crude recycling process or any nickel and cobalt containing aqueous solution.

In one embodiment, the mixture is a product (commonly a solid residue) obtained from the Selective Acid Leach (SAL) process disclosed in PCT/AU2012/000058, in which pH and the amount of oxidant is controlled to selectively dissolve at least a portion of nickel in a solution. In this process the amount of oxidant is typically to oxidise at least a portion of cobalt and/or manganese to Co(III). Consequently, use of this process would typically provide an oxidised feed. In the SAL process a MHP is used, as discussed above.

Therefore, in one embodiment, prior to the treating, the method includes the steps of:
(a) Contacting an MHP comprising the at least two metals with an acidic solution (which may comprise an oxidant), at a pH to cause one of said metals (especially cobalt) to be stabilised in the solid phase and dissolve another of said metals in the acidic solution; and
(b) Separating the solid phase from the acidic solution, wherein the solid phase comprises the at least two metals, wherein the solid phase forms at least part of the feed mixture.

In a specific form of this embodiment, these steps comprise:
(a) Contacting an MHP comprising at least nickel and cobalt, and optionally also manganese, with an acidic solution (which may comprise an oxidant), at a pH to cause the cobalt to be stabilised in the solid phase and dissolve nickel in the acidic solution; and
(b) Separating the solid phase from the acidic solution, wherein the solid phase comprises the at least two metals, one of which is cobalt; wherein the solid phase forms at least part of the feed mixture.
   In this embodiment, the solid phase comprising said at least two metals may be the feed mixture.

In one embodiment, the MHP is washed prior to step (a). The MHP may be treated with oxidant in the washing step.

In one embodiment the feed mixture comprises cobalt and nickel and step A comprises the steps of
(a) Contacting a mixed hydroxide precipitate and/or mixed carbonate precipitate comprising at least cobalt and nickel with an acidic solution comprising an oxidant at a pH to cause cobalt to be stabilised in the solid phase and dissolve nickel in the acidic solution; and
(b) Separating the solid phase from the acidic solution, wherein the solid phase comprises the at least two metals, one of which is cobalt; wherein the solid phase forms at least part of the feed mixture.

In one embodiment, the cobalt is stabilised in the solid phase in the form of Co(III). In one embodiment, the manganese is stabilised in the solid phase of step (a) in the form of Mn(III).

The pH of the acidic solution in step (a), or of the aqueous solution, or of the leachate, may be from about 1 to about 6, or from about 2 to 6, 2 to 5, 2 to 4,2 to 3, 3 to 5, 3 to 6, 4 to 6 or 4 to 5, for example about 1, 1.5, 2, 2.5, 3, 3.5, 4, 4.5, 5, 5.5 or 6. The pH of step (a) may be the terminal pH at the end of step (a). The pH of step (a) may be the pH throughout step (a).

The oxidant in step (a) or in step B may be selected from the group consisting of persulfates, peroxides, permanganates, perchlorates, ozone, mixtures containing oxygen and sulfur dioxide, oxides and chlorine; for example sodium or potassium persulfate, sodium or potassium permanganate, ozone, magnesium or hydrogen peroxide, chlorine gas or sodium or potassium perchlorate. It may be a persulfate or a permanganate. It may be sodium or potassium persulfate, sodium or potassium peroxyhydrogendisulfate or sodium or potassium permanganate.

In one embodiment of step (a), between about 70% and about 500% stoichiometric equivalents of oxidant to combined moles of the metals which are stabilised in the solid phase, e.g. cobalt and manganese, are added; for example between about 80% and 400%; between 80% and 200%, or 100% to 150%, for example about 70, 80, 90, 100, 110, 120,125, 130, 140, 150, 200, 250, 300, 350, 400, 450 or 500%.

The temperature of step (a) may be greater than about 20° C. but less than about 120° C., or greater than about 50° C. but less than about 100° C., or from about 60° C. to about 90° C. It may be about 25, 30, 40, 50, 60, 70, 80, 90, 95, 100, 105, 110 or 115° C.

In step (b), the separating step may be a step of filtration.

In one embodiment, the method may comprise a step of removing impurities from the feed mixture, which comprises the at least two metals selected from nickel, cobalt and manganese, prior to said treating. The method may comprise contacting a mixture (or a precursor) comprising said at least one metal (or said at least two metals) with a weak acid leach solution (which may be to provide at least a part of the feed mixture). The weak acid leach solution may be at a concentration of from about 0.005M to about 0.5M acid, or about 0.01M to 0.3M, 0.01M to 0.1M, 0.02M to 0.08M, 0.03M to 0.07M, 0.04M to 0.06M, or 0.05M to 0.1M acid, for example about 0.01, 0.02, 0.05, 0.1, 0.2, 0.3, 0.4 or 0.5M acid. The acid in the weak acid leach solution may be an inorganic acid or it may be an organic acid. The inorganic acid may be selected from the group consisting of sulfuric acid, hydrochloric and nitric acid. The organic acid may be selected from acetic or formic acid. Other acids may also be suitable. The acid in the weak acid leach solution may be sulfuric acid.

Step (a) may be performed at any suitable pressure, commonly atmospheric pressure. Step (a) may provide a slurry. The slurry may have from about 1 wt % solids to about 40 wt % solids, or from about 5 wt % solids to about 40 wt % solids, or from about 10 wt % solids to about 30 wt % solids, for example about 1, 5, 10, 15, 20, 25, 30, 35 or 40 wt % solids.

After step (a), the solids may be separated from the liquid, for example by filtration. The solids may be used as the feed mixture in step B. Step (a) may be useful to remove and/or separate impurities selected from the group consisting of one or more of calcium, magnesium and zinc. It may additionally or alternatively remove and/or separate other impurities.

In another embodiment, the feed mixture is a product derived from, or obtained from a lithium ion battery, especially from cathode material from a lithium ion battery. It may be from recycled NMC materials. It may have a combined amount of nickel, cobalt and manganese of greater than about 1% by weight on a dry basis, or of greater than about 2, 3, 4, 5, 10, 20, 30, 40, 50 or 60% by weight. It may comprise nickel at greater than about 0.1% by weight on a dry basis, or greater than about 0.2, 0.3, 0.4, 0.5, 1, 2, 3, 4, 5, 10, 20, 30 or 35% by weight. It may comprise cobalt at greater than about 0.10% by weight on a dry basis, or greater than about 0.2, 0.3, 0.4, 0.5, 1, 2, 3, 4, 5, or 10% by weight. It may include manganese at greater than about 0.1% by weight on a dry basis, or greater than about 0.2, 0.3, 0.4, 0.5, 1, 2, 3, 4, 5, 10 or 15% by weight.

Consequently, in another embodiment, prior to said treating, the method may comprise the steps of separating the cathode material from a discharged lithium ion battery. The separating step may comprise shredding or crushing the battery. The separating step may comprise removing the casing of the lithium ion battery. The separating step may comprise separating the casing, electrolyte, anode and cathode. The separated cathode material may form the mixture to be treated, or the mixture to be treated may be derived from the separated cathode material in the method of the first aspect.

When a cathode material is made, the cathode is calcined, which causes the nickel, cobalt and manganese to be oxidised. Consequently, once the cathode is used and recycled, the spent cathode material is in a very similar chemical state to the SAL process residue. Therefore, the spent cathode material may be used in the method of the first aspect of the present invention.

In one embodiment, the mixture to be treated may be a product (especially a solid residue) obtained from the Selective Acid Leach (SAL) process disclosed in PCT/AU2012/000058 (as described above); a product from a recycled lithium ion battery; a product from recycled NMC materials; or a combination thereof.

In one embodiment, the feed is a mixture. In another embodiment, it is a filter cake, for example a moist filter cake. In another embodiment it is a slurry. The slurry may have from about 1 wt % solids to about 40 wt % solids, or from 5 wt % solids to about 40 wt % solids, or from about 10 wt % solids to about 30 wt % solids, for example about 5, 10, 15, 20, 25, 30, 35 or 40 wt % solids.

In the method of the above embodiment with steps A and B, at least a portion of the at least one metal (or the at least two metals) selected from nickel, cobalt and/or manganese in the feed mixture may be in an oxidised state, i.e. in an oxidation state greater than 2. As discussed above, a large proportion of the nickel, manganese and cobalt that is present in the solid residue obtained from the SAL process may be in an oxidised state. Due to the poor solubility associated with these oxidised metal components, the solubility of these metals in an aqueous solution at a pH of from about 1 to about 6 can be significantly improved through treatment with a reducing agent. The cobalt, manganese and nickel which have been thereby reduced to an oxidation state of 2 may be selectively dissolved in the aqueous solution, relative to one or more impurities (or leach impurities) in the solution.

In one embodiment, at least about 5%, 10%, 20%, 30%, 40%, 50% or 60% of the at least one metal (or the at least two metals) selected from cobalt, manganese and nickel in the feed mixture that is treated is in an oxidised state.

Oxidised forms of cobalt may comprise Co(III) and/or Co(IV); especially Co(III). Oxidised forms of manganese may comprise one or more of Mn(III), Mn(IV) and Mn(V); commonly Mn(III). Oxidised forms of nickel may comprise Ni(III) and/or Ni(IV), commonly Ni(III). The mixture may also comprise substantial amounts of cobalt, manganese and/or nickel in the desired (II) state.

However, the solubility profiles of some of the major leach impurities in the solid residue, notably iron (Fe), aluminium (Al) and to lesser extent copper (Cu), overlap to some degree with the solubility profiles of the desired nickel, manganese and cobalt components. For instance, the desired +2 oxidation state forms of nickel, manganese, cobalt and iron (Fe(II)) are all relatively soluble between about pH 3 and about 7, while the oxidised forms of these metals only start to become significantly soluble in aqueous solution below about pH 3. In the case of aluminium and copper, while neither of these leach impurities have the same oxidation/reduction behaviour as that of nickel, manganese and cobalt, they are significantly soluble in aqueous solution below about pH 3 and about 4, respectively.

In one embodiment, the feed mixture may comprise one or more leach impurities. The one or more leach impurities may be selected from the group consisting of: iron, aluminium, copper, barium, cadmium, calcium, carbon, chromium, lead, lithium, magnesium, potassium, fluoride, phosphorus, sodium, silicon, scandium, sulfur, titanium, zinc, arsenic and zirconium.

It will be appreciated that in most cases, the types and amounts of these leach impurities will largely depend on how much processing the solid residue has been subjected to before the method is performed, and what material was used as a starting material. For instance, if the solid residue has been obtained directly from the SAL process, then the residue is likely to contain significantly more iron (Fe) and aluminium (Al) than if the residue was obtained directly from cathode active material (CAM) itself, particularly if the CAM has been partially treated through a recycling process first.

In one embodiment, the aqueous solution used in the treatment comprises a leaching agent. The leaching agent may be an acid. The acid may be used to provide a pH of from about 1 to about 7, or from about 1 to about 6. The leaching agent may be an inorganic acid or an organic acid. The inorganic acid may be selected from the group consisting of sulfuric acid, hydrochloric and nitric acid. The organic acid may be selected from acetic or formic acid. Other acids may also be suitable. The leaching agent may be sulfuric acid.

The aqueous solution may be at a pH (or may be such that the leachate has a pH) of less than 7.0, or less than 6.75, 6.50, 6.25, 6.0, 5.75, 5.50, 5.25, 5.0, 4.75, 4.50, 4.25, 4.0, 3.75, 3.50, 3.25, 3.0, 2.75, 2.50 or 2.0. The aqueous solution may be at a pH (or may be such that the leachate has a pH) of more than 2.0, or more than 2.25, 2.50, 2.75, 3.0, 3.25, 3.50, 3.75, 4.0, 4.25, 4.50, 4.75, 5.0, 5.25, 5.50 or 5.75. In certain embodiments, the aqueous solution may be at a pH (or may be such that the leachate has a pH) of from 1.0 to 4.0, 2.0 to 4.0, 4.0 to 6.0, 2.0 to 3.0, 3.0 to 4.0, 4.0 to 5.0 or 5.0 to 6.0, or 6.0 to 7.0. In some embodiments, the aqueous solution may be at a pH (or may be such that the leachate has a pH) of from 1.0 to 1.5, 1.5 to 2.0, 2.0 to 2.5, 2.5 to 3.0, 3.0 to 3.5, 3.5 to 4.0, 4.0 to 4.5, 4.5 to 5.0, 5.0 to 5.5, or 5.5 to 6.0, or 6.0 to 6.5, or 6.5 to 7.0. The pH of the aqueous solution may be from about 2.5 to 3.5. It may be about 3.0. The inventors have found that if the pH is below 1 then more leach impurities are dissolved into the aqueous solution. However, if the pH is above 6 or 7, then the ability of the aqueous solution to dissolve the desired +2 oxidation state forms of nickel, cobalt and manganese is diminished. The pH in step B may be the terminal pH of the solution at the end of the step, i.e. the pH of the leachate at the end of step B. The pH of step B may be the pH throughout the step.

In one embodiment, the method may comprise the step of adding the leaching agent to the aqueous solution. In another embodiment, it may comprise the step of controlling the pH of the aqueous solution. In one embodiment, the pH of the aqueous solution may be controlled through addition of an acidic leaching agent, as defined above. In another embodiment, the pH of the aqueous solution may be controlled through addition of a base. Example bases may include an alkali or alkaline earth hydroxide, such as sodium hydroxide. However, the base may be a nickel, cobalt or manganese containing material, such as fresh solid (such as the mixture to be treated, or a nickel, cobalt and manganese precipitate for example a hydroxide precipitate) or hydroxide compounds or carbonate compounds or hydroxyl-carbonate compounds. An advantage of using a nickel, cobalt or manganese containing material, especially a nickel, cobalt or manganese containing material which includes at least an oxidised portion, is that addition of this material would also consume remaining reducing agent in solution and convert the conditions to oxidising to oxidise Fe²⁺ to Fe³⁺ as Fe³⁺ precipitates more favourably than Ni or Co.

In one embodiment, the leaching agent is added to the aqueous solution (or “leach solution”) at a controlled rate. In one embodiment, the leaching agent may be added incrementally until the solution reaches a desired terminal pH (the desired terminal pH may be as described for the pH of the aqueous solution above). In another embodiment, all of the leaching agent may be added to the aqueous solution in one step. In another embodiment, leaching agent may be added gradually over the course of the treating (i.e. for the predetermined time discussed elsewhere herein). In some embodiments, the reagent is combined with the aqueous solution and then added to the feed mixture. In other embodiments the aqueous solution is added to the feed mixture in order to achieve the desired pH, and then the reagent is added. In another embodiment, the reagent is combined with the aqueous solution after the aqueous solution has been combined with the feed mixture.

The leaching agent may be added to the aqueous solution at a ratio of about 10,000 mol to about 20,000 mol leaching agent per tonne of mixture comprising nickel, cobalt and manganese; for example at a ratio of about 12,000 mol to about 17,000 mol leaching agent per tonne of mixture comprising nickel, cobalt and manganese; or at a ratio of 14,000 mol to 14,500 mol leaching agent per tonne of mixture comprising nickel, cobalt and manganese. Sulfuric acid may be added to the aqueous solution at a ratio of about 1.0 to about 2.0 t H₂SO₄ per tonne of mixture comprising nickel, cobalt and manganese; or at a ratio of about 1.2 to about 1.7 t H₂SO₄ per tonne of mixture comprising nickel, cobalt and manganese; or at a ratio of about 1.4 t H₂SO₄ per tonne of mixture comprising nickel, cobalt and manganese.

The reducing agent may be selected from the group consisting of hydrogen gas, SO₂ gas, a sulfite (such as sodium metabisulfite), organic acids, a sulfide (such as nickel, sodium, potassium, cobalt, or manganese sulfide, or sodium, potassium, cobalt, or manganese hydrosulfide), and hydrogen peroxide or a combination thereof. It may be SO₂ gas or sodium metabisulfite or a combination thereof. It may be SO₂ gas. A combination of reducing agents may be used. In one embodiment, the reducing agent may be selected from the group consisting of hydrogen gas and SO₂ gas. Advantageously, hydrogen gas and SO₂ gas are both strong enough to reduce the cobalt, manganese and nickel, and do not introduce any additional impurities to the leaching solution. When selecting a suitable reducing agent it is preferable to select agents that would either not introduce impurities into the solution, or alternatively would only introduce impurities which may be readily removed and/or separated. In one embodiment, the reducing agent is SO₂ gas. The presence SO₂ gas in the solution may also produce acid in situ (for example through reaction with solution or oxidised material). In one embodiment, the reducing agent is a gas at atmospheric pressure and temperature. In another embodiment, the reducing agent is a liquid at atmospheric pressure and temperature. In a further embodiment, the reducing agent is a solid at atmospheric pressure and temperature.

The aqueous solution and, if used, the reagent, may, independently, be added over a period of from about 0.25 to about 5 hours, or about 0.25 to 1, 0.25 to 05, 0.5 to 1, 0.5 to 2, 1 to 4, 1 to 3, 1 to 2, 2 to 5, 3 to 5 or 3 to 4 hours, e.g. about 0.25, 0.5, 0.75, 1, 1.5, 2, 2.5 3, 3.5, 4, 4.5 or 5 hours, although on occasions one or both of these may be added over longer than 5 hours. They may be added independently or may be added together. They may be added concurrently or they may be added sequentially or (if added batchwise or semi-continuously) may be added in an alternating manner. Each, independently, may be added batchwise or continuously or may be added semi-continuously (i.e. continuously but with periods of no addition). The reagent may be added in a stoichiometric ratio of from about 70 to about 500% relative to the two or metals which are to be oxidised or reduced, or of from about 100 to 500, 200 to 500, 300 to 500, 100 to 300, 70 to 200, 70 to 100 or 70 to 150%, e.g. about 70, 80, 90, 100, 125, 150, 175, 200, 250, 300, 350, 400, 450 or 500%, although ratios outside these ranges may also be suitable in certain cases.

In one embodiment, the reducing agent is not hydrogen peroxide. Processes described previously which employ hydrogen peroxide, may oxidise any iron present and reduce the nickel, cobalt and manganese in the recycled cathode material. In these processes a bulk amount of hydrogen peroxide is used (hydrogen peroxide is a relatively weak reducing agent for the nickel, cobalt and manganese), which means that there is little control over the reduction reaction. Furthermore, hydrogen peroxide is a relatively expensive reagent and necessitates addition of further acid, and hydrogen peroxide also results in significant dilution due to associated water.

The inventors have advantageously found that in order to selectively dissolve the oxidised forms of nickel, manganese and cobalt, relative to various leach impurities in the mixture, it is necessary to convert these oxidised forms of nickel, manganese and cobalt in the mixture to the desired +2 oxidation state forms to render them soluble at a pH of from about 1 to about 6.

In one embodiment, the method may comprise the step of adding the reducing agent to the aqueous solution. In another embodiment, it may comprise the step of controlling the addition of the reducing agent to the aqueous solution. The addition of reducing agent to the aqueous solution may be controlled such that the oxidised cobalt, manganese and/or nickel components are substantially reduced to the desired +2 oxidation state, while minimising the reduction of the main leach impurities such as iron (Fe), which has a wider pH range of solubility in the reduced Fe(II) form. In one embodiment, the method of the first aspect may be performed under conditions that preferentially reduce oxidised cobalt, manganese and/or nickel relative to leach impurities in the mixture. Such leach impurities may be at least one of the group consisting of (especially all of the group consisting of): iron, aluminium, copper, iron, barium, cadmium, calcium, carbon, chromium, lead, lithium, magnesium, potassium, phosphorus, sodium, silicon, fluorine, sulfur, titanium, zinc, and zirconium; especially aluminium, barium, cadmium, carbon, chromium, copper, lead, silicon, fluorine, titanium, zinc and zirconium.

The inventors have advantageously found that in terms of reduction reactions, oxidised nickel should be the first to reduce, followed by cobalt, then manganese, then iron. Consequently, in one embodiment the amount of reducing agent added to the mixture is selected to reduce oxidised nickel, cobalt and manganese, but so that iron is substantially not oxidised.

In one embodiment, between about 0.5 and about 2 stoichiometric equivalents of reducing agent to combined moles of oxidised cobalt, oxidised manganese and oxidised nickel (some of which oxidised metals may be absent) are added to the aqueous solution; or between about 0.7 and 1.5, 0.8 and 1.2, or 0.9 and 1.1 stoichiometric equivalents. About 1 stoichiometric equivalent may be added, or about 0.5, 0.75, 1.25, 1.5, 1.75, 2, 2.5, 3, 3.5, 4, 4.5 or 5 stoichiometric equivalents. The inventors have advantageously found that one equivalent of reducing agent is typically sufficient to reduce one equivalent of the oxidised forms of nickel, manganese or cobalt. The reducing agent may be added to the aqueous solution at a ratio of about 3,000 mol to about 10,000 mol reducing agent per tonne of feed mixture; or at a ratio of about 5,000 mol to 8,000 mol or 6,000 mol to 6,500 mol reducing agent per tonne of feed mixture. The SO₂ may be added to the aqueous solution at a ratio of about 0.2 to about 0.6 tonne SO₂ per tonne of feed mixture; or at a ratio of 0.3 to 0.5 tonne SO₂ per tonne of feed mixture; for example at a ratio of about 0.3, 0.4 or 0.5 tonne SO₂ per tonne of feed mixture.

In one embodiment, between about 0.5 and about 5 stoichiometric equivalents of oxidising agent to combined moles of reduced cobalt, reduced manganese and reduced nickel (some of which reduced metals may be absent) are added to the aqueous solution; or between about 0.5 and 2, 0.7 and 1.5, 0.8 and 1.2, or 0.9 and 1.1 stoichiometric equivalents. About 1 stoichiometric equivalent may be added, or about 0.5, 0.75, 1.25, 1.5, 1.75, 2, 2.5, 3, 3.5, 4, 4.5 or 5 stoichiometric equivalents. In one embodiment of step B, between about 70% and about 500% stoichiometric equivalents of oxidant to combined moles of reduced cobalt, reduced manganese and reduced nickel (some of which reduced metals may be absent) are added; for example between about 80% and 400%; between 80% and 200%, or 100% to 150%, for example about 70, 80, 90, 100, 110, 120,125, 130, 140, 150, 200, 250, 300, 350, 400, 450 or 500%.

In one embodiment, the reagent (especially the reducing agent) is added to the aqueous solution (or “leach solution”) at a controlled rate. The reagent (especially the reducing agent) may be added at a continuous rate over a specific time. A suitable time may be from about 15 minutes to about 3 hours; or from about 30 minutes to about 2 hours; or from about 30 minutes to about 1 hour; or from about 1 to about 3 hours; or from about 1 to about 2 hours. The inventors have found that a slower addition rate typically provides greater selectivity over leach impurities, but a faster addition rate typically provides improved throughput.

In one embodiment, the treatment is performed in a sealed vessel. Advantageously, use of a sealed vessel may control the loss of gas, allowing for greater control over the reduction reaction or the oxidation reaction (as appropriate), and slower addition of the reducing agent or the oxidising agent (especially when the reducing agent or oxidising agent is a gas). In one embodiment, the treatment is performed at atmospheric pressure. In another embodiment, it is performed at from 0.9 to 2.0 atmospheres, or from 1.0 to 1.5 atmospheres, for example at about 1, 1.1, 1.2, 1.3, 1.4 or 1.5 atmospheres. Performing the treatment at a slight overpressure may be useful to constrain excess gas.

The inventors have found that for at least some reagents (such as some reducing agents), addition of the reagent may affect the pH of the aqueous solution. Consequently, in some embodiments, the pH of the solution may need to be controlled, for example through addition of acid or base.

In some embodiments when a reducing agent is used, control of the pH and reduction reactions will allow selective dissolution of the nickel, cobalt and manganese while limiting leaching of iron, aluminium, and copper to about 40% by weight or less each; or to about 30%, 20%, 15% or 12% by weight or less each. Advantageously, by using this process significant portions of some leach impurities may remain in a solid phase.

In another embodiment, the treating provides a leachate comprising dissolved nickel, cobalt and manganese, and a solid comprising at least one of the group consisting of (or all of the group consisting of): iron, aluminium, copper, barium, cadmium, calcium, carbon, chromium, lead, lithium, magnesium, potassium, phosphorus, sodium, silicon, fluorine, sulfur, titanium, zinc, and zirconium; or aluminium, barium, cadmium, carbon, chromium, copper, lead, silicon, fluorine, titanium, zinc and zirconium.

In one embodiment, the step B is performed at a temperature at which the aqueous solution remains in a liquid state. In one embodiment, it is performed at a temperature between about 0° C. and about 100° C.; or from about 10° C. to about 100° C., or from about 20° C. to about 100° C., or from about 40° C. to about 100° C.; more especially from about 50° C. to about 100° C.; or from about 60° C. to about 100° C. In another embodiment, it is performed at a temperature from about 60° C. to about 95° C. (or from about 60° C. to about 90° C.); or from about 70° C. to about 95° C., or from about 75° C. to about 95° C.; or from about 80° C. to about 95° C. In one embodiment, it is performed at a temperature between about 0° C. and about 100° C.; or from about 10° C. to about 100° C., or from about 20° C. to about 100° C., or from about 30° C. to about 80° C.; or from about 40° C. to about 70° C.; or from about 45° C. to about 65° C.; or from about 45° C. to about 80° C.; or from about 50° C. to about 60° C. It may be performed at about 0, 10, 20, 30, 40, 50, 60, 70, 80, 90 or 100° C., or at about 55° C. The temperature of the aqueous solution may increase over time as the reaction/process is typically exothermic.

In one embodiment, step B may be performed at a temperature of from 80 to 81.0, from 81.0 to 82.0, from 82.0 to 83.0, from 83 to 84.0, from 84.0 to 85.0, from 85.0 to 86.0, from 86.0 to 87.0, from 87.0 to 88.0, from 88.0 to 89.0, from 89.0 to 90.0, from 90.0 to 91.0, from 91.0 to 92.0, from 92.0 to 93.0, from 93.0 to 94.0, or from 94.0 to 95.0° C.

In one embodiment, step B may be performed for a predetermined time. As outlined above, the time needed for the treating of the first aspect may be affected by factors such as the temperature at which the reaction is conducted, the pH of the solution and the reagent. However, in one embodiment, the treating may be performed for at least about 10 minutes, or at least about 30 minutes, or at least about 1 hour, or at least about 2 hours. In one embodiment, it may be performed for from about 30 minutes to about 6 hours, or from about 30 minutes to about 4 hours, 1 hour to 4 hours, 1 hour to 3 hours, or 2 hours to 3 hours, for example for about 2 hours or about 2.5 hours.

In one embodiment, the treating is performed with mixing or agitation, e.g. with stirring.

In one embodiment, the treating may be performed using at least one vessel. The at least one vessel may be one vessel or may be two vessels. Said vessels may be mixing vessels and may be configured to mix the liquid (which may include entrained solids) therein. Said vessels may be agitated. They may include a stirrer.

The treating may be performed at any suitable ratio of liquids to solids. In one embodiment, the solid-liquid mixture may comprise at least about 1% solids (by weight), or at least about 2%, 3%, 4%, 5%, 10%, 15% or 20% solids (by weight). In one embodiment, the solid-liquid mixture may comprise from about 3 to about 25% solids (by weight), or from about 4 to 20%, 1 to 10%, 3 to 7% or 4 to 6% solids (by weight). In one embodiment, the feed mixture and the aqueous solution together form a slurry.

The method may comprise a step of adding the reagent (such as an oxidising agent or reducing agent) to the aqueous solution after combining the feed mixture with the aqueous solution. The oxidising agent may be a mixture comprising at least two of nickel, cobalt and manganese (i.e. starting material to be treated). A manganese, carbonate or hydroxide salt (commonly a carbonate or hydroxide salt) may also be added in this step. A suitable manganese salt may be MnCO₃. A suitable carbonate salt may be selected from the group consisting of MnCO₃, Ni(OH)(CO₃)_{0.5}, NiCO₃, CoCO₃, Co(OH)₂, Na₂CO₃ and CaCO₃.

A suitable hydroxide salt may be selected from the group consisting of Ni(OH)₂, Ni(OH)(CO₃)_{0.5}, NaOH and Ca(OH)₂. This step may be performed at any suitable temperature, commonly as described previously for the treating. This step may be performed for any length of time, for example from about 30 minutes to about 10 hours, or from about 3 hours to about 10 hours, or from about 4 hours to about 8 hours. This step may avoid the need to remove or separate leach impurities such as magnesium, sodium, calcium and zinc. This step may consume any reducing agent remaining in the solution.

In one embodiment, the method may comprise adding oxidant and/or reductant to neutralise any excess reductant and/or oxidant in the solution. In another embodiment, the method may comprise adding base to the solution to increase the pH to, for example, a pH above step B, but below pH 7 (for example pH 6). The method may comprise the step of filtering the solution before neutralising excess reductant and/or oxidant, or increasing the pH.

Following the treating, impurities (or “leach impurities”) may be removed and/or separated from the leachate in any suitable way. In this context, the term “impurity” or “leach impurity” or “leach impurities”) refers to a metal, complex, compound or element that is not nickel, cobalt, manganese, water, OH⁻, H⁺, H₃O⁺, sulfate or carbonate. An appropriate technique of removing impurities may be selected by a skilled person based on the nature of the impurities. For example, at least a portion of the leach impurities may be in solid form. In one embodiment, solid leach impurities may be removed and/or separated from the aqueous solution using at least one separating technique selected from the group consisting of decantation, filtration, cementation, centrifugation and sedimentation, or a combination of any two or more thereof. Exemplary solid leach impurities may include at least one selected from the group consisting of: iron, aluminium, copper, barium, cadmium, carbon, chromium, lead, silicon, sulfur, titanium, zinc, and zirconium.

The leachate may comprise at least one liquid leach impurity. Exemplary liquid leach impurities in the leachate may be at least one leach impurity is selected form the group consisting of arsenic, aluminium, barium, cadmium, carbon, calcium, magnesium, chromium, copper, lead, silicon, sodium, lithium, potassium, phosphorous, tetrafluoroborate, hexafluorophosphate, vanadium, lanthanum, ammonium, sulphite, fluorine, fluoride, chloride, titanium, scandium, iron, zinc and zirconium, silver, tungsten, vanadium, molybdenum, platinum, rubidium, tin, antimony, selenium, bismuth, boron, yttrium, lead, niobium or a combination thereof; especially arsenic, aluminium, barium, cadmium, carbon, calcium, magnesium, chromium, copper, lead, silicon, vanadium, lanthanum, titanium, scandium, iron, zinc, zirconium, silver, tungsten, molybdenum, platinum, rubidium, tin, antimony, selenium, bismuth, boron, yttrium, and niobium or a combination thereof.

In one embodiment, the mass ratio of the at least one metal (selected from the group consisting of nickel, cobalt and manganese; especially at least two metals or three metals): at least one liquid leach impurity is less than 1:50 or less than 1:20, or less than 10:1, or less than 1:1 or less than 10:1 or less than 100:1 or less than 500:1 or less than 1000:1 or less than 5000:1 or less than 10,000:1 or less than 50,000:1 or less than 200,000:1 or less than 500,000:1 by weight.

In another example, at least a portion of the leach impurities may be in liquid (or dissolved) form. In one embodiment, liquid (or dissolved) leach impurities may be removed and/or separated from the aqueous solution using at least one separating technique selected from the group consisting of ion exchange, precipitation, absorption/adsorption, electrochemical reduction and distillation, or a combination of any two or more thereof, commonly ion exchange, precipitation and adsorption, or a combination thereof. In this context, the term “impurity” or “leach impurity” refers to a metal which is not cobalt, nickel or manganese, but may also encompass unwanted non-metals or semimetals. Exemplary liquid leach impurities may include arsenic, aluminium, barium, cadmium, carbon, calcium, magnesium, chromium, copper, lead, silicon, sodium, lithium, potassium, phosphorous, tetrafluoroborate, hexafluorophosphate, vanadium, lanthanum, ammonium, sulphite, fluorine, fluoride, chloride, titanium, iron, scandium, zinc and zirconium, or a combination thereof.

In one embodiment, the concentration of alkali metal (such as Na, Li, K) (or at least one alkali metal) liquid leach impurities in the leachate is less than or equal to 100,000 ppm, or less than or equal to 80,000 ppm, or less than or equal to 60,000 ppm, or less than or equal to 50,000 ppm, or less than or equal to 40,000 ppm, or less than or equal to 30,000 ppm, or less than or equal to 20,000 ppm, or less than or equal to 15,000 ppm, or less than or equal to 10,000 ppm, or less than or equal to 7,000 ppm, or less than or equal to 5,000 ppm, or less than or equal to 4,000 ppm, or less than less than or equal to 3,000 ppm, or less than or equal to 2,500 ppm, or less than or equal to 2,000 ppm. In another embodiment, the molar ratio of the at least one metal (or the at least two metals) to alkali metal liquid leach impurities (or at least one alkali metal impurity) in the leachate may be greater than about 1:10, or greater than about 1:5, or greater than about 1:1, or greater than about 5:1, or greater than about 10:1, or greater than about 20:1, or greater than about 50:1, or greater than about 80:1, or greater than about 100:1, or greater than about 120:1, or greater than about 150:1, or greater than about 180:1 or greater than about 200:1. In another embodiment, the molar ratio of the at least one metal (or the at least two metals) to alkali metal liquid leach impurities (or at least one alkali metal impurity) in the leachate may be less than about 1:1, or less than about 5:1, or less than about 10:1, or less than about 20:1, or less than about 50:1, or less than about 80:1, or less than about 100:1, or less than about 120:1, or less than about 150:1, or less than about 180:1 or less than about 200:1. In another embodiment, the molar ratio of the at least one metal (or the at least two metals) to alkali metal liquid leach impurities (or at least one alkali metal impurity) in the leachate may be from about 1:10 to 23,000:1, or from about 1:10 to 100,000,000:1, or from about 1:10 to 300,000,000:1.

In one embodiment, the concentration of anionic species liquid leach impurities (such as F⁻ and Cl⁻ (but excluding the oxide, hydroxide, sulfate or carbonate) (or at least one anionic species liquid impurity) in the leachate is less than or equal to 100,000 ppm, or less than or equal to 80,000 ppm, or less than or equal to 60,000 ppm, or less than or equal to 50,000 ppm, or less than or equal to 40,000 ppm, or less than or equal to 30,000 ppm or less than or equal to 20,000 ppm, or less than or equal to 10,000 ppm, or less than or equal to 5,000 ppm, or less than or equal to 4,000 ppm, especially less than or equal to 3,000 ppm or less than or equal to 2,500 ppm or less than or equal to 2,000 ppm. In another embodiment, the molar ratio of the at least one metal (or the at least two metals) to anionic species liquid leach impurities (or at least one anionic species liquid impurity) in the leachate may be greater than about 1:10, or greater than about 1:5, or greater than about 1:1, or greater than about 5:1, or greater than about 10:1, or greater than about 20:1, or greater than about 50:1, or greater than about 80:1, or greater than about 100:1, or greater than about 120:1, or greater than about 150:1, or greater than about 180:1 or greater than about 200:1. In another embodiment, the molar ratio (or mass ratio) of the at least one metal (or the at least two metals) to anionic species liquid leach impurities (or at least one anionic species impurity) in the leachate may be less than about 5:1, or less than about 10:1, or less than about 20:1, or less than about 50:1, or less than about 80:1, or less than about 100:1, or less than about 120:1, or less than about 150:1, or less than about 180:1 or less than about 200:1.

In another embodiment, the concentration of alkaline earth metal liquid leach impurities (such as Ca and Mg) (or at least one alkaline earth metal impurity) in the leachate is less than 50,000 ppm, or less than 40,000 ppm, or less than 30,000 ppm, or less than 20,000 ppm, or less than 10,000 ppm, or less than 5,000 ppm, or less than 1,000 ppm, or less than 800 ppm, or less than 600 ppm, or less than 500 ppm, or less than 400 ppm, or less than 300 ppm, or less than 250 ppm or less than 200 ppm. In a further embodiment, the molar ratio of the at least one metal (or the at least two metals) to alkaline earth metal liquid leach impurities (or at least one alkaline earth metal liquid impurity) in the leachate is greater than about 500:1, or greater than about 1000:1, or greater than about 1500:1, or greater than about 2000:1. In one embodiment, the molar ratio of the at least one metal (or the at least two metals) to alkaline earth metal liquid leach impurities (or at least one alkaline earth metal liquid impurity) in the leachate is from about 300,000,000:1 to about 1:10; or greater than about 1:10, or greater than 1:1. In one embodiment, the molar ratio of the at least one metal (or the at least two metals) to alkaline earth metal liquid leach impurities (or at least one alkaline earth metal liquid impurity) in the leachate is less than 1:10, or less than 1:5 or less than 1:1, or less than about 5:1, or less than about 10:1, or less than about 20:1, or less than about 50:1, or less than about 80:1, or less than about 100:1, or less than about 120:1, or less than about 150:1, or less than about 180:1 or less than about 200:1.

In a further embodiment, the concentration of metal and metalloid liquid leach impurities (or at least one metal or metalloid impurity) in the leachate is less than 250 ppm, especially less than 50 ppm. Exemplary metal and metalloid leach impurities may be selected from the group consisting of iron, aluminium, copper, zinc, cadmium, chromium, silicon, lead, scandium, zirconium and titanium. In one embodiment, the molar ratio of the at least one metal (or the at least two metals) to metal and metalloid liquid leach impurities (or at least one metal or metalloid liquid impurity) in the leachate is less than 10,000:1, or less than 20,000:1, or less than 40,000:1, or less than 60,000:1, or less than 80,000:1, or less than 100,000:1, or less than 500,000:1. In one embodiment, the molar ratio of the at least one metal (or the at least two metals) to Fe impurities in the leachate is from about 300,000,000:1 to about 10,000:1; or greater than about 10,000:1, or greater than 12,000:1. In one embodiment, the molar ratio of the at least one metal (or the at least two metals) to Fe impurities in the leachate is less than 10,000:1, or less than 20,000:1, or less than 100,000:1, or less than 500,000:1, or less than 1,000,000:1. In one embodiment, the molar ratio of the at least one metal (or the at least two metals) to Al impurities in the leachate is from about 300,000,000:1 to about 10,000:1; or greater than about 10,000:1, or greater than 12,000:1. In one embodiment, the molar ratio of the at least one metal (or the at least two metals) to Al impurities in the leachate is less than 10,000:1, or less than 20,000:1 or less than 100,000:1.

In an embodiment of the invention there is provided a method of producing a co-precipitate, wherein the co-precipitate comprises at least one metal selected from nickel, cobalt and manganese, the method comprising:
(i) providing a feed mixture comprising the at least one metal and at least one impurity, said feed mixture being one of an oxidised feed, a reduced feed or an unoxidized feed, wherein:
   an oxidised feed has more of the at least one metal in an oxidation state greater than 2 than in an oxidation state less than 2;
   a reduced feed has more of the at least one metal in an oxidation state less than 2 than in an oxidation state greater than 2 or has substantially all of the at least one metal in an oxidation state of 2 and at least some of the at least one metal in the form of their sulfide; and
   an unoxidized feed has substantially all of the at least one metal in an oxidation state of 2 and substantially none of the at least one metal in the form of their sulfide;
   treating the feed mixture with an aqueous solution to form a leachate comprising said at least one metal, wherein the pH of the aqueous solution is such that the leachate has a pH of between about 1 and about 7 and wherein:
   if the feed mixture is an oxidised feed, the treating additionally comprises adding a reagent which comprises a reducing agent; and if the feed mixture is a reduced feed, the treating additionally comprises adding a reagent which comprises an oxidising agent;
   whereby the leachate comprises the at least one metal in an oxidation state of 2,
so as to provide an aqueous feed solution comprising said at least one metal, said aqueous feed solution being the leachate; and
(ii) adjusting the pH of the feed solution to between about 6.2 and about 11, optionally to between about 6.2 and about 10 or between about 6.2 and about 9.2, so as to provide: (a) a precipitate comprising said at least one metal; and (b) a supernatant comprising said at least one impurity.
   In this embodiment, the method may further comprise the step of mixing at least one metal with the aqueous feed solution, wherein the at least one metal is selected from nickel, cobalt and manganese, so that step (ii) provides a co-precipitate comprising at least two metals (or comprising three metals) selected from nickel, cobalt and manganese.

In one embodiment, at least 1% of said at least one impurity, or at least 5%, or at least 10%, or at least 20%, or at least 30%, or at least 40%, or at least 50% of said at least one impurity, especially at least 60%, or at least 65%, or at least 70%, or at least 75% or at least 80%, or at least 85%, or at least 90%, or at least 95%, or at least 96%, or at least 97%, or at least 98% or at least 99% of said at least one impurity in the feed solution of step (ii) may be in the supernatant after the co-precipitation, or in a wash solution after the co-precipitate is washed, or in the combination of both the supernatant and the wash solutions. The at least one impurity may also be a plurality of impurities. The amount of each impurity in the aqueous feed solution that may be in the supernatant or wash solution or both may be different for each impurity.

In an embodiment of the invention there is provided a method of producing a co-precipitate comprising at least two metals selected from nickel, cobalt and manganese, the method comprising:
(i) providing a feed mixture comprising the at least two metals, said feed mixture being one of an oxidised feed, a reduced feed or an unoxidized feed, wherein:
   an oxidised feed has more of the at least two metals in an oxidation state greater than 2 than in an oxidation state less than 2;
   a reduced feed has more of the at least two metals in an oxidation state less than 2 than in an oxidation state greater than 2 or has substantially all of the at least two metals in an oxidation state of 2 and at least some of the at least two metals in the form of their sulfide; and
   an unoxidized feed has substantially all of the at least two metals in an oxidation state of 2 and substantially none of the at least two metals in the form of their sulfide;
   treating the feed mixture with an aqueous solution to form a leachate comprising said at least two metals, wherein the pH of the aqueous solution is such that the leachate has a pH of between about 1 and about 7 and wherein:
   if the feed mixture is an oxidised feed, the treating additionally comprises adding a reagent which comprises a reducing agent; and
   if the feed mixture is a reduced feed, the treating additionally comprises adding a reagent which comprises an oxidising agent;
   whereby the leachate comprises the at least two metals in an oxidation state of 2,
so as to provide an aqueous feed solution comprising said at least two metals, said aqueous feed solution being the leachate; and
(ii) adjusting the pH of the feed solution to between about 6.2 and about 11, optionally to between about 6.2 and about 10 or between about 6.2 and about 9.2, so as to co-precipitate said at least two metals from the feed solution.

In one embodiment, the at least one impurity in the co-precipitate may be controlled through selective precipitation. There may be less than 100%, or less than 90% or less than 80% or less than 70% or less than 50% or less than 30% or less than 10% or less than 5% or less than 1% of the initial amount of the at least one impurity in the aqueous feed solution precipitating into the co-precipitate. This would be especially the case for alkaline earth metals such as Ca and Mg.

In one embodiment, the at least one impurity may precipitate due to phenomena such as adsorption, absorption, substitution, atomic substitution, phase formation, secondary phase formation, mixed phase formation, co-precipitation or liquor entrainment. Alkali metals (such as Li, Na and K), ammonia/ammonium, sulphur (in the form of sulphate or sulphite) and to a lesser extent alkaline earth metals, Zn and Cu, may be removed using high purity water, acid, caustic, sodium carbonate or ammonia washing or a combination thereof. After washing less than 100% or less that 99% or less than 90% or less than 70% or less than 50% or less than 40% or less than 30% or less than 20% or less than 10% or less than 5% or less than 1% of these species may be present in the final co-precipitate relative to the amount in the aqueous feed solution.

In step (i), one or more impurities may be at least partially (especially partially) separated and/or removed from the aqueous solution comprising said at least two metals (especially nickel, cobalt and manganese) in any suitable way, for example as described elsewhere in the present application.

Accordingly, in a further embodiment there is provided a method of producing a co-precipitate comprising at least two metals selected from nickel, cobalt and manganese, the method comprising:
(i) providing an aqueous feed solution comprising said at least two metals and at least one impurity, and optionally removing and/or separating one or more impurities from the feed solution; and
(ii) adjusting the pH of the feed solution to between about 6.2 and about 11, optionally to between about 6.2 and about 10 or between about 6.2 and about 9.2, so as to co-precipitate said at least two metals from the feed solution.

In yet a further embodiment there is provided a method of producing a co-precipitate comprising at least two metals selected from nickel, cobalt and manganese, the method comprising:
(i) providing a feed mixture comprising the at least two metals, said feed mixture being one of an oxidised feed, a reduced feed or an unoxidized feed, wherein:
   an oxidised feed has more of the at least two metals in an oxidation state greater than 2 than in an oxidation state less than 2;
   a reduced feed has more of the at least two metals in an oxidation state less than 2 than in an oxidation state greater than 2 or has substantially all of the at least two metals in an oxidation state of 2 and at least some of the at least two metals in the form of their sulfide; and
   an unoxidized feed has substantially all of the at least two metals in an oxidation state of 2 and substantially none of the at least two metals in the form of their sulfide;
   treating the feed mixture with an aqueous solution to form a leachate comprising said at least two metals, wherein the pH of the aqueous solution is such that the leachate has a pH of between about 1 and about 7 and wherein:
   if the feed mixture is an oxidised feed, the treating additionally comprises adding a reagent which comprises a reducing agent; and
   if the feed mixture is a reduced feed, the treating additionally comprises adding a reagent which comprises an oxidising agent;
   whereby the leachate comprises the at least two metals in an oxidation state of 2,
so as to provide an aqueous feed solution comprising said at least two metals and at least one impurity, said aqueous feed solution being the leachate, and optionally removing and/or separating one or more impurities (or at least a portion of said at least one impurity) from the feed solution; and
(ii) adjusting the pH of the feed solution to between about 6.2 and about 11, optionally to between about 6.2 and about 10 or between about 6.2 and about 9.2, so as to co-precipitate said at least two metals from the feed solution (or so as to provide: (a) a co-precipitate comprising said at least two metals; and (b) a supernatant comprising at least a portion of said at least one impurity).

The step of removing and/or separating one or more impurities may be a step of removing and/or separating one or more impurities from the leachate.

An appropriate technique of separating and/or removing impurities to the extent desired may be selected by a skilled person based on the nature of the impurities. For example, at least a portion of the impurities may be in solid form. In one embodiment, solid impurities may be separated and/or removed from the feed solution (or leachate) using at least one technique selected from the group consisting of decantation, filtration, centrifugation, cementation and sedimentation, or a combination thereof. Exemplary solid impurities may include at least one selected from the group consisting of: iron, aluminium, copper, barium, cadmium, carbon, chromium, lead, silicon, sulphur, titanium, zinc, and zirconium.

In another example, at least a portion of the impurities may be in liquid (or dissolved) form. In one embodiment, liquid (or dissolved) impurities may be removed from the feed solution (or leachate) using at least one separating technique selected from the group consisting of: ion exchange, precipitation, absorption/adsorption, electrochemical reduction and distillation, or a combination thereof, especially ion exchange, precipitation and adsorption, or a combination thereof; or solvent extraction, ion exchange, precipitation, adsorption and absorption, or a combination thereof. Exemplary liquid impurities may include iron, copper, zinc, calcium, magnesium, chromium, fluorine, lead, cadmium, silicon and aluminium; especially iron, copper, zinc, calcium, magnesium, silicon and aluminium.

Ion exchange may be used to remove at least one impurity, especially at least one metalloid or metal (liquid) impurity, or an alkaline earth metal (liquid) impurity. Exemplary impurities which may be removed using ion exchange may comprise at least one of the group consisting of: magnesium, calcium, aluminium, iron, zinc, copper, chromium, cadmium and scandium; especially at least one of the group consisting of aluminium, iron, zinc, copper, chromium, cadmium and scandium. Ion exchange may be used to remove at least some zinc. Ion exchange may be performed in at least two washing steps, especially two washing steps. Ion exchange may be performed at a temperature of from 20° C. to 60° C.; or from about 30 to 50, 20 to 40 or 40 to 60° C.; for example at about 20, 30, 40, 50 or 60° C. The pH of the ion exchange may be from about 2 to about 7, or from about 3 to about 7, or from about 3 to about 4, for example at about 2, 2.5, 3, 3.5, 4, 4.5, 5, 5.5, 6, 6.5 or 7.

Removal and/or separation of impurities may be performed using a combination of techniques to remove solid and/or liquid and/or gaseous impurities. Thus it may include a solid impurity removal and/or separation step, and a liquid impurity removal and/or separation step. It may include a gaseous impurity removal and/or separation step.

In one embodiment, removal and/or separation of impurities may be performed using at least one vessel. The at least one vessel may be one or two vessels. Said vessels may be settling vessels and may be configured to settle the liquid (which may include entrained solids) therein. Said vessels may include at least two outlets. Said vessels may comprise an upper outlet in an upper portion of the vessel to provide an outlet for liquid, and a lower outlet in a lower portion of the vessel to provide an outlet for settled solids.

In one embodiment, step (i) may be performed using a plurality of vessels. In one embodiment, step (i) is performed with at least two vessels (or mixing vessels); especially two vessels (or mixing vessels). In one embodiment, removal and/or separation of impurities is performed with at least two vessels (or settling vessels); especially two vessels (or settling vessels).

In one embodiment, a mixture comprising at least one or two of nickel, cobalt and manganese (or the feed mixture discussed above) is added to an aqueous solution in a first mixing vessel, which is especially stirred. The solution (including entrained solids) exits the first mixing vessel through the first mixing vessel liquid outlet, and enters a first settling vessel through a first settling vessel liquid inlet. The first settling vessel includes at least an upper outlet in an upper portion of the vessel to provide an outlet for liquid, and a lower outlet in a lower portion of the vessel to provide an outlet for settled solids. Liquid exiting the first settling vessel through the upper outlet may progress to step (ii) of the method of the first aspect, or to remove liquid impurities in the solution (as a further part of step (i) of the method of the first aspect). Liquid/solids exiting the first settling vessel through the lower outlet may flow into a second mixing vessel through a second mixing vessel inlet. A reducing or oxidising agent and a leaching agent may be added to the second mixing vessel. In some instances there is no settling vessel and the solution is taken directly to a filter. The second mixing vessel may be stirred. The solution (including entrained solids) exits the second mixing vessel through the second mixing vessel liquid outlet, and enters a second settling vessel through a second settling vessel liquid inlet. The second settling vessel includes at least an upper outlet in an upper portion of the vessel to provide an outlet for liquid, and a lower outlet in a lower portion of the vessel to provide an outlet for settled solids. Liquid exiting the second settling vessel through the upper outlet may flow to the inlet of the first mixing vessel. Liquid/solids exiting the second settling vessel through the lower outlet may be discarded, for example after passing through a screw press. An advantage of this arrangement is that this minimises the amount of acid and reducing or oxidising agent which remains in the solution from which the nickel, cobalt and manganese is co-precipitated. Furthermore, the amount of iron (and other impurities such as copper and aluminium) in the first mixing vessel may be minimised by maintaining the correct conditions. In some embodiments, the method may comprise use of 3 or more mixing vessels (or reactors). The method may comprise the step of controlling the amount of reagent added to any of said mixing vessels.

The method may include a step of adding one or more of cobalt, manganese and nickel to the feed solution or the leachate to adjust the molar ratios of nickel, cobalt and manganese to a desired molar ratio. Suitable desired molar ratios may include 1:1:1 nickel:cobalt:manganese, or 6:2:2 nickel:cobalt:manganese, or 8:1:1 nickel:cobalt:manganese. In some embodiments, desired molar ratios may include 1:1:1 nickel:cobalt:manganese, 2:1:1 nickel:cobalt:manganese, 3:1:1 nickel:cobalt:manganese, 4:1:1 nickel:cobalt:manganese, 5:1:1 nickel:cobalt:manganese, 6:1:1 nickel:cobalt:manganese, 7:1:1 nickel:cobalt:manganese, 8:1:1 nickel:cobalt:manganese, 9:1:1 nickel:cobalt:manganese, 10:1:1 nickel:cobalt:manganese, 5:3:2 nickel:cobalt:manganese, 9:0.5:0.5 nickel:cobalt:manganese, or 83:5:12 nickel:cobalt:manganese. Desired molar ratios of nickel:manganese may include 1:1 nickel:manganese, or 6:2 nickel:manganese, or 8:1 nickel:manganese. In some embodiments, desired molar ratios may include 1:1 nickel:manganese, 2:1 nickel:manganese, 3:1 nickel:manganese, 4:1 nickel:manganese, 5:1 nickel:manganese, 6:1 nickel:manganese, 7:1 nickel:manganese, 8:1 nickel:manganese, 9:1 nickel:manganese, 10:1 nickel:manganese, 5:3 nickel:manganese or 9:0.5 nickel:manganese. Desired molar ratios of cobalt:manganese may include 1:1 cobalt:manganese, or 6:2 cobalt:manganese, or 8:1 cobalt:manganese. In some embodiments, desired molar ratios may include 1:1 cobalt:manganese, 2:1 cobalt:manganese, 3:1 cobalt:manganese, 4:1 cobalt:manganese, 5:1 cobalt:manganese, 6:1 cobalt:manganese, 7:1 cobalt:manganese, 8:1 cobalt:manganese, 9:1 cobalt:manganese, 10:1 cobalt:manganese, 5:3 cobalt:manganese or 9:0.5 cobalt:manganese. Desired molar ratios of nickel:cobalt may include 1:1 nickel:cobalt, or 6:2 nickel:cobalt, or 8:1 nickel:cobalt. In some embodiments, desired molar ratios may include 1:1 nickel:cobalt, 2:1 nickel:cobalt, 3:1 nickel:cobalt, 4:1 nickel:cobalt, 5:1 nickel:cobalt, 6:1 nickel:cobalt, 7:1 nickel:cobalt, 8:1 nickel:cobalt, 9:1 nickel:cobalt, 10:1 nickel:cobalt, 5:3 nickel:cobalt or 9:0.5 nickel:cobalt. In one embodiment, the before-mentioned molar ratios may be the nickel:cobalt:manganese ratios or the nickel:cobalt ratios or the nickel:manganese ratios or the cobalt:manganese ratios in the co-precipitate. Not all of the nickel, cobalt or manganese in the feed solution may be precipitated. A skilled person would be able to select a suitable ratio based on the desired application, and the desired ratio of nickel:cobalt:manganese in the final material (for example the cathode material).

The one or more of cobalt, manganese and nickel added to the solution may be in any suitable form. One or more cobalt-containing compounds, manganese-containing compounds or nickel-containing compounds may be added to the feed solution. For example, the cobalt, manganese and nickel added may be in the form of one or more sulphate salts, hydroxide salts or carbonate salts, or a mixture thereof; especially CoSO₄, NiSO₄ and/or MnSO₄. In some instances, the feed mixture may be produced by combining separate feed mixtures, each of which is, independently, an oxidised feed, a reduced feed or an unoxidized feed, so as to produce a composite feed for use in the presently described method. In other instances, more than one feed mixture, each of which is, independently, an oxidised feed, a reduced feed or an unoxidized feed, may be used to generate more than one leachate by the method described herein, and the more than one leachate may be subsequently combined, in any suitable ratio, so as to provide a composite leachate. In one embodiment, metals other than Ni, Co and Mn (in any suitable form) may be added to the leachate or aqueous feed solution. This may assist in producing a co-precipitate with said other metals present.

Step (ii) of the method produces a co-precipitate comprising the at least two metals selected from nickel, cobalt and manganese. In one embodiment, the at least two metals selected from nickel, cobalt and manganese are all of nickel, cobalt and manganese.

In one embodiment, more than 10% or more than 10% or more than 20% or more than 50%, or more than 60% or more than 80% or more than 90% or more than 99% of the at least one metal in the co-precipitate (especially the at least two metals, more especially all of nickel, cobalt and manganese) is derived from the feed mixture (which is leached). In one embodiment, the feed mixture may be a plurality of feed mixtures which have been combined. In one embodiment, each of said plurality of feed mixtures may be derived from a different source.

The pH of the co-precipitation step is at a pH of from about 6.2 to about 11, or from about 6.2 to about 10.5, or from about 6.2 to about 10, or from about 6.2 to about 9.2, 6.2 to 9, 6.2 to 8, 6.2 to 7, 6.2 to 6.5, 6.5 to 9.2, 7 to 9.2, 8 to 9.2, 9 to 9.2, 6.5 to 9, 6.5 to 8, 7 to 9 or 7 to 8, e.g. about 6.2, 6.3, 6.4, 6.5, 7, 7.5, 8, 8.5, 8.6, 8.7, 8.8, 8.9, 9, 9.1, 9.2, 9.3, 9.4, 9.5, 9.6, 9.7, 9.8, 9.9 or 10. A pH of about 9 to 9.2 may be advantageous if the feed solution from which the at least two metals are co-precipitated is relatively pure.

The inventors have advantageously found that a pH range of between about 7.0 and about 8.6, or between 6.2 and 8.6, may result in less co-precipitation or inclusion of unwanted impurities such as, for example, the salts of magnesium and/or calcium, than if a higher pH range was used, although the choice of pH may depend upon what impurities are present and their concentrations. For instance, magnesium would generally begin to precipitate from solution as a hydroxide or oxide above a pH of about pH 8.5, while calcium would generally begin to precipitate from solution as a hydroxide or oxide above about pH 10.0 (however complete precipitation of these impurities would not be achieved until a higher pH is achieved and partial precipitation of these elements may be achieved at a lower pH depending on the method of precipitation). Consequently, the co-precipitation may be performed even at a pH where some impurities begin to precipitate. However, the relative amount of impurity precipitation may be controlled so as to not negatively impact the performance of the battery material or to achieve the desired amount of impurity in the co-precipitated or to achieve the desired battery material performance.

Any suitable reagent (such as a base) may be used to adjust the pH. Example reagents (or bases) may include an alkali or alkaline earth hydroxide, such as sodium hydroxide. However, the base may be a nickel, cobalt and/or manganese containing material, such as fresh solid (such as a hydroxide, carbonate, or a hydroxyl-carbonate), or a nickel, cobalt and manganese precipitate (such as produced by step (ii), especially a hydroxide precipitate).

Step (ii) may be performed at any suitable temperature or pressure. It may be conducted at a temperature and pressure at which the feed solution is in liquid form. In one embodiment, step (ii) is performed at from about 15 to about 25° C., for example at about room temperature. In one embodiment, step (ii) is performed at a temperature of less than about 100° C., or less than about 90, 85, 80, 70, 60 or 50° C. In another embodiment, step (ii) is performed at a temperature of more than about 30° C., or more than about 35, 40, 45, 50, 55, 60, 65, 70, 75 or 80° C. In one embodiment, step (ii) is performed at a temperature of from about 25° C. to about 100° C., or from about 40° C. to 95° C., 50° C. to 95° C., 60° C. to 90° C. or 70° C. to 90° C. In one embodiment, step (ii) is performed at a temperature of about 80° C. In another embodiment, step (ii) is performed at atmospheric pressure.

Step (ii) may be performed with any suitable base. In one embodiment, the base may be a carbonate, a bicarbonate, a hydroxide, ammonia or a mixture thereof. It may be ammonia. Suitable carbonates may include a carbonate selected from the group selected from ammonium carbonate, sodium carbonate, potassium carbonate, lithium carbonate, or a mixture thereof. Suitable bicarbonates may be selected from the group consisting of sodium bicarbonate, and ammonium bicarbonate or a mixture thereof. A suitable bicarbonate is ammonium bicarbonate. A suitable hydroxide may be ammonium hydroxide or sodium hydroxide.

The at least two metals may be co-precipitated in any suitable form, such as in the form of oxides, hydroxides, carbonates and/or hydroxyl-carbonates.

The at least two metals may be all three of nickel, cobalt and manganese. These may be co-precipitated in any suitable molar ratio. Exemplary molar ratios may include 1:1:1 nickel:cobalt:manganese, or 6:2:2 nickel:cobalt:manganese, or 8:1:1 nickel:cobalt:manganese. In some embodiments, molar ratios may include 1:1:1 nickel:cobalt:manganese, 2:1:1 nickel:cobalt:manganese, 3:1:1 nickel:cobalt:manganese, 4:1:1 nickel:cobalt:manganese, 5:1:1 nickel:cobalt:manganese, 6:1:1 nickel:cobalt:manganese, 7:1:1 nickel:cobalt:manganese, 8:1:1 nickel:cobalt:manganese, 9:1:1 nickel:cobalt:manganese, 10:1:1 nickel:cobalt:manganese or 9:0.5:0.5 nickel:cobalt:manganese.

Step (ii) may comprise separation of the co-precipitate from the supernatant. Such separation may comprise one or more of decantation or filtering. The separation may comprise resuspending decanted or filtered co-precipitate in a solution. The separation may comprise washing the decanted or filtered solid with a solution.

In one embodiment of the method of the first aspect, step (ii) may be followed by washing the co-precipitate (especially nickel, cobalt and manganese). This may dissolve and/or remove impurities present in the initially formed co-precipitate. The washing may be performed in at least one washing step (or at least two washing steps), such as at least one resuspension washing step. Impurities in the initially formed co-precipitate may be present by virtue of associate or adsorption, and washing may be required to remove such impurities even if they are not substantially precipitated. In one embodiment, the washing is with an aqueous solution (especially a relatively pure water solution, such as distilled water), or may be with a solution (especially an aqueous solution) comprising bases, acids or alkali reagents (this may achieve the desired removal of impurity elements). The washing step may comprise a plurality of washing steps. Said plurality of washing steps may utilise different washing solutions. This may assist in removal of different impurities. These washing solutions may remove the contaminated solution entrained with the solid, or may react with the solid to remove impurities which have partially coprecipitated, or both.

In one embodiment of the method, step (ii) may be followed by mixing the co-precipitate (or the precipitated nickel, cobalt and manganese) with lithium. This may be followed by calcining the lithium, and co-precipitate (or nickel, cobalt and manganese). This may form cathode active material (CAM). The co-precipitate may be to provide NMC material for use as the cathode active material (CAM) in new batteries.

In one embodiment, the calcined lithiated co-precipitate may provide battery performance of greater than 10 mAh/g, or greater than 20, 50, 70, 100, 120, 130, 140, 150, 160, 170, 180, 190, 200 mAh/g. In this embodiment, electrochemical performance is defined by the first cycle capacity when measured in a coin half-cell battery test conducted at a charge-discharge rate of 0.2 C between a voltage range of 3.0-4.4V.

In another embodiment of the method of the first aspect, step (ii) may be followed by scavenging the supernatant for remaining nickel and/or cobalt and/or manganese by precipitation and/or ion exchange.

The feed solution, either before or after the step of removing one or more impurities, may comprise one or more impurities. These impurities may be selected from Ca²⁺, Mg²⁺, Li⁺, Na⁺, K⁺, NH₄⁺, S, F⁻ and Cl⁻; especially selected from Ca²⁺, Mg²⁺, Li⁺, Na⁺, K⁺, S, F⁻ and Cl⁻. Other impurities may additionally or alternatively be present, such as iron, aluminium, copper, zinc, cadmium, chromium, silicon, lead, zirconium and titanium. The impurities may be at a level in the feed solution at which, if included in the final co-precipitate, would have an adverse effect on the performance of a CAM made therefrom.

In one embodiment, the method described herein involves treating a feed solution comprising at least two metals selected from Ni, Co and Mn, if required, to remove some impurities, and optionally mixing the resulting solution with sufficient amounts of other Ni and/or Co and/or Mn containing solution to achieve a required Ni:Mn:Co ratio (or Ni:Co, Ni:Mn, or Co:Mn ratio) in the solution. A co-precipitate is selectively precipitated from the solution optionally in the presence of any remaining impurities, such that the filtered, washed and cleaned co-precipitate may be suitably pure with respect to the impurities and has appropriate properties such that, after further processing, sufficient performance as a battery material may be achieved.

In one embodiment, the precipitation of the co-precipitate is carried out in the presence of some impurities. That is, some impurities present in the feed solution (or in a solid material used to generate the feed solution) may not be removed from that solution prior to the precipitation step. The amount of these impurities which appear in the co-precipitate may be controlled through control of upstream impurity removal or separation steps, and through control of the precipitation step and subsequent precursor washing and cleaning steps, such that these impurities either do not appear in the initially formed co-precipitate, or appear in the initially formed co-precipitate but are subsequently washed out or removed, or they appear in the final co-precipitate at a concentration and in a form that sufficient performance of the precursor material in its intended use as a battery cathode material is achieved. It should be understood in this context that the “initially formed co-precipitate” refers here to the material initially precipitated from the aqueous feed solution following pH adjustment, and the “final co-precipitate” refers to the solid material produced from the initially formed co-precipitate following any subsequent purification steps (e.g. washing, drying) as described herein. The final co-precipitate may then be used a precursor material for manufacture of lithium ion batteries. In one embodiment, the co-precipitate as described herein is an initially formed co-precipitate.

The conventional or standard approach to production of precursor materials is to start with a very high purity Ni or Co or Mn material such as a salt of sulphate, metal, hydroxide, oxide, carbonate, etc, and dissolve this material into a sulphate solution. Solutions of the three elements are then mixed together to achieve the required ratio of Ni:Co:Mn. The resulting solution contains no or insignificant amounts of any impurity elements. This NiMnCo solution may be mixed with some ammonia containing solution as well, as ammonia can act as a complexing agent which can favourably mediate the precipitation reaction. The precursor is then precipitated using sodium hydroxide or sodium carbonate or combinations of the above sodium or ammonium hydroxide and carbonates. This causes precipitation of a mixed Ni/Co/Mn-containing oxide or carbonate or mixture of oxide and carbonates. The precipitated material is then filtered and washed with water. It is also sometimes washed or mixed again with additional sodium carbonate solution which will cause any remaining sulphate ions to be extracted. In this way, a typical precursor material with suitable battery performance is produced from very high purity feed materials.

The main reasons for this standard approach is because the production of battery precursor materials is thought to require very high purity feed material in order to avoid contamination of the battery material with any impurity elements which could negatively affect the performance of the battery.

However, the inventors have surprisingly discovered that some elements can be present during the precursor production process with no negative effect on the battery material performance. This means that it is possible to use feed materials and processes which introduce these elements to the solution without them contaminating or negatively effecting the precursor product. In some embodiments, at least one impurity may be added to the aqueous feed solution prior to co-precipitation. This may assist with the co-precipitation step (for example when the at least one impurity comprises sodium and potassium salts).

The materials used to prepare the aqueous feed solution used in the method of the present invention may include those discussed in the co-pending application referenced above. They may also include Ni or Co or Mn materials which do not contain significant amounts of more than one of the Ni or Co or Mn, although they may also include one or more impurities. In one embodiment, at least one of the Ni, Co or Mn materials may include at least one impurity. Hence, the selective leaching conditions discussed for the co-pending application referenced above also apply here to any of the individual materials being used. These impurities need only be removed from the aqueous feed solution prior to the step of pH adjustment to a concentration such that sufficient performance as a battery material is achieved by the final co-precipitate. The presence of some of these impurities may actually improve the performance of the battery material in some instances.

Alkali metals such as Li(I), Na(I) and K(I) are generally highly soluble in acidic solution and do not display stabilisation or oxidative precipitation behaviour and as such will typically dissolve at the leaching conditions used in the preparation of the aqueous feed solution. Alkaline earth metals such as Mg(II) generally display similar behaviour. Alkaline earth metals such as Ca(II) are also generally soluble however in sulphuric acid can be limited to a relatively low concentration by the solubility of various sulphate compounds. Hence these elements may be present in the feed solution. However, alkali metals such as Li, Na and K are generally soluble in aqueous solution up to pH values greater than 12, and hence generally do not significantly precipitate or co-precipitate. Alkaline earth metals such as Mg may precipitate at about pH 8-9 as a hydroxide or as a carbonate. Alkaline earth metals such as Ca may precipitate at about pH 8-9 as a carbonate and at about pH 9-10 as a hydroxide. Hence careful control of the pH, and also possibly variables such as base addition, initial concentration of elements in solution and final concentration of elements in solution (and other variables which may effect this precipitation behaviour, which may for example include temperature, reagent addition rate, reagent concentration and washing conditions) during the co-precipitation step, and possibly also selection of the precipitation reagent allows control of the behaviour of these elements during the formation of the co-precipitate (or of the final co-precipitate if multiple precipitation steps and/or multiple washing steps are used). Despite the Li, Na and K being soluble up to higher pH values than that at which the co-precipitate is precipitated, these elements can still substantially contaminate the solid product if selective precipitation and washing is not carried out, especially in cases where the amount of these elements in the supernatant after co-precipitate precipitation is higher than it would be if the reagent was added only for the precipitation of the co-precipitate itself.

This means that as a feed material for preparing the feed solution, any Ni or Co or Mn-containing material which also contains significant Li, Na, K, Mg, or Ca impurities may be used, and rather than removing these impurities only by selective dissolution and impurity removal and/or separation steps, any negative effect of these elements on the battery performance may be avoided by methods as described herein which may involve control of the precursor precipitation, washing and cleaning processes.

Step (ii) of the method described herein may be carried out using, for example, any one or more of sodium carbonate, sodium hydroxide, potassium carbonate, potassium hydroxide, lithium carbonate, lithium hydroxide, ammonia, ammonium carbonate and ammonium hydroxide as precipitation reagents (e.g. to adjust the pH of the feed solution).

Step (ii) of the method described herein may be performed for any suitable time. For example, step (ii) may be performed for at least 1 hour, 2 hours, 4 hours, 8 hours, 16 hours, 24 hours, 36 hour or 48 hours.

Careful control of the concentration of Ni, Co and/or Mn in the feed solution, the Ni, Co and Mn solution addition rate, rate of adjustment of pH, temperature, reaction time, ageing time, and many other factors such as presence of complexing ions such as ammonia may be used to carry out precipitation of the precursor material at the targeted ratio of Ni:Mn:Co to produce an initial co-precipitate which may then be filtered and washed to achieve a battery precursor material with sufficient performance. After the initial co-precipitate is formed, the environment in which the at least two metals are present in may be controlled to minimise or ameliorate any oxidation of the at least two metals, or to maximise oxidation of the at least two metals. Such control may comprise controlling the atmosphere surrounding the at least two metals or co-precipitate, or initial co-precipitate or final co-precipitate. Controlling the atmosphere may comprise controlling the oxygen concentration in the atmosphere or any gas phase, the pressure of the atmosphere or any gas phase.

It has been thought that for a suitable co-precipitate cathode active material (precursor material) in the form of a hydroxide, the amount of nickel, manganese and/or cobalt in the co-precipitate should preferably be at least about 60% of the material on a dry solid basis. The other approximately 40% may be oxide or hydroxide or carbonate. In this 60% of the material the impurity limits are generally specified at 3000-4000 ppm for the anionic species such as SO₄²⁻, F⁻ and Cl⁻ (but excluding the abovementioned oxide, hydroxide or carbonate); 300 ppm for the alkali and alkaline earth metals (except for lithium) (or for alkaline earth metals); 50 ppm for metals and metalloids. Thus anions (especially except hydroxide, oxide and carbonate) may have a molar ratio (or mass ratio) of about 200:1 of NMC to impurity. The Ca and Mg (or Ca, Mg, Na, and K) at 300 ppm provides a molar ratio (or mass ratio) in the solid of about 2000:1 NMC to impurity, and the Fe for example at 50 ppm gives about a 12,000:1 NMC to impurity molar ratio (or mass ratio).

The total amount of nickel, manganese and/or cobalt in the aqueous feed solution may be at least 1 g/L, or at least 5 g/L, or at least 8 g/L, or at least 10 g/L or at least 15 g/L or at least 20 g/L, or at least 30 g/L or at least 50 g/L or at least 70 g/L or at least 90 g/L or at least 120 g/L or at least 150 g/L or at least 200 g/L.

In one embodiment the amount of the at least two metals in the co-precipitate is controlled to be less than 100% of the at least two metals in the aqueous feed solution. In one embodiment, the amount of the at least two metals in the co-precipitate is controlled to be less than 99%, less than 95%, less than 90%, less than 80%, or less than 70%, or less than 50%, or less than 20%. of the at least two metals in the aqueous feed solution. The amount of nickel, manganese and cobalt in the co-precipitate relative to the amount in the aqueous feed solution may be a different percentage to each other or may be the same.

In one embodiment, the supernatant in step (ii) comprises less than 1 mg/L, or more than 1 mg/L, or more than 5, 10, 100, 200, 500 or 1000 mg/L of Ni, Co or Mn.

In one embodiment, the concentration of alkali metal (such as Na, Li, K) (or at least one alkali metal) in the aqueous feed solution is less than or equal to 100,000 ppm, or less than or equal to 80,000 ppm, or less than or equal to 60,000 ppm, or less than or equal to 50,000 ppm, or less than or equal to 40,000 ppm, or less than or equal to 30,000 ppm, or less than or equal to 20,000 ppm, or less than or equal to 15,000 ppm, or less than or equal to 10,000 ppm, or less than or equal to 7,000 ppm, or less than or equal to 5,000 ppm, or less than or equal to 4,000 ppm, or less than less than or equal to 3,000 ppm, or less than or equal to 2,500 ppm, or less than or equal to 2,000 ppm. In another embodiment, the molar ratio of the at least two metals to alkali metal impurities (or at least one alkali metal impurity) in the aqueous feed solution may be greater than about 1:50, or greater than about 1:10, or greater than about 1:5, or greater than about 1:1, or greater than about 5:1, or greater than about 10:1, or greater than about 20:1, or greater than about 50:1, or greater than about 80:1, or greater than about 100:1, or greater than about 120:1, or greater than about 150:1, or greater than about 180:1 or greater than about 200:1. In another embodiment, the molar ratio of the at least two metals to alkali metal impurities (or at least one alkali metal impurity) in the aqueous feed solution may be less than about 1:1, or less than about 5:1, or less than about 10:1, or less than about 20:1, or less than about 50:1, or less than about 80:1, or less than about 100:1, or less than about 120:1, or less than about 150:1, or less than about 180:1 or less than about 200:1. In another embodiment, the molar ratio of the at least two metals to alkali metal impurities (or at least one alkali metal impurity) in the aqueous feed solution may be from about 1:10 to 23,000:1, or from about 1:10 to 100,000,000:1, or from about 1:10 to 300,000,000:1. In another embodiment, the molar ratio of the at least two metals to alkali metal impurities (or at least one alkali metal impurity) in the aqueous feed solution may be from about 1:50 to 23,000:1, or from about 1:50 to 100,000,000:1, or from about 1:50 to 300,000,000:1. In one embodiment, the alkali metal impurities are not derived from a precipitation reagent.

In one embodiment the percentage of alkali metals present in the aqueous feed solution that result in co-precipitate is less than 100% or less than 99% or less than 90%, or less than 50%, or less than 20% or less than 1%.

In another embodiment, the co-precipitate comprises less than 10 ppm of alkali metals in the dry solids, or less than 250 ppm, or less than 500 ppm, or less than 1000 ppm or less than 2000 ppm, or less than 5000 ppm, or less than 20000 ppm.

In one embodiment, the concentration of anionic species impurities (such as F⁻ and Cl⁻ (but especially excluding the abovementioned oxide, hydroxide, sulfate or carbonate) (or at least one anionic species impurity) in the aqueous feed solution is less than or equal to 100,000 ppm, or less than or equal to 80,000 ppm, or less than or equal to 60,000 ppm, or less than or equal to 50,000 ppm, or less than or equal to 40,000 ppm, or less than or equal to 30,000 ppm or less than or equal to 20,000 ppm, or less than or equal to 10,000 ppm, or less than or equal to 5,000 ppm, or less than or equal to 4,000 ppm, especially less than or equal to 3,000 ppm or less than or equal to 2,500 ppm or less than or equal to 2,000 ppm. In another embodiment, the molar ratio of the at least two metals to anionic species impurities (or at least one anionic species impurity) in the aqueous feed solution may be greater than about 1:10, or greater than about 1:5, or greater than about 1:1, or greater than about 5:1, or greater than about 10:1, or greater than about 20:1, or greater than about 50:1, or greater than about 80:1, or greater than about 100:1, or greater than about 120:1, or greater than about 150:1, or greater than about 180:1 or greater than about 200:1. In another embodiment, the molar ratio of the at least two metals to anionic species impurities (or at least one anionic species impurity) in the aqueous feed solution may be less than about 5:1, or less than about 10:1, or less than about 20:1, or less than about 50:1, or less than about 80:1, or less than about 100:1, or less than about 120:1, or less than about 150:1, or less than about 180:1 or less than about 200:1.

In one embodiment the percentage of anionic species present in the aqueous feed solution that result in the co-precipitate is less than 100% or less than 99% or less than 90% or less than 50%, or less than 20% or less than 1%.

In another embodiment, the co-precipitate comprises less than 10 ppm of anions (excluding hydroxide, oxide, carbonate or bicarbonate anions) in the dry solids, or less than 250 ppm, or less than 500 ppm, or less than 1000 ppm or less than 2000 ppm, or less than 5000 ppm, or less than 20000 ppm.

Without wishing to be bound by theory, the inventors believe that due to phenomena such as liquor entrainment and atomic substitution, some anions (in particular F⁻, PO₄³⁻ Cl⁻, SO₄²⁻ and NO₃⁻) may present themselves in the co-precipitate or in the supernatant after physical separation is carried out. The inventors have advantageously found that these anionic impurities can be largely controlled using the specified methods. Such anions may be removed by washing or reslurrying the co-precipitate to the extent required or by reaction with the wash or reslurry solution.

In another embodiment, the concentration of alkaline earth metal impurities (such as Ca and Mg) (or at least one alkaline earth metal impurity) in the aqueous feed solution is less than 900,000 ppm, or less than 700,000 ppm, or less than 500,000 ppm, or less than 200,000 ppm, or less than 100,000 ppm, or less than 50,000 ppm, or less than 40,000 ppm, or less than 30,000 ppm, or less than 20,000 ppm, or less than 10,000 ppm, or less than 5,000 ppm, or less than 1,000 ppm, or less than 800 ppm, or less than 600 ppm, or less than 500 ppm, or less than 400 ppm, or less than 300 ppm, or less than 250 ppm or less than 200 ppm, or less than 150 ppm, or less than 100 ppm, or less than 50 ppm, or less than 20 ppm, or less than 10 ppm, or less than 5 ppm, or less than 1 ppm, or less than 100 ppb, or less than 10 ppb. In a further embodiment, the concentration of alkaline earth metal impurities (such as Ca and Mg) (or at least one alkaline earth metal impurity) in the aqueous feed solution is more than 900,000 ppm, or more than 700,000 ppm, or more than 500,000 ppm, or more than 200,000 ppm, or more than 100,000 ppm, or more than 50,000 ppm, or more than 40,000 ppm, or more than 30,000 ppm, or more than 20,000 ppm, or more than 10,000 ppm, or more than 5,000 ppm, or more than 1,000 ppm, or more than 800 ppm, or more than 600 ppm, or more than 500 ppm, or more than 400 ppm, or more than 300 ppm, or more than 250 ppm or more than 200 ppm, or more than 150 ppm, or more than 100 ppm, or more than 50 ppm, or more than 20 ppm, or more than 10 ppm, or more than 5 ppm, or more than 1 ppm, or more than 100 ppb, or more than 10 ppb. In a further embodiment, the molar ratio of the at least two metals to alkaline earth metal impurities (or at least one alkaline earth metal impurity) in the aqueous feed solution is greater than about 1:50, or greater than about 1:20, or greater than about 1:10, or greater than about 1:1, or greater than about 10:1, or greater than about 50:1, or greater than about 100:1, or greater than about 200:1, or 500:1, or greater than about 1000:1, or greater than about 1500:1, or greater than about 2000:1, or greater than about 5,000:1 or greater than about 10,000:1. In one embodiment, the molar ratio of the at least two metals to alkaline earth metal impurities (or at least one alkaline earth metal impurity) in the aqueous feed solution is from about 300,000,000:1 to about 1:10; or greater than about 1:10, or greater than 1:1. In one embodiment, the molar ratio of the at least two metals to alkaline earth metal impurities (or at least one alkaline earth metal impurity) in the aqueous feed solution is less than 1:50, or less than 1:20, or less than 1:10, or less than 1:5 or less than 1:1, or less than about 5:1, or less than about 10:1, or less than about 20:1, or less than about 50:1, or less than about 80:1, or less than about 100:1, or less than about 120:1, or less than about 150:1, or less than about 180:1, or less than about 200:1, or less than about 500:1, or less than about 1000:1, or less than about 2000:1, or less than about 5000:1, or less than about 10,000:1. In one embodiment, the ratio (by weight) of the at least two metals:alkaline earth metals in the aqueous feed solution is less than 10,000:1. In one embodiment, the ratio (by weight) of the at least two metals: calcium in the aqueous feed solution is less than 10,000:1. In a further embodiment, the ratio (by weight) of the at least two metals: magnesium in the aqueous feed solution is less than 10,000:1. In one embodiment, the ratio (by weight) of the at least two metals: metals other than nickel, cobalt, manganese and alkaline earth metals and/or alkali metals in the aqueous feed solution is less than 6,000:1.

In one embodiment the percentage of alkaline earth metal species present in the aqueous feed solution that report to in the co-precipitate is less than 100%, or less than 99%, or less than 90%, or less than 70%, or less than 50%, or less than 10% or less than 1%, or less than 0.5% or less than 0.1%.

In another embodiment, the co-precipitate comprises less than 10 ppm of alkaline earth metals in the dry solids, or less than 250 ppm, or less than 500 ppm, or less than 1000 ppm or less than 2000 ppm, or less than 5000 ppm, or less than 10000 ppm.

In a further embodiment, the concentration of metal and metalloid impurities (or at least one metal or metalloid impurity) in the aqueous feed solution is less than 250 ppm, especially less than 50 ppm. In a further embodiment, the concentration of metal and metalloid impurities (or at least one metal or metalloid impurity) in the aqueous feed solution is more than 1 ppb, especially more than 100 ppb, or more than 1 mg/L, or more than 5 mg/L, or more than 10 mg/L or more than 20 mg/L or more than 50 mg/L. Exemplary metal and metalloid impurities may be selected from the group consisting of: iron, aluminium, copper, zinc, cadmium, chromium, silicon, lead, zirconium, scandium and titanium, among others. In one embodiment, the molar ratio of the at least two metals to metal and metalloid impurities (or at least one metal or metalloid impurity) is less than 50:1, or less than 100:1, or less than 500:1, or less than 1,000:1, or less than 5,000:1, or less than 10,000:1, or less than 20,000:1, or less than 40,000:1, or less than 60,000:1, or less than 80,000:1, or less than 100,000:1, or less than 500,000:1. In one embodiment, the molar ratio of the at least two metals to Fe impurities is from about 300,000,000:1 to about 10,000:1; or greater than about 10,000:1, or greater than 12,000:1. In one embodiment, the molar ratio of the at least two metals to Fe impurities is less than 10,000:1, or less than 20,000:1, or less than 100,000:1, or less than 500,000:1, or less than 1,000,000:1. In one embodiment, the molar ratio of the at least two metals to Al impurities is from about 300,000,000:1 to about 10,000:1; or greater than about 10,000:1, or greater than 12,000:1. In one embodiment, the molar ratio of the at least two metals to Al impurities is less than 10,000:1, or less than 20,000:1 or less than 100,000:1.

In one embodiment, the ratio (by weight) of the at least two metals: iron in the aqueous feed solution is less than 16,000:1. In one embodiment, the ratio (by weight) of the at least two metals: copper in the aqueous feed solution is less than 6,000:1. In one embodiment, the ratio (by weight) of the at least two metals: aluminium in the aqueous feed solution is less than 10,000:1. In one embodiment, the ratio (by weight) of the at least two metals: niobium in the aqueous feed solution is less than 500,000:1. In one embodiment, the ratio (by weight) of the at least two metals: tungsten in the aqueous feed solution is less than 500,000:1. In one embodiment, the ratio (by weight) of the at least two metals: zirconium in the aqueous feed solution is less than 500,000:1.

In one embodiment the percentage of metal and metalloid species present in the aqueous feed solution that result in the co-precipitate is less than 90%, or less than 10% or less than 1%.

In another embodiment, the co-precipitate comprises less than 10 ppm of metal and metalloid species in the dry solids, or less than 250 ppm, or less than 500 ppm, or less than 1000 ppm or less than 2000 ppm, or less than 5000 ppm, or less than 10,000 ppm.

The inventors have however found that the above specifications in some cases may be somewhat arbitrary. For example Ca and Mg in the final co-precipitate up to 500 or 1000 ppm does not appear to have a significant impact on the battery material performance. It is therefore likely that lower ratios could be acceptable for these elements. It is considered that a calcium level of up to 1000:1 of the at least two metals: Ca could be present in the co-precipitate with no negative effect.

As set out elsewhere herein, when producing the final co-precipitate using the method of the present invention, it is possible to largely avoid precipitation of many of these elements, while for other elements a certain degree of co-precipitation is relatively unavoidable. In the latter case, however, the co-precipitation of impurities may have little effect on the performance of the final co-precipitate, or provide acceptable performance of the final co-precipitate when used in a battery material.

Using Mg as an example, it has been possible to achieve Mg co-precipitation at 100%, close to 100%, less than 100%, less than 50%, down to substantially less than 10%. If one assumes 1% Mg precipitation from solution, and precipitation of Ni, Co and Mn, a ratio of the at least two metals: Mg in the feed solution of 10:1 would enable a ratio of 1000:1 of the at least two metals: Mg in the co-precipitate to be achieved.

The inventors have found that even less Mg co-precipitation is possible and have demonstrated that a feed solution containing 1:17 of the two metals: Mg was viable for creating an acceptable co-precipitate. Therefore, feed solutions having up to 1:10 or even 1:50 the at least two metals: Mg may provide an acceptable co-precipitate at the desired Mg ratio. Feed solutions having up to 1:1 or even 1:10 the at least two metals: Mg may also provide an acceptable co-precipitate. Similar ratios for Ca are also likely to be achievable.

For other elements such as Fe, the coprecipitation may be 100%, close to 100% or less than 100%. At 100% coprecipitation of Fe, and 100% precipitation of the at least two metals, in order to achieve a ratio of the at least two metals: Fe in the initial co-precipitate of 12,000:1, which is approximately equivalent to 50 ppm concentration target in the final co-precipitate, a ratio of the at least two metals: Fe in the solution of 12000:1 would be an upper limit. In this case, the method may still allow treatment of this aqueous feed solution to produce the coprecipitate. However if less than 100% coprecipitation of Fe is carried out, the ratio of the at least two metals: Fe in the aqueous feed solution may be lower than 12,000:1 and less than 50 ppm of Fe may be achieved in the co-precipitate. It is also possible that more than 50 ppm Fe or other element may be tolerated in the final co-precipitate with no significant effect on the battery material performance.

Conversely, it is highly unlikely that feed solutions having no impurities would be readily available or would be used in the invention. A practical minimum of each impurity present, or of the combined impurities, may be around 2 ppb, or about 3, 5, 10, 50, 100, 200 or 500 ppb, or about 1, 2, 5, 10, 50, 100, 200, 500, 1000, 2000, 5000 or 10000 ppm.

In one embodiment, the amount of the at least one impurities relative to the at least two metals in the co-precipitate is less than the amount of the at least one impurities relative to the at least two metals in the aqueous feed solution. In one embodiment, the co-precipitate comprises less than 100% of the at least one impurity in the aqueous feed solution, especially less than 90%, or 80% or 70% or 60% or 50% or 40% or 30% or 20% or 10% of the at least one impurity in the aqueous feed solution. In one embodiment, the co-precipitate comprises less than 100% of the alkali metals and anions in the aqueous feed solution, especially less than 90%, or 80% or 70% or 60% or 50% or 40% or 30% or 20% or 10% of the alkali metals and anions in the aqueous feed solution. In one embodiment, the co-precipitate comprises less than 100% of the alkaline earth metals in the aqueous feed solution, especially less than 90%, or 80% or 70% or 60% or 50% or 40% or 30% or 20% or 10% of the alkaline earth metals in the aqueous feed solution. In one embodiment, the co-precipitate comprises less than 100% of the alkali metals and ionic species in the aqueous feed solution; and the supernatant comprises at least 0.1% of the alkaline earth metals, less than 100% of the alkali metals and ionic species and less than 100% of metals other than alkali metals and alkaline earth metals in the aqueous feed solution.

In one embodiment, at least 1% and up to 100% of the nickel, cobalt and/or manganese is derived from an impure feed source (in which the ratio of nickel, cobalt and/or manganese: impurity is less than 0.01:1, less than 0.1:1, less than 1:1, less than 10:1, less than 100:1, less than 500:1, less than 1000:1, less than 5000:1, less than 10,000:1, less than 50,000:1, less than 200,00:1 or less than 500,000:1.

The inventors have advantageously found that by processing impure solutions, levels of beneficial impurities can be controlled in the final product. In prior art processes, such beneficial impurities (such as Mg or Al) may be added in separately as dopants. The methods of the present invention may allow for this cost to be avoided while still producing an acceptable co-precipitate. This allows for a wide variety of feed materials to used in the methods. This is also especially important in cases of some specific feed materials which contain impurities which may also be used as dopants, for example aluminium and magnesium; or where a recycled battery feed material is used as these recycled materials may contain impurities which can also be used as dopants, and employing the methods described may allow these impurities present in that feed material to be controlled in such a way that they report to the supernatant and to the co-precipitate at desired concentrations. In all of these cases, a substantial portion of the desirable dopant element may be derived from a feed material comprising the at least one metal and at least one impurity.

As previously discussed, a typical prior process was to dissolve highly purified, individual nickel, cobalt and manganese sulphate salt feed materials into a solution at specific ratios and purities, and then carry out a co-precipitation on that solution. In such a process such salt feed materials may have, for example, 5 ppm or less of impurities. Two examples of the specifications required for use of a nickel sulphate hexa hydrate salt in the preparation of NMC material is shown in the table below. Given the very low allowable impurity concentrations of these salts for production of NMC material, the solution used for NMC precipitation would have equivalently low NMC:impurity ratios, as indicated in the second table. Avoiding the cost of purifying the feed material to this very low concentration of impurity is a major advantage of the current invention as the current invention is able to produce NMC materials from materials containing more impurities without the need to carry out expensive steps to remove said impurities from the solution prior to the NMC production.

| | A | B |
|---|---|---|
| Nickel, mass % | >22.3 | >22.2 |
| Cobalt, ppm | <10 | <10 |
| Manganese, ppm | <2 | <10 |
| Iron, ppm | <3 | <10 |
| Copper, ppm | <1 | <5 |
| Sodium, ppm | <15 | <20 |
| Calcium, ppm | <4 | <5 |
| Magnesium, ppm | <10 | <10 |
| Zinc, ppm | <3 | <5 |
| Lead, ppm | <5 | <5 |
| Chromium, ppm | <5 | <5 |
| Cadmium, ppm | <1 | <5 |
| Aluminium, ppm | <5 | <5 |
| Silicon, ppm | <10 | <20 |
| Potassium, ppm | <10 | <20 |
| Chloride, ppm | <10 | <5 |
| Fluoride, ppm | <1 | <1 |
| Arsenic, ppm | <1 | <5 |

| | Mass Ratio | Mass Ratio | Mole Ratio | Mole Ratio |
|---|---|---|---|---|
| | Ni:Impurity | Ni:Impurity | Ni:Impurity | Ni:Impurity |
| | A | B | A | B |
| Cobalt | <22300 | <22300 | <22391 | <22391 |
| Manganese | <111500 | <22300 | <104367 | <20873 |
| Iron | <74333 | <22300 | <70726 | <21218 |
| Copper | <223000 | <44600 | <241439 | <48288 |
| Sodium | <14867 | <11150 | <5823 | <4367 |
| Calcium | <55750 | <44600 | <38068 | <30455 |
| Magnesium | <22300 | <22300 | <9235 | <9235 |
| Zinc | <74333 | <44600 | <82802 | <49681 |
| Lead | <44600 | <44600 | <157448 | <157448 |
| Chromium | <44600 | <44600 | <39511 | <39511 |
| Cadmium | <223000 | <44600 | <427109 | <85422 |
| Aluminium | <44600 | <44600 | <20503 | <20503 |
| Silicon | <22300 | <11150 | <10671 | <5336 |
| Potassium | <22300 | <11150 | <14855 | <7428 |
| Chloride | <22300 | <44600 | <13470 | <26940 |
| Fluoride | <223000 | <223000 | <72182 | <72182 |
| Arsenic | <223000 | <44600 | <284661 | <56932 |

In some prior art documents, a feed material used to prepare a solution for NMC co-precipitation is an NMC like material or a material which was previously or could have been used as a battery cathode which may contain some impurity elements, as well as containing at least one of the Ni, Co and Mn elements. In such cases, very few if any impurities may be present in the feed material, or the impurities that are present in the feed material are at such low concentrations that the material would be equivalent to the standard highly purified feed material. In such cases, the co-precipitation can be under non-selective conditions.

Feed materials for use in the methods (or the feed mixture in step A) may include recycled materials, ore products, intermediate ore products, and/or NMC salts that comprise an impurity.

Recycled materials may include, but are not limited to, spent lithium-ion batteries (black mass) and used catalysts comprising nickel, cobalt and/or manganese. The recycled material may comprise at least one of Co/Mn/Ni and also at least one impurity. Many prior art processes fail to consider the presence of impurities such the following for black mass: Zn, Cr, W, P, Ti, S, Pb, K, Mo, Nb, Ba, Cd, V, Rb, Y, Zr, Pt, Sb, Sc, Si and/or Sn. Such impurities may be substantially or completely removed from a co-precipitate formed by the methods of the present application. In some cases, in some recycled materials some impurity elements are present through contamination or are present through variation in the initial lithium ion battery composition.

Ore and ore intermediate products comprising one or more of nickel, cobalt and manganese may be leached to make an aqueous feed solution suitable for co-precipitation. Such feeds may inherently contain impurities, and may comprise laterites and sulphides (and flotation concentrates thereof) as well as more processed feeds such as MHP and MSP. To the inventors' knowledge the production of a co-precipitate from such feed materials which comprise impurities of types and at the concentrations present in such ore and ore intermediate products have not been considered in the prior art.

NMC salts that comprise an impurity may be, for example, a combination of pure Co and Mn salts with an Ni salt containing at least one impurity or other combinations of pure and impure salts.

In one embodiment, step (ii) may comprise the steps of: performing the co-precipitation at a lower pH, altering the method of base dosing, changing the type of base, adding a precipitation agent or adjusting the concentration of the at least two metals in the aqueous feed solution. Such steps may assist in controlling the selectivity of the co-precipitation. By way of example, a carbonate base (such as sodium carbonate) may be less suitable for an aqueous feed solution comprising a high concentration of Ca due to formation of stable CaCO₃. In this case a hydroxide base may enhance selectivity. The method of base dosing may comprise continuous, semi-continuous, semi-batch or batch dosing, or a combination thereof. The methods of the present invention may also assist in controlling the physical properties of the co-precipitate. Such physical properties may comprise particle size, bulk density, tap density, morphology, shape, and crystallinity.

In one embodiment, the co-precipitation step (step (ii)) may comprise adding a precipitation agent to the feed solution. The precipitation agent may be an oxidant, a base or an organic anion compound. The oxidant and the reductant may be as defined elsewhere in the present specification. The organic anion compound may comprise oxalate. The precipitation agent may be added in a stoichiometric amount to the at least two metals (for example at least 1, 1.5, 2, 2.5 or 3 equivalents of precipitation agent). The precipitation agent may be added in a sub-stoichiometric amount to the at least two metals (for example less than 1, 0.9, 0.8, 0.7 or 0.6 equivalents of precipitation agent). Use of a sub-stoichiometric amount of precipitation agent may result in recover of less than 100% of the at least two metals from the feed solution.

Following the co-precipitation step (step (ii)), the method may additionally comprise mixing with lithium. It may comprise calcining. These steps may result in production of a cathode active material (CAM).

It is also possible to control the oxidation by addition of an oxidising reagent to the feed solution (which may include controlling or adding an oxidising agent in gaseous form) so as to cause oxidation of one or more of Mn, Co and Ni prior to step (ii) in order to adjust or achieve a certain ratio of these elements in the solid, and to allow more selectivity of these elements over the impurity elements during the co-precipitation step.

Once the co-precipitate has been formed, it may be separated by any suitable means so as to isolate it. These include settling, centrifuging, filtering, decanting and any combination of these. The method may comprise decanting and/or filtering so as to isolate the co-precipitate. The isolated co-precipitate may then be washed. It may be washed with a suitable wash to remove any unwanted impurities. A suitable wash is an alkaline, water, acid or ammonia wash. The alkaline wash may be at a pH of greater than about 9, or greater than about 10, 11 or 12.

The co-precipitate, optionally after washing, may be supplemented with lithium. Therefore, the method may comprise adding lithium to the co-precipitate. The lithium may be in the form of, for example, lithium hydroxide or lithium carbonate. This may take the form of physically mixing the co-precipitate with the lithium. The lithium may be added in a molar ratio to the sum of Ni, Co and Mn of greater than about 1:1.

The co-precipitate may be dried. It may be dried at any suitable temperature, e.g. between about 80 and about 150° C., or between about 80 and 100, 100 and 150, 100 and 130, 130 and 150 or 90 and 120° C., e.g. about 80, 90, 100, 110, 120, 130, 140 or 150° C. It may be performed by passing air or some other gas through the co-precipitate at the designated temperature, or it may comprise allowing the co-precipitate to rest at that temperature. The time of drying may be sufficient to achieve a moisture level of less than about 10%, or less than about 5, 2, 1, 0.5, 0.2 or 0.1% on a weight basis. It may be for at least about 5 hours, or at least about 6, 7, 8, 9 or 10 hours, or from about 5 to about 20 hours, or about 5 to 15, 5 to 10, 10 to 15, 15 to 20 or 7 to 12 hours, e.g. about 5, 6, 7, 8, 9, 10, 11, 12, 13, 14 or 15 hours.

In one embodiment, steps (i) and (ii) of the method of the first aspect may be repeated. That is, the method may comprise:
(i) providing an aqueous feed solution comprising said at least one metal (or at least two metals) and at least one impurity; and
(ii) adjusting the pH of the feed solution to between about 6.2 and about 11, optionally between about 6.2 and about 10 or between about 6.2 and about 9.2, so as to provide: (a) a co-precipitate comprising said at least one metal (or at least two metals); and (b) a supernatant comprising said at least one impurity;
(iii) separating the co-precipitate from the supernatant;
(iv) dissolving the co-precipitate in solution to provide a solution in which the at least one metal (or at least two metals) are at least partially dissolved; and
(v) adjusting the pH of the solution of step (iv) to between about 6.2 and about 11, optionally between about 6.2 and about 10 or between about 6.2 and about 9.2, so as to provide: (a) a co-precipitate comprising said at least one metal (or at least two metals) at least two metals; and (b) a supernatant comprising said at least one impurity.
   In one embodiment, step (iv) may comprise dissolving the co-precipitate in an acidic solution. Features of step (v) may be as described above for step (ii). This method may advantageously permit easier separation of impurities. For example, the pH of the solution in step (v) may be higher than the pH of the solution at step (ii).

In one embodiment, the method further comprises the step of producing a lithium ion battery using the co-precipitate.

According to a second aspect of the present invention there is provided a method of producing a precipitate comprising at least one metal selected from nickel, cobalt and manganese, the method comprising:
(i) providing an aqueous feed solution comprising said at least one metal; and
(ii) adjusting the pH of the feed solution to between about 6.2 and about 11, optionally between about 6.2 and about 10 or between about 6.2 and about 9.2, so as to precipitate said at least one metal from the feed solution.

The aqueous feed may comprise at least one impurity. Accordingly, the step of adjusting the pH of the feed solution may provide a supernatant which comprises said at least one impurity. Therefore, in one embodiment of the second aspect there is provided a method of producing a precipitate, wherein the precipitate comprises at least one metal selected from nickel, cobalt and manganese, the method comprising:
(i) providing an aqueous feed solution comprising said at least one metal and at least one impurity; and
(ii) adjusting the pH of the feed solution to between about 6.2 and about 11, optionally between about 6.2 and about 10 or between about 6.2 and about 9.2, so as to provide: (a) a precipitate comprising said at least one metal; and (b) a supernatant comprising said at least one impurity.

Features of the second aspect may be as described above for the first aspect. Where context permits, references to “the at least two metals” in the first aspect may be a reference to “the at least one metal” for the second aspect. Similarly, where context permits, references to “the co-precipitate” in the first aspect may be a reference to “the precipitate” for the second aspect.

In a third aspect, there is provided a co-precipitate (or precipitate) comprising at least two metals selected from nickel, cobalt and manganese, said co-precipitate (or precipitate) being produced by the method of the first or the second aspect.

The present invention is directed to formation of a co-precipitate comprising nickel, manganese and/or cobalt which is suitable for use as a precursor material for producing lithium ion batteries. Mixtures of Ni, Co and/or Mn containing materials which contain some level of impurities may be dissolved at least partially selectively, for example using the process described in the present application. The resulting solution may be treated, if required, to remove some impurities and may be mixed with sufficient amounts of one or more other Ni and/or Co and/or Mn containing solutions to achieve a required Ni:Mn:Co ratio. A co-precipitate may then be selectively formed in that solution, in the presence of any remaining impurities, such that the filtered, washed and cleaned product is suitably pure with respect to the impurities and has appropriate properties such that, after further processing, sufficient performance as a battery material may be achieved.

In one embodiment, the co-precipitate has or comprises less than about 1000 ppm iron, or less than 500 ppm iron, or less than 200 ppm iron or less than 100 ppm iron, or less than 50 ppm iron, or less than about 40 ppm iron, or less than about 20 ppm iron, or less than about 10 ppm iron, or less than about 5 ppm iron, or less than about 2.5 ppm iron, or less than about 1 ppm iron. In another embodiment, the co-precipitate comprises less than 50,000 ppm, or less than 20,000 ppm, less than 10,000 ppm, less than 5,000 ppm, less than 2,000 ppm, less than 1,000 ppm, less than 500 ppm, less than 100 ppm, less than 50 ppm, less than 20 ppm, less than 10 ppm or less than 5 ppm magnesium. In another embodiment, the co-precipitate comprises less than 50,000 ppm, or less than 20,000 ppm, less than 10,000 ppm, less than 5,000 ppm, less than 2,000 ppm, less than 1,000 ppm, less than 500 ppm, less than 100 ppm, less than 50 ppm, less than 20 ppm, less than 10 ppm or less than 5 ppm calcium. In another embodiment, the co-precipitate comprises less than 50,000 ppm, or less than 20,000 ppm, less than 10,000 ppm, less than 5,000 ppm, less than 2,000 ppm, less than 1,000 ppm, less than 500 ppm, less than 100 ppm, less than 50 ppm, less than 20 ppm, less than 10 ppm or less than 5 ppm alkaline earth metals. In another embodiment, the co-precipitate comprises less than 2,000 ppm, less than 1,500 ppm, less than 1,000 ppm, less than 500 ppm, less than 200 ppm, less than 100 ppm, less than 50 ppm, less than 20 ppm, less than 10 ppm or less than 5 ppm alkali metals. In another embodiment, the co-precipitate comprises less than 2,000 ppm, less than 1,500 ppm, less than 1,000 ppm, less than 500 ppm, less than 200 ppm, less than 100 ppm, less than 50 ppm, less than 20 ppm, less than 10 ppm or less than 5 ppm of metals other than alkali and alkaline earth metals. In another embodiment, the co-precipitate comprises less than 2,000 ppm, less than 1,500 ppm, less than 1,000 ppm, less than 500 ppm, less than 200 ppm, less than 100 ppm, less than 50 ppm, less than 20 ppm, less than 10 ppm or less than 5 ppm metalloids. In another embodiment, the co-precipitate comprises less than 10,000 ppm, less than 5,000 ppm, less than 3,000 ppm, less than 2,000 ppm, less than 1,500 ppm, less than 1,000 ppm, less than 500 ppm, less than 200 ppm, less than 100 ppm, less than 50 ppm, less than 20 ppm, less than 10 ppm or less than 5 ppm anionic species other than hydroxide or carbonate.

In a fourth aspect, the present invention provides a use of a co-precipitate of the third aspect for producing a lithium ion battery.

Features of the third and fourth aspects of the invention may be as described for the first aspect of the invention.

According to a fifth aspect of the present invention there is provided a method of producing a leachate comprising at least two metals selected from nickel, cobalt and manganese, the method comprising:
A. providing a feed mixture comprising the at least two metals, said feed mixture being one of an oxidised feed, a reduced feed or an unoxidized feed, wherein:
   an oxidised feed has more of the at least two metals in an oxidation state greater than 2 than in an oxidation state less than 2;
   a reduced feed has more of the at least two metals in an oxidation state less than 2 than in an oxidation state greater than 2 or has substantially all of the at least two metals in an oxidation state of 2 and at least some of the at least two metals in the form of their sulfide; and
   an unoxidized feed has substantially all of the at least two metals in an oxidation state of 2 and substantially none of the at least two metals in the form of their sulfide;
B. treating the feed mixture with an aqueous solution to form a leachate comprising said at least two metals, wherein the pH of the aqueous solution is such that the leachate has a pH of between about −1 and about 7 (or between about −1 and about 6; or between about 1 and about 7, or between about 1 and about 6) and wherein:
   if the feed mixture is an oxidised feed, the treating additionally comprises adding a reagent which comprises a reducing agent; and
   if the feed mixture is a reduced feed, the treating additionally comprises adding a reagent which comprises an oxidising agent;
      whereby the leachate comprises the at least two metals in an oxidation state of 2.

Features of the fifth aspect of the invention may be as described for the first or second aspect of the invention.

According to a sixth aspect of the present invention, there is provided a method of producing a leachate comprising at two metals selected from nickel, cobalt and manganese, the method comprising contacting a mixture comprising the at least two metals with an aqueous solution at a pH such that the leachate has a pH of from between about 1 and about 7, (or between about 1 and about 6), to thereby provide said leachate comprising said at least two metals in solution; wherein at least a portion of said at least two metals in the feed mixture has an oxidation state of 2.

The method of the sixth aspect may comprise a step of treating the mixture with a reducing agent. In one embodiment, at least a portion of the nickel, cobalt and/or manganese may be in an oxidised state, and the treating may reduce at least part of the oxidised nickel, cobalt and/or manganese. It will be noted that this embodiment resembles the fifth aspect of the invention. In one embodiment, the method of the sixth aspect may comprise the step of removing one or more impurities from the leachate.

Features of the sixth aspect of the present invention may be as described for the fifth aspect of the present invention.

In a seventh aspect, the present invention provides a leachate comprising at least two metals, optionally all three metals, selected from nickel, cobalt and manganese, said leachate being produced by the method of the fifth aspect.

In an eighth aspect, the present invention provides a leachate comprising at least two metals, optionally all three metals, selected from nickel, cobalt and manganese, said leachate being produced by the method of the sixth aspect.

Any of the features described herein can be combined in any combination with any one or more of the other features described herein within the scope of the invention.

In one embodiment, the present specification is directed towards dissolution of particular metals, in particular the dissolution of two or three of nickel, cobalt and manganese.

The dissolution may be carried out in an at least partially selective manner. This uses control of final pH between about 1 and about 7, or between about 1 and about 6, and control of oxidation and reduction reactions for the purpose of keeping the Ni+Mn, Ni+Co or Mn+Co, or indeed Ni+Mn+Co, together with minimal impurity dissolution and/or minimal loss of the Ni, Co or Mn, and may produce a solution with approximately the correct ratios for precipitation of battery precursor material. The process may then remove and/or separate some impurities from the resulting solution, such that the resulting solution can be used for production of battery precursor material. Depending on the initial solid material this may require the use of a reducing agent, an oxidising agent, both or neither. The material need not necessarily include all of Ni Mn and Co nor all of the Ni, Mn and Co required for the final product. This process is intended to produce a solution for use in production of a precursor material.

An aspect of the process is that a substantial portion of the selected metals are kept together through leaching and impurity removal or separation steps such that the ratio of the Ni:Mn:Co in the resulting leachate can be adjusted and used for precipitation of an NMC type material.

The feed mixture for the present process in an embodiment may include the residue from the SAL process, the product from this process, material from batteries, other oxide materials such as nickel oxide ores, intermediate nickel products like MHP (mixed hydroxide precipitate), MCP (mixed carbonate precipitate) or MSP (mixed sulfide precipitate), other sulfide materials such as nickel sulfide ores, nickel sulfide concentrates or nickel sulfide matte, or metal material, as long as these materials contain significant amounts of at least two of Ni, Co and Mn.

These materials can generally be classified by the oxidation state of the contained Ni, Co and Mn. Nickel and cobalt often exist in metallic form which can be referred to as Ni(0) or Co(0). These may be oxidised to ionic forms Ni(II) or Ni(III), and Co(II) or Co(III). The Mn can exist in Mn(0), Mn(II), Mn(III), Mn(IV) and Mn(VII) forms. Other oxidation states of these elements can exist but are less common. In order to dissolve these metals in a relatively selectively way, the inventors have found that it is convenient to change the oxidation state of the element to the (II) state. Hence any materials where the state of the Ni, Co and Mn are higher than (II) are considered oxidised compared to the desired (II) form, and any materials with an oxidation state lower than (II) are be considered reduced compared to the desired (II) form. The reason to obtain these elements in the (II) state is that in that form, all three of these metals are significantly soluble in acidic solutions of sulfuric, nitric or hydrochloric acid between pH about 1 and up to about pH 6 or 7. Comparatively, the (III), or (IV) in the case of Mn, are only significantly soluble in these acidic solutions below about pH 3. Therefore, obtaining the elements in the (II) state allows them to be dissolved at less acidic conditions. This provides selectivity over many impurities.

The residue from the SAL process has the majority of the Ni as Ni(II), the majority of the Co as Co(III) or a mixed Co(II)/Co(III) form of solid, and the majority of the Mn as Mn(III) or Mn(IV). This could be classified as an oxidised feed. The battery cathode material has the majority of the Ni as Ni(III), the majority of the Co as Co(III) and the majority of the Mn as Mn(III) and Mn(IV). This could be classified as an oxidised feed. Nickel oxide ores can have the Ni as Ni(II) or Ni(III), the Co as Co (II) or Co(III) and the Mn as Mn(II), Mn(III) and Mn(IV). These could be classified as an oxidised feed. MHP and MCP intermediates have the majority of the Ni as Ni(II), the majority of the Co as Co(II) and the majority of the Mn as Mn(II). These would be classified as unoxidized feeds.

MSP and the other sulfide materials have the majority of the Ni as Ni(II), the Co as Co(II). There is typically very little Mn associated with sulfides. The Ni and Co in these sulfhide materials is bonded with sulfur, so in order to dissolve them it is not necessary to oxidise or reduce the Ni or Co but it is necessary to oxidise the sulfur to allow the Ni and Co to be released from the sulfide form. Hence the sulfide sources would be classified as reduced feeds.

The metallic forms will have the majority of the Ni as Ni(0), the majority of the Co as Co(0) and the majority of the Mn as Mn(0), although there may be small amounts of oxide forms of these elements in the (II) state also associated with the metal. These would therefore be classified as reduced feeds

In general, oxidised feeds will need to be reduced by an appropriate reducing agent to allow them to dissolve and form the leachate. The unoxidized feeds will not require significant reducing or oxidising agents to allow the Ni, Co and/or Mn to dissolve so as to form the leachate. The reduced feeds will need to be oxidised by an appropriate oxidising agent to allow them to dissolve so as to form the leachate.

A feature of the present approach in one embodiment is that in oxidised feeds, oxidised nickel will typically be the first element to reduce, followed by oxidised cobalt, and then followed by oxidised manganese. These three elements can be reduced to the desired +2 oxidation state and therefore dissolved in such a way as to control the amount of each of the elements that contributes to the leachate. The choice of reducing agent, or even the use of a reducing agent followed by an oxidising agent can also control the extent of the dissolution of these metals.

Further, this behaviour allows one to reduce and dissolve significant amounts of the Ni/Co/Mn metals before the reducing reagent will react with significant amounts of other elements which can consume reducing agent and/or be dissolved by the reduction reaction. Fe is an example of an element which follows similar behaviour to the Ni and Co. That is, the Fe can exist in Fe(II) and Fe(III) states with the Fe(II) being significantly soluble in acid below about pH 7 while Fe(III) is only significantly soluble below pH about 3. However control of the reduction by careful control of the reagent addition rate, addition amount, reagent selection, temperature, and other parameters can be used to stop or minimise the reduction of the Fe(III) to Fe(II) until after the majority of the Ni, Co and Mn have been reacted to their (II) forms. Alternatively, the reduction can be followed by addition of an oxidant which will react with the Fe(II) and not the Ni(II) Co(II) or Mn(II), or at least react with the Fe(II) before the Ni(II) Co(II) and/or Mn(II), causing the Fe(II) to oxidise back to Fe(III) and revert to the solid phase. Therefore, selective dissolution of Ni/Co/Mn in Ni/Co/Mn containing materials away from Fe can be achieved. The selective dissolution step may then be followed by a solid/liquid separation step for example decantation, centrifugation, settling and/or filtration.

This approach of controlling the reduction and oxidation can also be applied to the reduced materials such as sulfides and metal sources of Ni, Co and Mn. The sulfide materials can be reacted with an oxidant to cause the sulfide portion to oxidise and allow the Ni, Co and Mn to be dissolved. The oxidant and dissolution may be controlled such that the Ni, Co and Mn portions of the material are oxidised and dissolved significantly before other impurity portions of the material are oxidised and/or dissolved, thereby producing a relatively clean solution containing the Ni, Co and Mn. The material or solution may be also oxidised further to cause any impurity elements such as Fe to be oxidised and precipitated before significant amounts of the Mn, Co or Ni are oxidised and precipitated.

Similarly, the metals may be reacted with an oxidant (for example as described above) to cause the contained Ni/Co/Mn portions to oxidise to their (II) state and dissolved, with control of the oxidation extent to avoid dissolution of any other metallic materials which oxidise after the Ni, Co and or Mn metals such as precious metals and platinum group metals, or even more noble metals including copper, lead and tin. Further oxidation can also be used to cause impurity metals such as Fe to be oxidised and precipitated, or even to oxidise and precipitate Mn to allow control of the ratio of Ni:Co:Mn in the solution.

The main leach impurities that are commonly associated with these materials are alkali elements (primary considerations are Li, Na, K), alkaline earth elements (primary considerations are Mg, Ca), transition metals (primary considerations are Sc, Ti, V, Cr, Fe, Cu, Zn, Cd), other metals (primary considerations are Al, Sn, Pb) and metalloids (primary considerations are Si, As, Sb).

Metals such as Li(I), Na(I) and K(I) are highly soluble in acidic solution and do not display the stabilisation or oxidative precipitation behaviour and as such will typically dissolve at the leaching conditions used in the process described herein. Mg(II) displays similar behaviour. Ca(II) is also generally soluble, however in sulfuric acid it will be limited to a relatively low concentration by the solubility of various calcium sulfate compounds. In general, these elements are not of major concern as they are soluble in solution up to pH higher than approximately 8 or 9 and therefore they would not contaminate the battery precursor product as they would remain in the solution during any subsequent precipitation process used to recover Ni, Co and/or Mn.

For other significant impurity elements, Fe dissolution can be controlled by the oxidation and reduction and pH behaviour discussed above. Dissolution of Sc(III), Ti(IV), V(V), Cr(III), Al(III), Sn(IV), As(III), Sb(III) and to some extent of Cu(II), Zn(II) and Cd(II) can be controlled by the leaching pH, as these elements are significantly soluble at lower pH values and not significantly soluble at higher pH values within the range of pH about 1-7 or 1-6. Pb(II) is also generally soluble, however in sulfuric acid will be limited by the solubility of various lead sulfate compounds. Si is generally not significantly soluble in the range of pH about 1-7 or 1-6.

Cr, Sn, As and Sb can all take on other oxidation states which affect their solubility. Commonly higher oxidation states of these elements are more soluble, hence their oxidation or reduction may be controlled so as to achieve the oxidation state noted, which would in turn achieve the desired selectivity of Ni/Co/Mn over these elements.

As discussed above, an aim of the process described in one embodiment herein is to obtain Ni, Co and/or Mn in solution together with minimal impurities by control of the oxidation and reduction reactions and the solution pH.

Subsequent impurity removal steps, such as pH adjustment, ion exchange, solvent extraction, precipitation and/or cementation reactions, may be conducted so as to remove and/or separate further impurities from this solution. For example, Cu, Zn and Cd may be removed from the solution by various ion exchange or solvent extraction processes.

Alternatively or additionally, the any two or all of Ni, Co and Mn may be separated from impurities in the leachate by ion exchange or solvent extraction, such that these remain together.

The ratios of different materials used in the leaching process may be adjusted so as to target a desired ratio of Ni:Co:Mn in the final leachate.

Additional Ni or Co or Mn may also be added to the leachate, either before or after any impurity removal steps so as to adjust the ratio of Ni:Co:Mn as required.

In one embodiment, the final target may be a solution with the required Ni:Co:Mn ratio, with sufficient purity, such that a battery cathode precursor material can be produced from that solution.

It should be noted that the term NMC refers to any material containing Ni, Co and Mn which can be used as active material in batteries.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

Notwithstanding any other forms which may fall within the scope of the present invention, preferred embodiments of the invention will now be described, by way of example only, with reference to the accompanying drawings in which:

FIG. 1 shows a flow diagram of a method of producing a co-precipitate comprising nickel, manganese and cobalt obtained from a solid residue according to a method which includes an embodiment of the present invention;

FIG. 2 shows a schematic diagram for a second method of producing a co-precipitate comprising nickel, manganese and cobalt according to a method which includes a second embodiment of the present invention;

FIG. 3 shows the removal of undesired metals from a cobalt concentrate using an acid pre-wash step, based on volume of filtrate; and

FIGS. 4a and 4b show a plot of the recovery to solution of various metals compared to pH in the course of leaching a pre-washed cobalt concentrate under reducing conditions;

FIGS. 5a, 5b and 5c show a plot of the change in the solution phase concentration of various metals in the course of terminating the reduction reaction;

FIGS. 6a-6d show a plot of recovery to solution of major elements over the reaction time and pH, where solids were treated at a reactor temperature of 55° C. with 5% initial solids and 100% stoichiometric addition of SO₂ in 2.5 hours. The solids used were: FIG. 6a—BMJ-A; FIG. 6b—BMJ-B; FIG. 6c—BMC; FIG. 6d—BMK;

FIGS. 7a-7d show a plot of recovery to solution of major elements over reaction time and pH, where BMK solids were treated at a reactor temperature of 55° C. with 5% initial solids and 100% stoichiometric addition of SO₂, with acid added under a variety of conditions. Acid was added by: FIG. 7a—H₂SO₄ added stepwise at sampling points to reduce pH to 4.5, and SO₂ added (31 mL/min) over 2.5 hours; FIG. 7b—H₂SO₄ added continuously to give 100% of the stoichiometric requirement (1 mL/min) in 200 minutes, and SO₂ added (31 mL/min) over 2.5 hours; FIG. 7c—H₂SO₄ added continuously to give 100% of the stoichiometric requirement (2.2 mL/min) in 1.5 hours, and SO₂ added (52 mL/min) over 1.5 hours; FIG. 7d —100% of the stoichiometric requirement of H₂SO₄ delivered at the start of the reaction, and SO₂ added (220 mL/min) in 0.5 hours. FIG. 7e shows a comparative plot of recovery to solution of major elements over reaction time and pH, where BMK solids were treated at a reactor temperature of 55° C. with 5% initial solids and no SO₂, with H₂SO₄ added continuously to give 100% of the stoichiometric requirement (1 mL/min) in 200 minutes;

FIG. 8 shows a plot of recovery to solution of major elements over reaction time and pH, where BMK solids were treated at a reactor temperature of 55° C. with 20% initial solids and 100% stoichiometric addition (290 mL/min) of SO₂ in 1.5 hours with 50% H₂SO₄ added continuously to give 100% of the stoichiometric requirement (2.9 mL/min) in 1.5 hours;

FIGS. 9a and 9b show a plot of recovery to solution of major elements over reaction time and pH, where BMK solids were treated at a reactor temperature with 5% initial solids and 100% stoichiometric addition (52 mL/min) of SO₂ in 1.5 hours and H₂SO₄ added continuously to give 100% of the stoichiometric requirement (2.2 mL/min) in 1.5 hours. The reactor temperature was: FIG. 9a —75° C.; FIG. 9b —35° C.;

FIG. 10 shows a flow diagram of a method of one embodiment of the present invention;

FIG. 11 shows a flow diagram of a method of another embodiment of the present invention;

FIG. 12 shows a graph of pH vs target metal precipitation at 75° C., 50 ml/min air with pH adjusted by automatic titration of 2.5M NaOH;

FIG. 13 shows a graph of pH vs impurity element precipitation at 75° C., 50 ml/min air with pH adjusted by automatic titration of 2.5M NaOH;

FIG. 14 shows a graph of pH vs target metal precipitation at 75° C., 50 ml/min air with pH adjusted by automatic titration of 200 g/l Na₂CO₃;

FIG. 15 shows a graph of pH vs impurity element precipitation at 75° C., 50 ml/min air with pH adjusted by automatic titration of 200 g/l Na₂CO₃;

FIG. 16 shows a graph of pH vs target metal precipitation at 75° C., 50 ml/min air with pH initially adjusted by adding solid MnCO₃ and BNC followed by automatic titration of 200 g/l Na₂CO₃;

FIG. 17 shows a graph of pH vs impurity element precipitation at 75° C., 50 ml/min air with pH initially adjusted by adding solid MnCO₃ and BNC followed by automatic titration of 200 g/l Na₂CO₃;

FIG. 18 shows a graph of pH vs target metal precipitation at 75° C., 50 ml/min air with pH adjusted by automatic titration of 200 g/l Na₂CO₃. Solid liquid separation at 150 minutes with base addition resulted at 180 minutes;

FIG. 19 shows a graph of pH vs impurity element precipitation at 75° C., 50 ml/min air with pH adjusted by automatic titration of 200 g/l Na₂CO₃. Solid liquid separation at 150 minutes with base addition resulted at 180 minutes;

FIG. 20 shows the effect of co-precipitation final pH and initial NMC ratios on the final NMC compositions;

FIG. 21 shows the precipitation extent of Ca²⁺ and Mg²⁺ at different NMC final precipitation pHs. The initial 50 mg/L Ca+200 mg/L Mg in solution. The initial 0.12 mol/L Ni, 0.02 mol/L Co, and x mol/L Mn (x=0.02, 0.04 and 0.06) in solution to change the NMC ratio from 6:2:2 to 6:3:2 and 6:4:2;

FIG. 22 shows precipitation percentages of Ni²⁺, Co²⁺ and Mn²⁺ at different NMC final precipitation pHs. The initial 0.12 mol/L Ni, 0.02 mol/L Co, and x mol/L Mn (x=0.02, 0.04 and 0.06) in solution to change the NMC ratio from 6:2:2 (solid red dot) to 6:3:2 (red circle) and 6:4:2 (red rectangle);

FIG. 23 illustrates leaching recoveries from a laterite ore sample according to one embodiment of the invention;

FIG. 24 illustrates recoveries to solid from NMC precipitation of adjusted laterite ore leach solution according to an embodiment of the invention;

FIG. 25 illustrates leach recoveries to solution from sulphuric acid leaching of MSP according to an embodiment of the invention;

FIG. 26 illustrates recoveries to solid from NMC precipitation of adjusted sulphide concentrate leach solution according to an embodiment of the invention; and

FIG. 27 illustrates leach recoveries to solution from sulphuric acid leaching of blended cobalt concentrate/black mass according to an embodiment of the invention.

### DESCRIPTION OF EMBODIMENTS

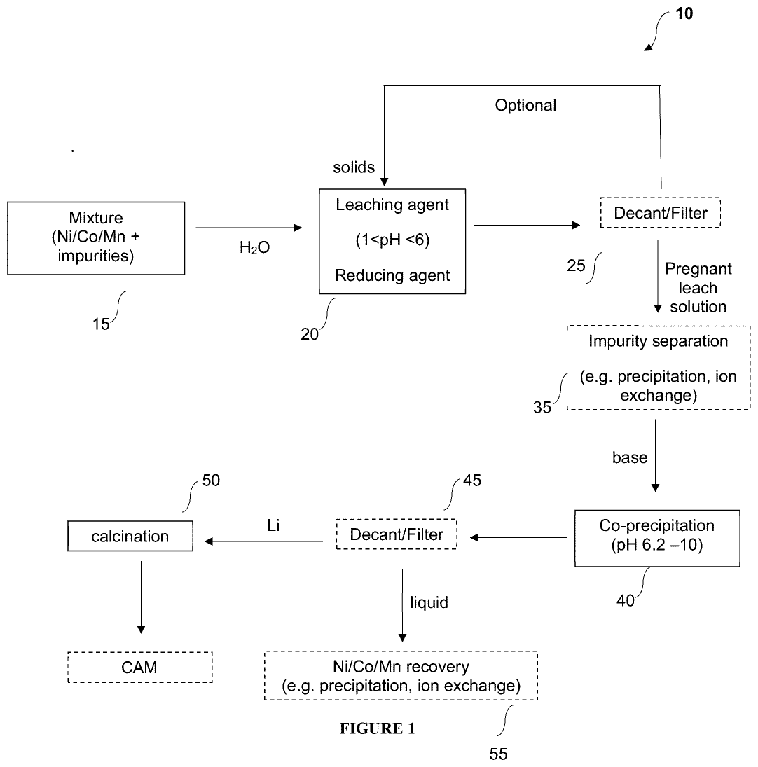

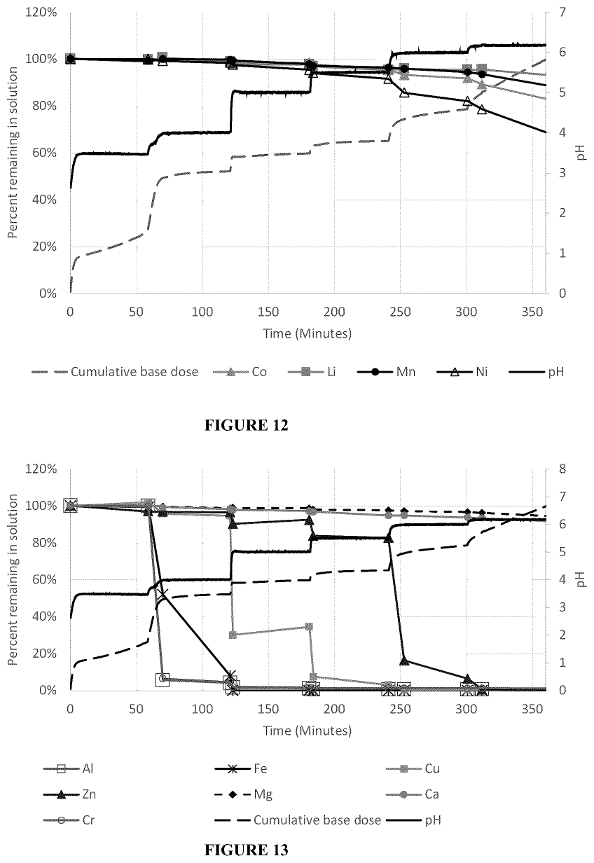

Exemplary methods of the invention will now be discussed with reference to FIGS. 1 to 27.

A first exemplary method 10 of producing a co-precipitate comprising nickel, manganese and cobalt of the invention is illustrated in FIG. 1. The precipitation methods relate primarily to steps 25 onwards.

The method comprises the step of treating a mixture 15 comprising nickel, cobalt and manganese, with a reducing agent in an aqueous solution at a pH of from about 1 to 6 (at 20). In the mixture 15, a portion of the nickel, cobalt and/or manganese is in an oxidised state, and the treatment with the reducing agent reduces at least part of the oxidised nickel, cobalt and/or manganese, to thereby provide an aqueous solution comprising dissolved nickel, cobalt and manganese.

The mixture is especially a moist filter cake, especially obtained from the Selective Acid Leach (SAL) process disclosed in PCT/AU2012/000058 (although cathode material which includes nickel, cobalt and manganese from a lithium ion battery may also be used). Broadly, the moist filter cake was obtained by contacting a mixed hydroxide precipitate comprising nickel, cobalt and manganese with an acidic solution comprising an oxidant at a pH to cause the cobalt to be stabilised in the solid phase while nickel dissolves in the acidic solution; and subsequently separating the solid phase from the acidic solution, wherein the solid phase comprises at least nickel, cobalt and manganese. In this exemplary embodiment, the solid phase is a moist filter cake.

In the treatment step with the leaching agent and the reducing agent, the moist filter cake may include cobalt, nickel and/or manganese in oxidised forms, namely Co(III), Co(IV), Mn (III), Mn(IV), Mn(VII), Ni(III), or Ni(IV). However, this material may also contain substantial amounts of unoxidized or reduced cobalt, manganese or nickel, for example in the form of Co(II), Mn(II) or Ni(II). The reduced cobalt, manganese and nickel are far more soluble in aqueous solutions with a pH of from 1 to 6 than the oxidised forms.

When the treatment step is performed, the pH may decrease over time. A preferred pH for performing the treatment step was a terminal pH of about 3-4 (although a terminal pH of about 2-3 may be suitable under more aggressive conditions), and through the treatment step the pH was controlled at this pH through addition of further leaching agent or base. A preferred leaching agent was sulphuric acid, however hydrochloric acid, nitric acid or organic acids may be suitable. The reducing agent in the treatment step was preferably sulphur dioxide gas, as this is strong enough to reduce the cobalt, manganese and nickel and does not introduce any additional impurities into the aqueous solution. The addition of the reducing agent in the treatment step was controlled, in order to control the reduction of cobalt, nickel and/or manganese. The treatment step was performed in a sealed vessel to control the loss of gas. The reducing agent was added in a controlled manner, using about 1 stoichiometric equivalent of reducing agent to combined moles of oxidised cobalt, oxidised manganese and oxidised nickel in the mixture. The treatment step was performed at a temperature of about 80° C. to about 95° C. for about 2 hours with stirring, or at a temperature of about 55° C. for about 1-5 hours with stirring.

After the treatment step 20, the aqueous solution, which represents the aqueous feed solution of the present invention, comprised dissolved nickel, cobalt and manganese, and also impurities such as arsenic, aluminium, barium, cadmium, carbon, chromium, copper, lead, silicon, ammonium, sulphite, fluorine, fluoride, chloride, titanium, zinc, scandium and zirconium; especially aluminium, copper and iron (for example, if starting with a material derived from black mass) or zinc, calcium and magnesium (and also iron and aluminium) (for example if starting with a material derived from MHP). The aqueous solution also comprised entrained solids which comprised impurities such as aluminium, barium, cadmium, carbon, chromium, copper, lead, silicon, fluorine, titanium, zinc and zirconium.

After completion of the treatment step 20, one or more impurities from the aqueous solution comprising dissolved nickel, cobalt and manganese were removed. Solids were removed from the liquid by passing the liquid with entrained solids from treatment step 20 flowed to a settling vessel for decanting/filtering 25. Solids removed from the settling vessel were returned to treatment step 20. Liquids removed from the settling vessel were treated further to remove impurities at 35. Exemplary impurities removed from the liquid may include iron, copper, zinc and aluminium, and this may be achieved using precipitation and/or ion exchange separation techniques. Ion exchange may assist in removing at least some zinc, for example.

After removal and/or separation of impurities, the nickel, cobalt and manganese were co-precipitated from the aqueous solution at 40. However, before co-precipitation, additional cobalt, nickel and/or manganese may be added to adjust the ratios of nickel, cobalt and manganese to a desired ratio, or to provide a desired ratio in the co-precipitate. An exemplary ratio is 1:1:1 nickel:cobalt:manganese. The cobalt, manganese and nickel added may be in the form of CoSO₄, NiSO₄ and/or MnSO₄ or other cobalt, manganese and nickel containing compounds.

The co-precipitation step at 40 may be performed by adjusting the pH of the solution comprising dissolved nickel, cobalt and manganese, and preferably by adjusting the pH of the solution to from about 7.5 to about 8.6. It has been found that this pH range results in less co-precipitation or inclusion of unwanted impurities such as, for example, the salts of magnesium and/or calcium, than if a higher pH range was used. This step was performed at 80° C. and atmospheric pressure. The nickel, cobalt and manganese were co-precipitated in the form of hydroxides. A two stage resuspension wash with 0.5% NH₃ solution may be used.

The precipitate was then separated from the liquid, for example through decanting or filtering at 45. Advantageously, further impurities were removed through the co-precipitation step, as some impurities remained in the solution such as sodium, potassium, magnesium, calcium, and sulphate. The liquid was further treated for nickel, manganese or cobalt recovery (for example precipitation or ion exchange) at 55, and the solid was washed to remove further impurities and then mixed with lithium and calcined at 50. The calcined product may be used to provide NMC material for use as the cathode active material (CAM) in new batteries.

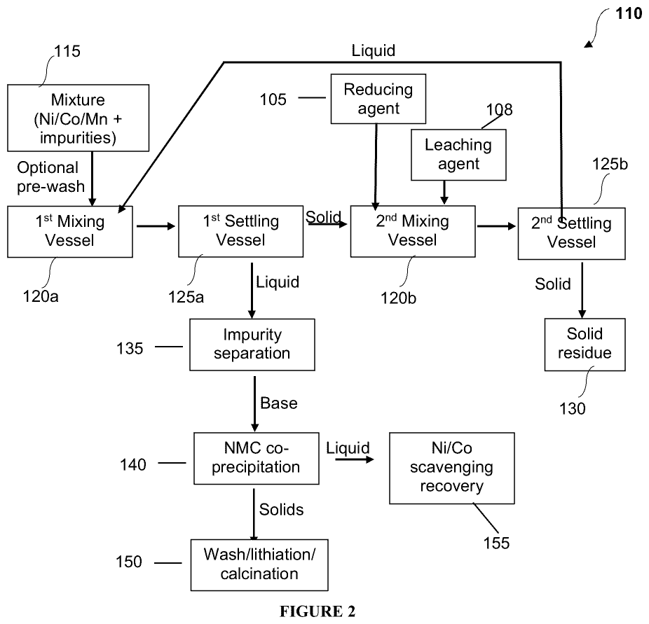

A similar method 110 is illustrated in FIG. 2. Similar numbers refer to similar features. However, the method illustrated in FIG. 2 includes an optional pre-wash. This may be a wash with a weak acid leach solution, at a starting pH of around 3.5 (the pH will increase as the wash progresses), resulting in a solution with about 10% solid. Such a pre-wash may be able to remove at least some zinc, magnesium and calcium.

In contrast to what is illustrated in FIG. 1, the method illustrated in FIG. 2 also employs a counter-current setup, as discussed further below. In FIG. 2 two mixing vessels 120a, 120b, and two settling vessels 125a, 125b are used. As illustrated in FIG. 2, the mixture comprising nickel, cobalt and manganese is added to an aqueous solution in a first mixing vessel 120a, which is stirred. The solution (including entrained solids) exits the first mixing vessel 120a through a first mixing vessel liquid outlet, and enters the first settling vessel 125a through a first settling vessel liquid inlet. The first settling vessel 125a includes at least an upper outlet in an upper portion of the vessel to provide an outlet for liquid, and a lower outlet in a lower portion of the vessel to provide an outlet for settled solids. Liquid exiting the first settling vessel through the upper outlet progressed to a step in which liquid impurities in the solution were separated at 135. Liquid/solids exiting the first settling vessel 125a through the lower outlet flow into a second mixing vessel 120b through a second mixing vessel inlet. A reducing agent 105 and a leaching agent 108 were added to the second mixing vessel 120b, which is stirred. The solution (including entrained solids) exited the second mixing vessel 120b through the second mixing vessel liquid outlet, and enters a second settling vessel 125b through a second settling vessel liquid inlet. The second settling vessel 125b includes at least an upper outlet in an upper portion of the vessel to provide an outlet for liquid, and a lower outlet in a lower portion of the vessel to provide an outlet for settled solids. Liquid exiting the second settling vessel through the upper outlet flowed to the inlet of the first mixing vessel 120a. Liquid/solids exiting the second settling vessel through the lower outlet is discarded at 130, for example after passing through a screw press. An advantage of this arrangement is that this minimised the amount of acid and reducing agent which remains in the solution from which the nickel, cobalt and manganese is co-precipitated. Furthermore, the amount of iron in the first mixing vessel was minimised by maintaining the correct conditions.

Like in FIG. 1, the mixture at 115 is especially a moist filter cake, especially obtained from the Selective Acid Leach (SAL) process disclosed in PCT/AU2012/000058 (although cathode material which includes nickel, cobalt and manganese from a lithium ion battery may also be used). The SAL process is discussed further above, as is the oxidation states of cobalt, manganese and nickel.

Once again, a preferred pH for performing the treatment step was at a pH of about 3, and through the treatment step in the mixing vessels 120a, 120b and the settling vessels 125a, 125b, the pH was controlled at this pH through addition of further leaching agent or base. A preferred leaching agent was sulphuric acid, however hydrochloric acid or nitric acid may be suitable. The reducing agent in the treatment step was preferably sulphur dioxide gas, as this is strong enough to reduce the cobalt, manganese and nickel and does not introduce any additional impurities into the aqueous solution. The addition of the reducing agent in the treatment step was controlled, in order to control the reduction of cobalt, nickel and/or manganese and optimise the utilisation of the reducing agent. The treatment step was performed in sealed vessels to control the loss of gas (this would need to be vented and off-gas scrubbed). The reducing agent was added in a controlled manner, using about 1 stoichiometric equivalent of reducing agent to combined moles of oxidised cobalt, oxidised manganese and oxidised nickel in the mixture. The treatment step was performed at a temperature of about 55° C. for about 1-5 hours with stirring.

After the treatment step 120a, 120b, the aqueous solution comprised dissolved nickel, cobalt and manganese, and also impurities such as aluminium, barium, cadmium, carbon, chromium, copper, lead, silicon, fluorine, titanium, zinc and zirconium. The aqueous solution also comprised entrained solids which comprised impurities such as aluminium, barium, cadmium, carbon, chromium, copper, lead, silicon, fluorine, titanium, zinc and zirconium.

Liquids removed from the first settling vessel 125a were treated further to remove impurities at 135. Exemplary impurities removed from the liquid may include iron, copper, zinc and aluminium, and this may be achieved using precipitation and/or ion exchange separation techniques.

After removal and/or separation of impurities, the nickel, cobalt and manganese were co-precipitated from the aqueous solution at 140. However, before co-precipitation, additional cobalt, nickel and/or manganese may be added to adjust the ratios of nickel, cobalt and manganese to a desired ratio, as discussed above for FIG. 1. The co-precipitation step at 140 was as described above for FIG. 1.

The precipitate was then separated from the liquid, for example through decanting or filtering. The liquid was further treated for nickel, manganese or cobalt recovery (for example precipitation or ion exchange) at 155, and the solid was washed to remove further impurities and then mixed with lithium and calcined at 150. The calcined product may be used to provide NMC material for use as the cathode active material (CAM) in new batteries.

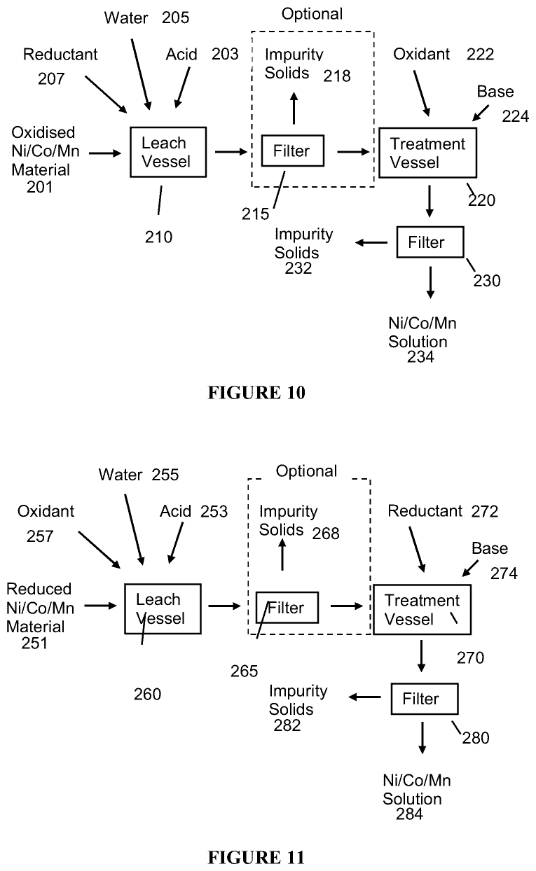

In a further embodiment, a method outlined in FIG. 10 or 11 may be used in the methods outlined in FIGS. 1 and 2 before the impurity separation/co-precipitation steps. In these methods, an oxidised nickel, cobalt, manganese material 201 (FIG. 10) or a reduced nickel, cobalt, manganese material 251 (FIG. 11) is treated with an acid 203/253 to bring the pH between about 1 and about 6 or about 1 and about 7, optionally water 205/255, and an oxidant (207) or reductant (257) (depending upon the starting material). After leaching the resultant solution in a leach vessel 210/260, the leachate may be filtered 215/265 and impurity solids 218/268 removed. Following this, the leachate passes to the treatment vessel 220/270 (note: the leaching vessel 210/260 may be the same as the treatment vessel 220/270), and oxidant 222 (when starting with an oxidised NMC material 201) or reductant 272 (when starting with a reduced NMC material 251) is added to neutralise excess reductant 207 or oxidant 257 remaining in the leachate. Base 224/274 may also be added to increase the pH (for example, the solution in the leach vessel may be at a pH of about 3, and the solution in the treatment vessel may be at a pH of about 6). Consequently, some material may precipitate in the treatment vessel 220/270, which can then be filtered 230/280 to provide impurity solids 232/282 and an NMC solution 234/284.

Exemplary results of the method are provided below.

### Leaching

### Example 1: Starting Material Derived from MHP

### Acid Pre-Washing

In this experiment, a cobalt concentrate derived from a pilot plant (Brisbane Metallurgy Laboratories) was used. The cobalt concentrate had the following elemental composition based on total dissolution and solution assay in %: 61.5 Ni, 18.3 Mn, 15.0 Co, 1.6 Na, 0.9 Zn, 0.9 Mg, 0.7 Fe, 0.4 Cu, 0.4 Al, 0.2 Ca. This cobalt concentrate was prepared from the SAL process, which utilised a mixed hydroxide precipitate (MHP—a solid mixed nickel-cobalt hydroxide precipitate). The MHP was contacted with an acidic solution comprising an oxidant at a pH to cause the cobalt to be stabilised in the solid phase and nickel dissolved in the acidic solution; and then the solid phase was separated from the acidic solution, in which the solid phase comprises nickel, cobalt and manganese.

The cobalt concentrate was washed with weak acid to reduce impurity content associated with entrained solution and residual nickel hydroxide. Due to the high solution retention of the solids in filtering, a combination of reslurry washing and displacement washing using a pressure filter was employed in this example.

In this process, cobalt concentrate (180 g dry solid) was first mixed with 5 g/L H₂SO₄ at room temperature to produce a slurry with 20 wt % solids. The slurry was next washed into a pressure filter; and (i) filtering was stopped after about 200 mL of solution was recovered, after which; (ii) the filter was depressurised and 200 mL of 1 g/L H₂SO₄ was added to the filter and filtering resumed. Steps (i) and (ii) were repeated until a total of 1 L of 1 g/L H₂SO₄ had been added to the filter. The remaining solution was filtered out and collected in batches of about 200 mL. After the last of the solution was recovered, air was blown through the filter for 30 minutes.

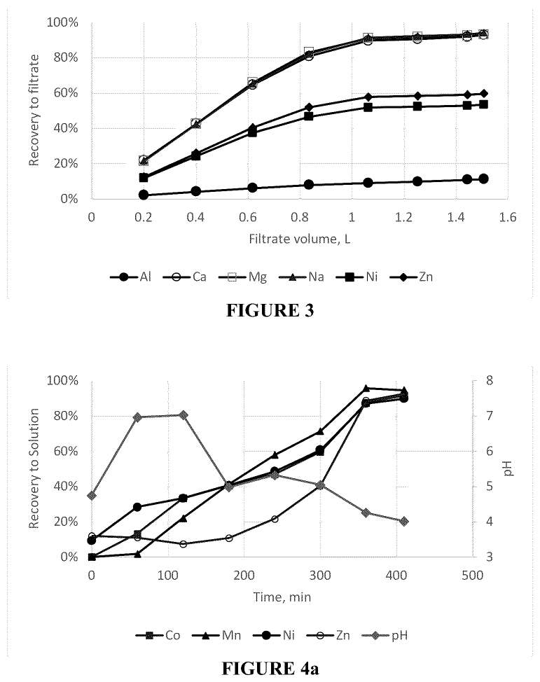

As shown in Tables 1 and 2 and FIG. 3, this process was effective at reducing the Ca (93%) and Mg (93%) content of the solids going to leaching, with moderate effectiveness for Ni and Zn (60%). Co and Mn losses to solution were negligible (<10 mg loss out of 180 g dry solids feed). No Fe and minimal Cu were washed out. The last 500 mL of the 1 L acid wash solution contained very little dissolved metals.

TABLE 1
Results of Acid Pre-Washing Step - Cobalt concentrate starting
material and acid pre-washed cobalt filter cake

| | | Cobalt conc. | Washed filter cake |
|---|---|---|---|
| Solids % | | 43% | 23% |
| Al | PPM | 1,892 | 3,134 |
| Ca | | 697 | 93 |
| Co | | 65,426 | 124,037 |
| Cu | | 1,777 | 3,140 |
| Fe | | 3,060 | 5,846 |
| Mg | | 4,071 | 529 |
| Mn | | 79,965 | 150,101 |
| Na | | 7,124 | 801 |
| Ni | | 268,351 | 233,164 |

TABLE 2
Percentage of minerals washed out in acid pre-washed cobalt
filter cake (versus minerals in cobalt concentrate)

| | Al | Ca | Co | Cu | Fe | Mg | Mn | Na | Ni | Zn |
|---|---|---|---|---|---|---|---|---|---|---|
| Washed | 11% | 93% | 0% | 5% | 0% | 93% | 0% | 94% | 53% | 60% |
| out | | | | | | | | | | |

Treatment with Reducing Agent and Acid

The washed cobalt concentrate was slurried at 5 wt %, heated, and SO₂ bubbled into the reactor to reduce the solids with a pH of 4 set as the experiment end point. This end point was selected as it showed good recovery in previous tests with some selectivity over impurity elements. Due to a miscalculation, the initial SO₂ flowrate was too low and had to be increased in order to complete the experiment.

In this process, the washed cobalt concentrate was first slurried at 5% solids in deionised water and heated to 55° C. Next, 12 mL/min SO₂ was bubbled into the slurry for 5 hours. The SO₂ flowrate was then increased to 36 mL/min for a further 110 min until the solution pH reached 4. Lastly, the slurry was filtered to recover the solution (filtrate).

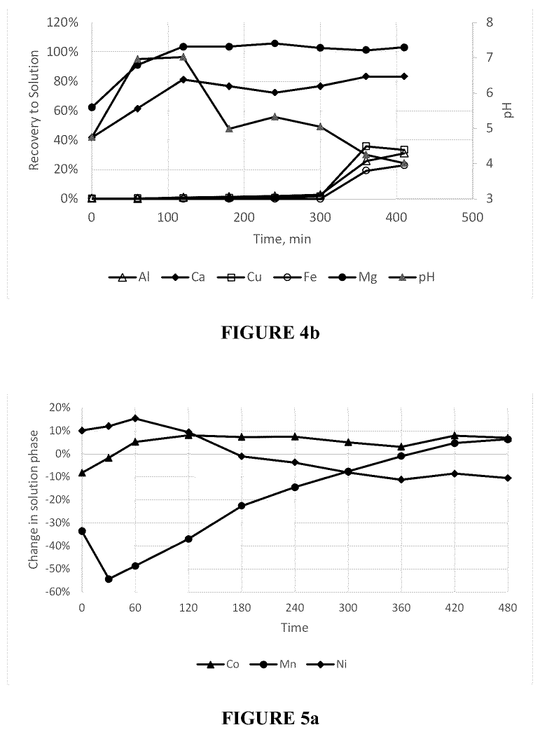

As shown in Table 3 and FIGS. 4a and 4b, the treatment with a reducing agent and acid recovered >90% of the target metals (Ni, Mn and Co). The slow addition of SO₂ allowed for the leaching of target metals while selecting against Al, Cu, and Fe until near the end point. Ca and Mg leached faster than the target elements, however final solution concentrations were low (<30 mg/L) due to the effective acid washing of feed solids.

TABLE 3
Analysis of treatment with reducing agent under acidic conditions

| | Al | Ca | Co | Cu | Fe | Mg | Mn | Na | Ni | S | Zn |
|---|---|---|---|---|---|---|---|---|---|---|---|
| Head | 0.31% | 0.01% | 12.40% | 0.31% | 0.58% | 0.05% | 15.01% | 0.08% | 23.32% | 3.31% | 0.30% |
| assay | | | | | | | | | | | |
| Solution | 48 | 4 | 5,561 | 51 | 65 | 27 | 6,958 | 31 | 10,254 | 16,204 | 137 |
| Assay | | | | | | | | | | | |
| (mg/L) | | | | | | | | | | | |
| Recovery | 31% | 83% | 92% | 33% | 23% | 103% | 95% | 78% | 90% | NA | 92% |

Without wishing to be bound by theory, the inventors believe that initially the acid generating reaction of SO₂ with water is overwhelmed by the reduction of Co³⁺ and Mn” hydroxides leading to an increase in pH. Once most of the reduction is mostly complete the pH falls until it is buffered by the dissolution of divalent hydroxides near pH 5, then falls further as recovery to solution approaches maximum.

### Termination of Reduction

The filtrate from the previous paragraph was contacted with the acid washed cobalt concentrate (as an oxidant) at 80° C. to consume any SO₂ remaining dissolved in solution and precipitate iron. MnCO₃ was added to increase pH and assist with impurity precipitation while offsetting expected Mn losses in ion exchange (IX), however the pH remained stable (at a pH of about 4.8) due to a buffering effect attributed to the impurity precipitation reactions.

In this process, first the filtrate was slurried with the washed cobalt concentrate at 5% solids (50 g) and heated to 80° C. After 1 hour, 13.8 g MnCO₃ was added to the slurry, and after 8 hours the slurry was filtered. The pH during this step in the process ranged from 5.1-4.6.

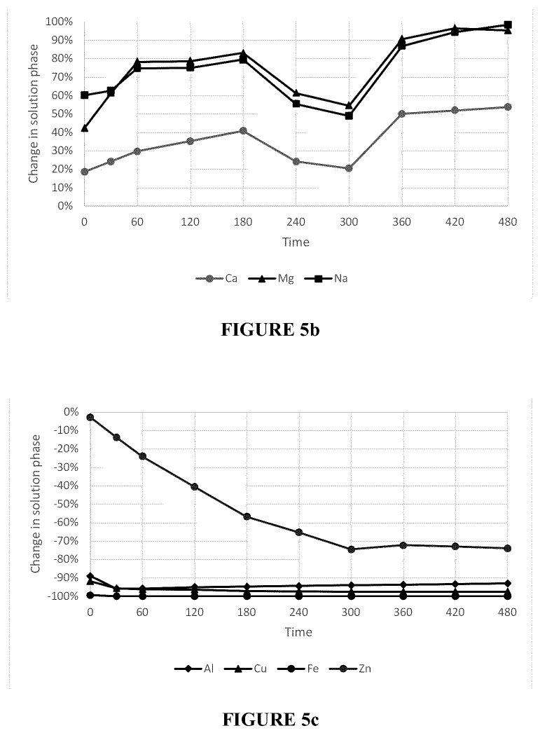

As illustrated in Table 4 and FIGS. 5a, 5b and 5c, contacting the leach solution with unleached solids at 80° C. with added MnCO₃ resulted in the rapid removal of Al, Cu and Fe (within minutes of contact with solids). The Ni and Co concentrations remained relatively stable with Mn initially precipitating out, then increasing gradually after MnCO₃ addition.

TABLE 4
Concentration of various metals at the beginning
and end of the termination of reduction step

| | Al | Ca | Co | Cu | Fe | Mg | Mn | Na | Ni | Zn |
|---|---|---|---|---|---|---|---|---|---|---|
| Feed | 70.5 | 5.4 | 5,946 | 73.3 | 115 | 27.7 | 7,519 | 32.1 | 11,010 | 149.7 |
| (mg/L) | | | | | | | | | | |
| Final | 4.9 | 8.3 | 6,357 | 1.8 | 0 | 54.1 | 7,992 | 63.7 | 9,853 | 38.9 |
| (mg/L) | | | | | | | | | | |

In previous oxidations tests where MnCO₃ was not added Co, Ni and Zn concentrations in solution all increased with the final Mn concentration being much lower (similar to the precipitation seen in this experiment, without the dissolution that followed). The pH remained relatively stable in spite of MnCO₃ addition (5.04 immediately after solids addition, 4.67-4.87 for remainder of test).

### Ion Exchange (IX)

The filtrate from the previous paragraph was contacted with a Lewatit@ VP OC 1026 macroporous ion exchange resin (based on a styrene divinylbenzol copolymer containing di-2-ethylhexyl phosphate (D2EHPA); the resin is available from Lanxess, Cologne). The contact with the ion exchange resin was performed at 40° C. in two stages. pH control was done using 0.1M H₂SO₄ and 1M NaOH before IX contact, with a target pH of 3.8-3.9. The resin was acid washed with 10% H₂SO₄ and then conditioned to pH 3.5 before use. The additions in the following paragraph below are given in volume of resin as received, accounting for mass changes during washing.
1. 250 mL of filtrate was added to a bottle and pH controlled down to 3.9.
2. 120 mL resin was added, the bottle sealed, and placed in a bottle roller for 24 hours at 40° C.
3. The resin was filtered out and the solution added to a clean bottle.
4. pH was adjusted up to 3.8.
5. 120 mL resin was added, the bottle sealed, and placed in a bottle roller for 4 hours at 40° C.
6. The resin was filtered out and the solution recovered.

Based on previous ion exchange (IX) tests, two contacts in series at 40° C. with minimal pH control were chosen to maximise Zn removal and minimise Mn loss. Tables 5 and 6 show the results of the solution assays before and after each contact. The dilution corrected assays take into account the solution held up in the resin from washing and conditioning. Both contacts showed excellent Zn removal (87% and 91%) compared to previous trials while Mn losses were not completely mitigated (15% and 16%). Some Al and Ca were also removed (cumulative 29% and 32% respectively) with Fe going into IX being <1 mg/L.

TABLE 5
Concentration of various metals during ion exchange treatment

| | pH | Al | Ca | Co | Cu | Mg | Mn | Na | Ni | Zn |
|---|---|---|---|---|---|---|---|---|---|---|
| | mg/L | | | | | | | | | |
| Before | 3.89 | 6 | 11 | 7,088 | 2 | 67 | 8,937 | 71 | 11,450 | 43 |
| 1st IX | | | | | | | | | | |
| After | 1.67 | 5 | 9 | 7,163 | 2 | 68 | 7,640 | 72 | 11,198 | 6 |
| 1st IX | | | | | | | | | | |
| (dilution | | | | | | | | | | |
| corrected) | | | | | | | | | | |
| Before | 3.80 | 5 | 8 | 6,400 | 2 | 60 | 6,803 | 1,161 | 9,972 | 5 |
| 2nd IX | | | | | | | | | | |
| After | 1.86 | 4 | 7 | 6,365 | 2 | 61 | 5,712 | 1,176 | 9,891 | 0.4 |
| 2nd IX | | | | | | | | | | |
| (dilution | | | | | | | | | | |
| corrected) | | | | | | | | | | |
| After | 1.86 | 4 | 6 | 5,850 | 2 | 56 | 5,250 | 1,081 | 9,090 | 0.4 |
| 2nd IX | | | | | | | | | | |
| (actual) | | | | | | | | | | |

TABLE 6
Ion exchange results, percentage of various metals on resin

| % on resin | Al | Ca | Co | Cu | Mg | Mn | Na | Ni | S | Zn |
|---|---|---|---|---|---|---|---|---|---|---|
| 1st IX | 18% | 17% | 0% | 2% | 0% | 15% | 0% | 2% | 0% | 87% |
| 2nd IX | 12% | 18% | 1% | 0% | 0% | 16% | 0% | 1% | 1% | 91% |
| Cumulative | 29% | 32% | 1% | 0% | 0% | 28% | 0% | 3% | 1% | 99% |

### Example 2: Starting Material Derived from Lithium-Ion Batteries (Black Mass)

### Materials and Equipment

Reagents used in this work were food grade SO₂ and reagent grade 98% H₂SO₄. The compositions of the black mass samples used are provided in Table 7. These samples were obtained from lithium-ion batteries which had been shredded and undergone chemical cleaning.

TABLE 7
Elemental concentration of major elements in black mass samples

| | | | Major Elements Concentration in moist mass | | | | |
|---|---|---|---|---|---|---|---|
| | Moisture | Sample | Ni | Co | Mn | Li | C |
| Sample | Wt % | origin | Wt % | | | | |
| BMK | 0 | Korea | 35.39% | 11.31% | 10.68% | 6.47% | 4.3% |
| (dry) | | | | | | | |
| BMJ-A | 0 | Japan | 34.57% | 14.47% | 9.72% | 6.21% | 3% |
| (dry) | | | | | | | |
| BMJ-B | 1 | Japan | 46.95% | 9.47% | 9.30% | 0.00% | 0% |
| BMC | 19 | Canada | 20.43% | 10.65% | 2.41% | 3.49% | 28% |

All reactions were completed in a 1.1 L baffled glass reactor. Temperature was maintained by a hot plate with thermocouple feedback control. Agitation was achieved by an overhead stirrer set to 800 RPM with a high-shear Teflon impellor. Gas was sparged using a glass sparging rod connected to a gas flowmeter to control the gas addition rate. Care was taken to ensure the sparger was submerged to a consistent level that was in line with the blades of the impellor to ensure maximum gas dispersion during the reaction.

### Methodology

The required amount of black mass was first weighed directly into the reactor. The required amount of water was then added and the reactor was heated to reaction temperature. Once at reaction temperature an initial sample was taken via pipetting and cooled to room temperature in a sealed syringe. Once cool the sample was syringe filtered and diluted in nitric acid with excess sample being returned to the reactor. As applicable, the SO₂ sparge and the hose from the acid pump were then inserted into the reactor and timing was commenced. Samples were taken at time intervals predetermined by the experiment following the sample methodology as outline for the initial sample.

Once the reaction time had elapsed, the reactor was weighed for mass balancing purposes and the slurry was vacuum filtered. The wet solids were then dried overnight at 105° C. and the solution was stored in a glass bottle.

SO₂ and H₂SO₄ addition rates were calculated based on the flowrates required to administer 100% of the stoichiometric dosage to react all Li, Ni, Mn and Co to their divalent state in the required time. This was assuming all Ni and Co were present as trivalent and Mn was present as tetravalent.

### Results—Effect of Sample Type

Four different black mass samples were processed using only SO₂ gas as the reducing agent with no additional acid added at 55° C. This condition was chosen as the initial baseline as it would provide a point of comparison to the previously completed reductive leach tests performed on the cobalt concentrate material. All tests were conducted with 5% solids concentration. 5% solids was chosen to both conserve sample mass and to target approximately 0.2M total metals concentration in the final solution. 0.2M metal concentration was selected as a target for the subsequent NMC precipitation operation. Full experimental details of the tests conducted are provided in Table 8.

TABLE 8
Summary of experimental conditions

| Sample ID | SO₂ flowrate (ml/min) |
|---|---|
| BMJ-A | 43 |
| BMJ-B | 26 |
| BMC | 18 |
| BMK | 31 |

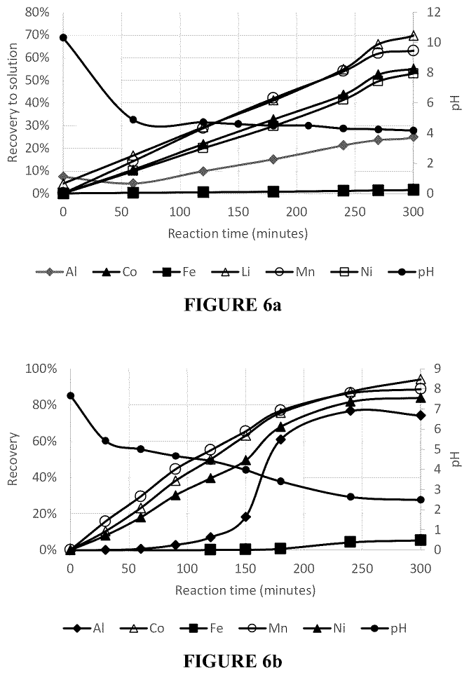

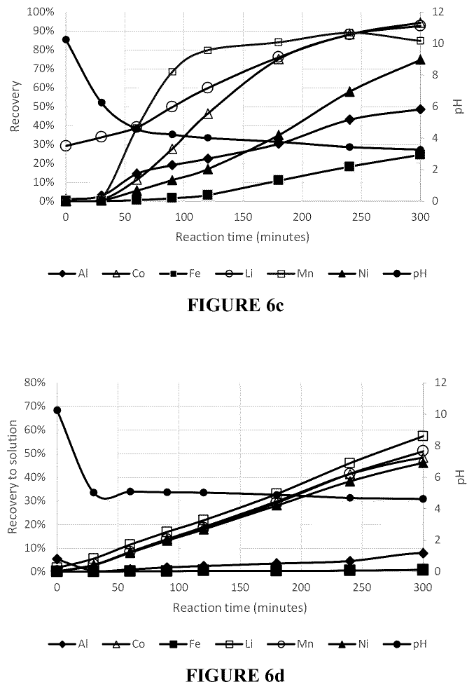

The leaching extents and pH profiles as a function of time for the tests summarised in Table 7 are presented in FIGS. 6a-6d. Comparing these results, it is clear that BMJ-B outperformed the other tested samples. BMJ-B was highly amorphous in nature, which would result in a much higher reactivity compared to the more crystalline sample. The inventors believe that this is likely caused by the removal of the lithium from the sample. This material came delithiated which would have destroyed the crystal structure causing the sample to become amorphous. This resulted in must faster kinetics, achieving greater than 90% cobalt recovery in five hours. The Canadian sample (BMC) contained the most impurities and was the least pre-processed of all samples. BMC performed similarly in terms of cobalt recovery but was only able to achieve 75% recovery of nickel. The inventors believe that the improved performance of this sample is expected to have been caused by the higher concentration of metal impurity (Al, Cu and Fe metal) which can act as reducing agents, improving recovery. BMJ-A and the Korean sample (BMK) were both pure and highly crystalline samples and both achieved only 50% recovery for Ni, Co and Mn in 5 hours. Given this, BMK was chosen as the representative sample for all further tests as it had sufficient sample mass and was equal for most difficult to leach. The most difficult was selected as if this material can be leached then all black mass samples should be possible to leach under similar conditions.

### Results Effect of Reagent Dosage Rate

Five experiments were conducted to investigate the influence of reagent addition rate. All samples used BMK solids at 55° C. and 5% solids concentration. SO₂ and acid (20% H₂SO₄) were then added to the reactor as per Table 9. For continuous acid tests, acid was added via a peristaltic pump.

TABLE 9
Summary of experimental conditions

| Experiment | SO₂ flowrate (ml/min) | H₂SO₄ flowrate |
|---|---|---|
| Stepwise acid | 31 | Added at sample points |
| | | till pH < 4.5 |
| Slow continuous | 31 | 1 ml/min (20% acid) |
| Fast continuous | 52 | 2.2 ml/min (20% acid) |
| Immediate acid | 220 | 100% acid requirement at |
| | | time 0 |
| Acid only | 0 | 1 ml/min (20% acid) |

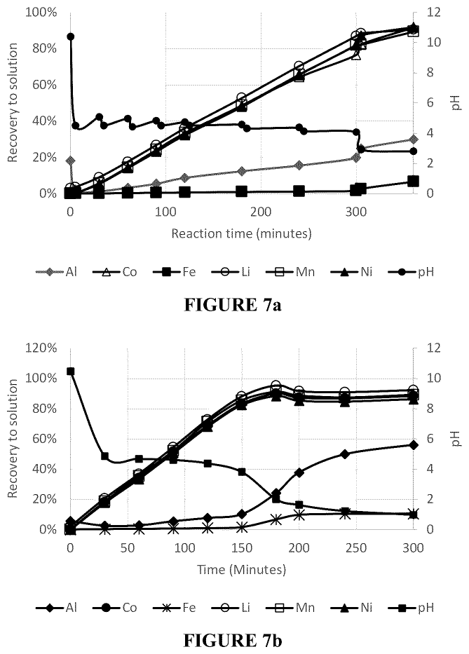

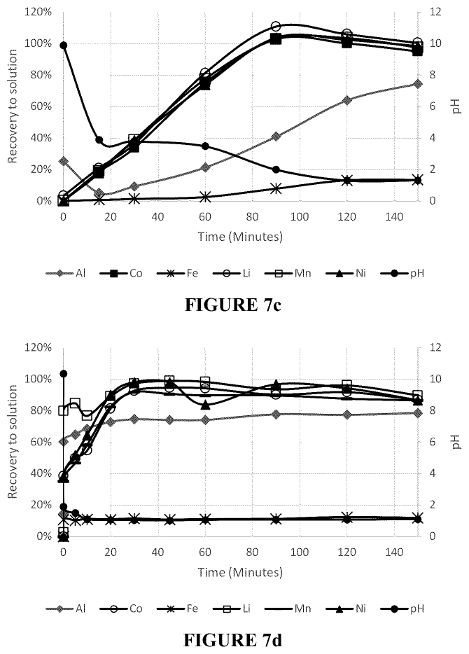

The solution recoveries for the tests summarised in Table 9 are presented in FIGS. 7a-7d. Comparing FIGS. 7a-7d with FIG. 6d, the addition of H₂SO₄ in any capacity resulted in significantly improved recovery and kinetics.

The stepwise addition of acid (FIG. 7a) with 100% stoichiometric SO₂ in 2.5 hours, resulted in recovery improving from 50% in five hours to over 80% in five hours. For this experiment, a sixth hour was included, before which a large dose of acid was added to bring the pH to below 3. The resulted in an immediate spike in both Co and Ni recovery (5%). Over this final hour, recovery increased up to 90% for all target metals, indicating the system is still limited by acid.

In the slow continuous acid test (FIG. 7b), acid was fed via a peristaltic pump to deliver 100% of the stoichiometric acid requirement in 200 minutes with 100% stoichiometric SO₂ in 2.5 hours. This test resulted in greater than 90% recovery of target metals in 180 minutes. Recovery did not significantly change after this point indicating a finished reaction. It should be noted that this recovery value was based on the solution assays and that analysis of the solids indicated that in reality the recoveries were above 98% for this test. Therefore, the leaching extents in the graphs are biased low as the calculated head from the final solution and final solids assay should be more accurate.

In the fast continuous test (FIG. 7c), both acid flowrate and SO₂ addition were increased to supply 100% of the stoichiometric requirement in 90 minutes. It was found that approximately 100% of all target metals were extracted in 90 minutes under these conditions. While there was little change in the target metal recovery after this point, the impurity elements continued to be recovered. At 90 minutes, 40% of aluminium and 10% of iron were recovered to solution, after 2.5 hours this had increased to 60% and 15% respectively. This shows that there is no benefit to further increasing the reaction time beyond the time required to give 100% of the reagents. Comparing the recovery of impurities in this test (FIG. 7c) to the slow acid test (FIG. 7b) revealed that there is some gain in selectivity at the slower addition rate. Maximum recovery was achieved in 150 minutes at the slow rate. At this point only 10% Al and 2% Fe had been recovered. Comparing this to the fast addition at 90 minutes shows an approximately 6 fold increase in impurity recovery.

FIG. 7d shows the results of the immediate acid test. In this experiment, 100% of the stoichiometric acid requirement was added at the start of the experiment with stoichiometric addition of SO₂ being achieved in 30 minutes. It was found that just adding all of the acid was sufficient to recover 35-40% of Ni, Mn and Co as well as 90% of the Li. These recoveries increased to above 90% for all metals within 30 minutes. After 30 minutes, there is a slow decline in all target metals down to 85-90% recovery over the 2.5 hour reaction time. At the 60 minute point there was an acute drop in the nickel. This point is believed to be an outlier caused by an error in dilution. Aluminium was recovered rapidly to 60% after acid addition and this value increased gently overtime up to a maximum of 78%. Iron recovery was consistent after acid recovery at 10-11%. This shows a roughly comparable selectivity to the fast continuous acid test but with significantly increased kinetics.

A final test (Reference Example) was completed with only acid and no SO₂ (FIG. 7e). It was found that after five hours only 30-40% of Ni, Mn and Co were recovered with 80% recovery of Li. These results correspond with the recoveries achieved in the immediate acid test before SO₂ had been added. This shows that for the BMK samples, approximately 40% of Ni, Mn and Co are soluble with no reducing agent.

### Results—Effect of Solids Concentration

One experiment was conducted to investigate the impact of higher solids concentration on reaction extent and kinetics. Higher solids concentration was chosen to be investigated as it will result in a more concentrated leach solution. This will increase the efficiency of downstream impurity separation as well as reducing the required reactor volumes given a set throughput. In this test, BMK solids were reacted at 55° C. at 20% solids concentration. Acid was added continuously at conditions comparable to the fast continuous acid test (2.9 ml/min 50% H₂SO₄, 290 ml/min SO₂). 50% H₂SO₄ was used in this experiment to prevent overflow from the reactor. This higher acid strength caused excessive heating of the solution, increasing temperature to approximately 75° C. in the first half hour. After this the reactor was relocated to a cooled water bath and the temperature remained constant at approximately 45° C. Due to this, the influence of solids concentration and temperature cannot be completely deconvoluted and this must be kept in mind when interpreting the results.

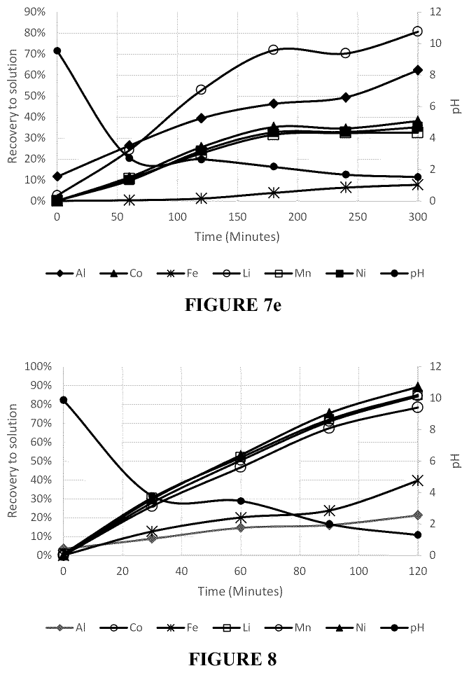

FIG. 8 shows the results of the experiment conducted at 20% solids with fast continuous reagent conditions. It was found that compared to the equivalent test at 5% solids, the overall recovery and the reaction kinetics were reduced, achieving only 80% recovery after two hours. However, the recoveries were trending upwards when the experiment had to be concluded and thus it is expected that complete dissolution at 20% solids is possible.

### Results—Effect of Reaction Temperature

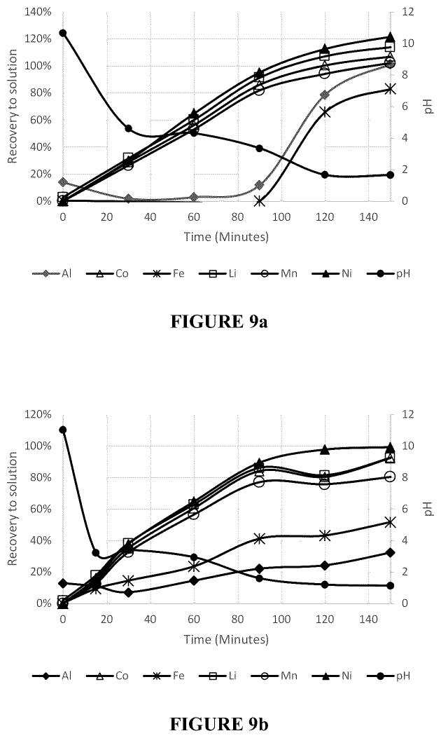

Two experiments were conducted to investigate the impact of temperature on reaction extent and kinetics. Higher temperatures were investigated in an attempt to further improve the reaction kinetics by increasing the rate of dissolution. BMK solids were reacted at 75° C. at 5% solids concentration. Acid was added continuously at conditions comparable to the fast continuous acid test (2.2 ml/min 20% H₂SO₄, 52 ml/min SO₂). It should be noted that the values exceeding 100% are displayed in FIG. 9a but are most likely due to evaporation. Due to an error in recording masses through the experiment, an estimation of the mass loss due to evaporation was not possible.

Lower temperatures were investigated in an attempt to further improve the reaction kinetics by increasing the solubility of SO₂ gas into solution. BMK solids were reacted at room temperature at 5% solids concentration. Over the course of the experiment, the temperature naturally raised to between 30° C. and 35° C. Acid was added continuously at conditions comparable to the fast continuous acid test (2.2 ml/min 20% H₂SO₄, 52 ml/min SO₂). It should be noted that the values exceeding 100% are displayed in FIG. 9b but are most likely due to evaporation. Due to an error in recording masses through the experiment, an estimation of the mass loss due to evaporation was not possible.

As seen in FIG. 9a, increasing reaction temperature resulted in decreased performance compared to the equivalent test at 55° C. At 75° C., recovery, selectivity and kinetics were all adversely impacted by the increase in reaction temperature. The inventors believe that this is likely due to the decreased SO₂ solubility resulting in slower reduction of the metals. Similarly, reducing the reaction temperature also had an adverse effect on the recovery and the kinetics. At 35° C., reactions times of between 120-150 minutes were required to achieve above 90% recovery for all target metals.

### Precipitation

### Removal of Impurities by Ion Exchange (IX)

A feed solution with composition set out below was contacted with a Lewatit® VP OC 1026 macroporous ion exchange resin (based on a styrene divinylbenzol copolymer containing di-2-ethylhexyl phosphate (D2EHPA); the resin is available from Lanxess, Cologne).

| | Al | Ca | Co | Cu | Fe | Mg | Mn | Na | Ni | Zn |
|---|---|---|---|---|---|---|---|---|---|---|
| Concentration | 4.9 | 8.3 | 6,357 | 1.8 | 0 | 54.1 | 7,992 | 63.7 | 9,853 | 38.9 |
| (mg/L) | | | | | | | | | | |

The contact with the ion exchange resin was performed at 40° C. in two stages. pH control was done using 0.1 M H₂SO₄ and 1M NaOH before IX contact, with a target pH of 3.8-3.9. The resin was acid washed with 10% H₂SO₄ and then conditioned to pH 3.5 before use. The additions in the following paragraph below are given in volume of resin as received, accounting for mass changes during washing.
7. 250 mL of filtrate was added to a bottle and pH controlled down to 3.9.
8. 120 mL resin was added, the bottle sealed, and placed in a bottle roller for 24 hours at 40° C.
9. The resin was filtered out and the solution added to a clean bottle.
10. pH was adjusted up to 3.8.
11. 120 mL resin was added, the bottle sealed, and placed in a bottle roller for 4 hours at 40° C.
12. The resin was filtered out and the solution recovered.

Based on previous ion exchange (IX) tests, two contacts in series at 40° C. with minimal pH control were chosen to maximise Zn removal and minimise Mn loss. Tables 10 and 11 show the results of the solution assays before and after each contact. The dilution corrected assays take into account the solution held up in the resin from washing and conditioning. Both contacts showed excellent Zn removal (87% and 91%) compared to previous trials while Mn losses were not completely mitigated (15% and 16%). Some Al and Ca were also removed (cumulative 29% and 32% respectively) with Fe going into IX being <1 mg/L.

TABLE 10
Concentration of various metals during ion exchange treatment

| | pH | Al | Ca | Co | Cu | Mg | Mn | Na | Ni | Zn |
|---|---|---|---|---|---|---|---|---|---|---|
| | mg/L | | | | | | | | | |
| Before 1st IX | 3.89 | 6 | 11 | 7,088 | 2 | 67 | 8,937 | 71 | 11,450 | 43 |
| After 1st IX | 1.67 | 5 | 9 | 7,163 | 2 | 68 | 7,640 | 72 | 11,198 | 6 |
| (dilution | | | | | | | | | | |
| corrected) | | | | | | | | | | |
| Before 2nd IX | 3.80 | 5 | 8 | 6,400 | 2 | 60 | 6,803 | 1,161 | 9,972 | 5 |
| After 2nd IX | 1.86 | 4 | 7 | 6,365 | 2 | 61 | 5,712 | 1,176 | 9,891 | 0.4 |
| (dilution | | | | | | | | | | |
| corrected) | | | | | | | | | | |
| After 2nd IX | 1.86 | 4 | 6 | 5,850 | 2 | 56 | 5,250 | 1,081 | 9,090 | 0.4 |
| (actual) | | | | | | | | | | |

TABLE 11
Ion exchange results, percentage of various metals on resin

| % on resin | Al | Ca | Co | Cu | Mg | Mn | Na | Ni | S | Zn |
|---|---|---|---|---|---|---|---|---|---|---|
| 1st IX | 18% | 17% | 0% | 2% | 0% | 15% | 0% | 2% | 0% | 87% |
| 2nd IX | 12% | 18% | 1% | 0% | 0% | 16% | 0% | 1% | 1% | 91% |
| Cumulative | 29% | 32% | 1% | 0% | 0% | 28% | 0% | 3% | 1% | 99% |

Removal of Impurities from a Feed Solution

This experiment summarises the investigations into the impurity removal from a synthetic solution. A synthetic solution was used to ensure repeatability and ample sample size. This solution created to mimic the solution concentration and pH of a solution produced during leaching. The major parameters that were investigated in this report were the pH and base type.

It is demonstrated that by increasing the pH to 6.2, 100% of the aluminium, copper, chromium, iron and zinc impurities could be removed from solution. It was found that by pH 5-5.5, all aluminium, chromium and iron were removed as well as the majority of the copper. Zinc was not significantly precipitated until pH 6 where 95% of the zinc and all remaining copper were lost. Increasing the pH to 6.2 removed the remaining zinc resulting in a solution free of impurities (excepting Ca and Mg). In order to reach the calculated solution specifications, pH 6.2 was required. Increasing the pH to 6.2 resulted in losses of approximately 25% Ni, 15% Co and 10% Mn.

Three different base types were trialled. Sodium hydroxide and sodium carbonate produced almost identical results. All impurities were precipitated at the same pH and losses of the target metals were consistent for both bases. However, using sodium carbonate resulted in significantly better filtration properties for the produced solids. Using a combination of manganese carbonate and basic nickel carbonate produced similar results to sodium carbonate. However, it was found that the manganese carbonate did not completely dissolve which resulted in wasted manganese. For this reason, it is recommended that sodium carbonate be used as the base for impurity removal.

There was a clear opportunity to conduct the impurity removal in two stages. Firstly at pH 5.5 the majority of solution impurities could be removed. This solid material could then be separated from the solution and disposed of as waste. The good filtration properties of the carbonate solids makes rapid and easy separation of the solids feasible. Following this stage the partially purified solution should contain only trace amounts of copper as well as zinc as impurities. Increasing the pH to above 6 (ideally to 6.2), would enable the remaining copper and the zinc to be rejected from the solution. This would also result in losses of nickel, cobalt and manganese making this solid stream of high value. This material could be collected and returned to the SAL leach to recover the copper and remove the zinc impurity from the system. This concept was demonstrated at the laboratory scale by including a solid/liquid separation between the two desired pH levels (5.5 and 6.2). it was found that by including the solid liquid separation, the losses of cobalt, nickel and manganese could be constrained to 5%, 10% and 0%, respectively.

The results presented herein highlight the potential for removing ion exchange from the process. The results of this experiment show that a solution of high purity can be produced through precipitation alone, removing the need for the expensive ion exchange process.

### Introduction

Based on the known pH dependence on the solubility of metal hydroxides, it was considered that it would be possible to remove hydroxides selectively from the solution. The impurities that were considered were iron, aluminium, copper and calcium. However, assay of black mass samples has shown that it may include magnesium and zinc. The tested parameters in this work were pH and base type.

### Materials and Methods

### Materials

Reagents used in this work were all reagent grade with the exception of the food grade SO₂. The chemicals used and the target concentration in the stock solution are shown in Table 12.

TABLE 12
Stock solution concentrations

| Chemical used | Target metal concentration (g/l) |
|---|---|
| NiSO₄•6H₂O | 15 |
| CoSO₄•7H₂O | 5 |
| MnSO₄•H₂O | 5 |
| Li₂SO₄ | 3 |
| Al₂(SO₄)₃•16H₂O | 0.5 |
| FeSO₄•7H₂O | 0.5 |
| CuSO₄•5H₂O | 0.5 |
| CaSO₄ | 0.2 |
| ZnSO₄•7H₂O | 0.2 |
| MgSO₄•7H₂O | 0.2 |
| CrCl₃•6H₂O | 0.05 |
| SO₂ | Saturated |
| H₂SO₄ | Adjust pH |
| NaOH | Adjust pH |

The solution concentrations were chosen to be representative of a solution produced through leaching of black mass. The impurity elements were dosed in to simulate a higher than expected impurity concentration. The pH was initially lowered to a target value of 1. This was overshot to approximately pH 0.5. However, this starting pH was too low and resulted in volume issues during the precipitation tests. To combat this, NaOH was used to increase the pH to 2.6. SO₂ was then sparged into the reactor until the solution was saturated to better mimic the solution produced during leaching. Following this pH was once again increased to 2.6.

### Equipment

All reactions were completed in a 1.1 L baffled glass reactor. Temperature was maintained by a hot plate with thermocouple feedback control. Agitation was achieved by an overhead stirrer set to 800 RPM with a high-shear Teflon impellor. Gas was sparged using a glass sparging rod connected to a gas flowmeter to control the gas addition rate. Care was taken to ensure the sparger was submerged to a consistent level that was in line with the blades of the impellor to ensure maximum gas dispersion during the reaction. pH was controlled using a Methrohm automatic titrator that is connected to a high temperature pH probe and a PID program run through a connected laptop.

### Methodology

The required amount of stock synthetic solution was first weighed directly into the reactor and the reactor was heated to reaction temperature. Once at reaction temperature, an initial sample was taken and cooled to room temperature in a sealed syringe. Once cool, the sample was syringe filtered and diluted in nitric acid with excess sample being returned to the reactor. The air sparge and the hose from the titrator were then inserted into the reactor and reagent dosing and timing was commenced. Samples were taken at time intervals predetermined by the experiment following the same sample taking methodology.

Once the experiment was completed, the reactor was weighed and the slurry was centrifuged for hydroxide samples or vacuum filtered for carbonate samples. The wet solids were then dried overnight at 105° C. and the solution was stored in a glass bottle. Density readings were taken before and after reaction.

To determine if an experiment successfully achieved the required solution purity, a set of solution target concentrations were calculated. These targets are presented in Table 13 and were calculated assuming 100% transfers to the final precipitated NMC product.

TABLE 13
Solution concentration targets.

| | Al* | Cr* | Cu | Fe | Zn* |
|---|---|---|---|---|---|
| NMC specification | 50 | 10 | 50 | 50 | 50 |
| solution target with | 3.2 | 0.6 | 3.2 | 3.2 | 3.2 |
| 5% solids in leaching | | | | | |
| solution target with | 6.7 | 1.3 | 6.7 | 6.7 | 6.7 |
| 10% solids in leaching | | | | | |
| solution target with | 20.1 | 4.0 | 20.1 | 20.1 | 20.1 |
| 25% solids in leaching | | | | | |

*based on an assumption

### Results

### Effect of pH

### Test Conditions and Justification

pH is a critical parameter for determining the separation efficiency of the impurity elements from the target metals. To investigate the impact of pH an automatic titrator was used to dose base (2.5M NaOH) into the stock solution to maintain the solution at the target pH. A sample was taken once this target pH was reached and after this pH had been held for 1 hour. After the second sample, the pH controller was adjusted to the next level and the process was repeated. Temperature was held at a constant 75° C. throughout each experiment. Three experiments were conducted in this way, the results of the most conclusive test are displayed in this report with others being referenced for specific points.

### Results and Discussion

Based on visual observations and the trends in base dosage and pH, the first precipitation began to occur at pH 3.6-4. After holding the solution at pH 4 for one hour, over 90% of the Fe and almost all Al and Cr were removed from solution. Further increasing the pH to 5 resulted in complete removal of Fe, Al and Cr and 65% removal of Cu impurity. To completely remove Cu, the solution had to be increased to pH 6 at which point 94% of the Zn was also removed. In order to meet the zinc solution specification outline in Table 11, the pH had to be increased to 6.2. However, at pH 6.2 there was associated losses of 110% cobalt, 21% nickel and 7% manganese. Increasing the pH above this point resulted in the loss of over 90% of the nickel, 80% of the cobalt and 40% of the manganese. It was seen that major pH buffering occurred at approximately pH 6.4. Therefore, this represents the upper limit that should never be exceeded in order to reduce losses of the target metals.

Additionally, it was revealed that rapid base dosage to pH 5 resulted in increased nickel losses at lower pH. With fast base addition, 15% of the nickel co-precipitated with the impurity elements. Therefore, the recommendation is to increase the pH slowly over a period of 2 hours to pH 5.5. This should be held for 1 hour to maximise copper precipitation. The solution should then be increased to pH 6.2 and immediately separated from the solution. This is based on the observation that the zinc and copper specifications are met at this point and further holding at pH 6.2 only increases losses of nickel, cobalt and manganese.

### Effect of Base Type

### Test Conditions and Justification

Using a similar method to what was described in the previous section, two additional tests were conducted to investigate alternate bases. Sodium carbonate is an ideal candidate for replacing NaOH as the base used in impurity removal as it is equally available but typically cheaper to source. Additionally, the carbonate anion may allow for additional impurity removal benefits compared to hydroxide.

The second alternate base that was investigated is the combination of sodium carbonate with solid manganese carbonate and basic nickel carbonate (BNC). These chemicals are cheaper and possibly available onsite, representing an opportunity for reducing reagent costs. For this test, an amount of manganese carbonate and BNC were added as solids such that the final solution after impurity removal would have a 6:4:2 Ni:Mn:Co ratio to reflect ongoing developments in the NMC precipitation unit. This represents the theoretical maximum amount of these compounds which should be added as anymore would requiring dosing of expensive cobalt salts. The metal salts were added at time 0 and given 1 hour to react. After this point sodium carbonate was added to further adjust pH as per the other experiments.

### Results and Discussion

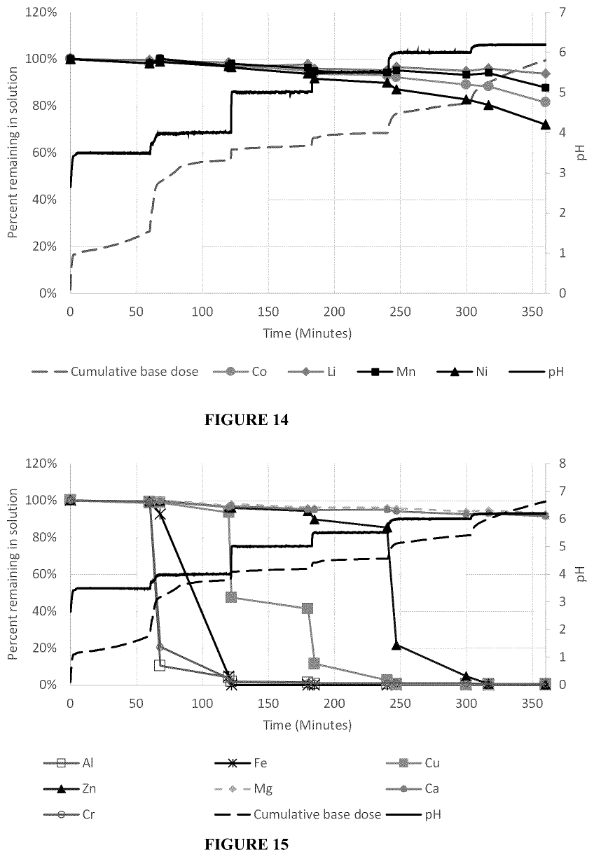

Comparing the results shown in FIGS. 14 and 15 to the NaOH results shows that there is no significant difference between the two base types. Table 14 shows a comparison of the major points of consideration between the two bases. This shows that impurity elements were removed at the same stages when using Na₂CO₃ compared to NaOH. Even the amount of target metals lost after precipitation was consistent. It can therefore be concluded that precipitation is occurring as a result of pH increase and the carbonate anion does not improve the precipitation. However, it is important to note that Na₂CO₃ has strong advantages in materials handling. The solids formed during carbonate precipitation settle and filter significantly easier than those produced from hydroxide precipitation.

TABLE 14
Comparison of NaOH and Na₂CO₃ base types.

| | NaOH | Na₂CO₃ |
|---|---|---|
| Al pH | 5-5.5 | 5-5.5 |
| Cr pH | 5 | 5 |
| Cu pH | 6 | 6 |
| Fe pH | 5 | 5 |
| Zn pH | 6.2 | 6.2 |
| Co loss | 11-17% | 12-19% |
| Ni loss | 21-31% | 20-28% |
| Mn loss | 7-11% | 6-12% |

pH values list the point at which all specifications from Table 11 had been met

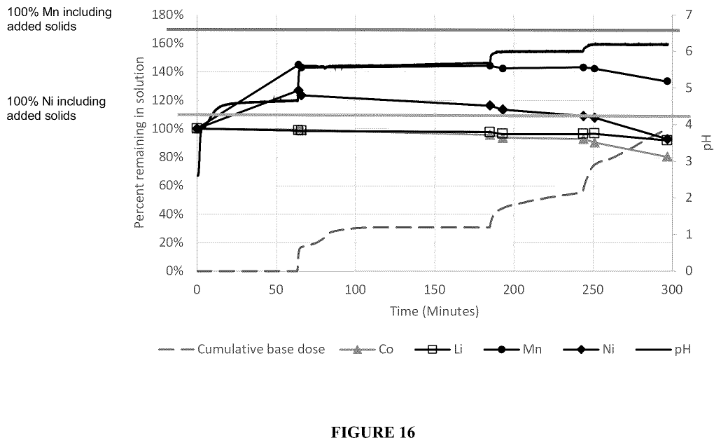

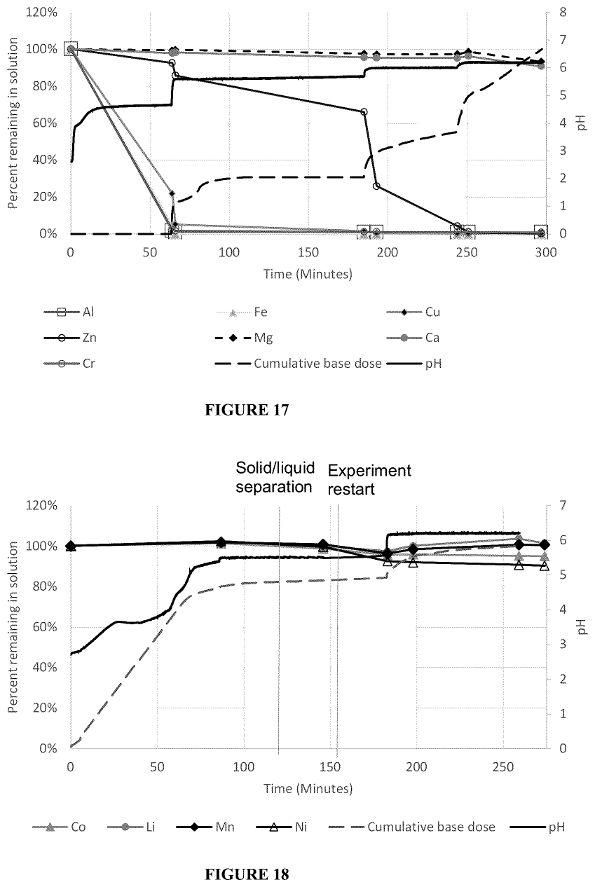

The addition of MnCO₃ and BNC resulted in no benefit compared to the Na₂CO₃ only test (see FIGS. 16 and 17). Impurity rejection was achieved at the same pH and to the same level. However, it should be noted that the MnCO₃ did not completely dissolve which indicates that it is limited in its ability to act as a base in this situation. BNC dissolution resulted in greater than 100% recovery of nickel which indicates that the assumption that the BNC was present at tetra-hydrate was erroneous. It can be assumed that all BNC dissolved and in theory it could be used as a base if the molar ratios allow for additional nickel to be added to the system prior to NMC precipitation.

### Effect of Two Stage Precipitation

Based on the results of the Na₂CO₃ and NaOH precipitation experiments, there appears to be an opportunity to split the unit into two operations at two pH levels. By first precipitating at pH 5.5, all Al, Cr and Fe can be removed along with approximately 90% and 10% of the Cu and Zn, respectively. This can be achieved with minimal losses of the target metals. Following this, a solid\liquid separation could be used to remove the unwanted low value waste material. The solution can then be increased to pH 6.2 where the remaining Cu and Zn can be removed. This was accompanied by approximately 30% loss of Ni, 20% loss of Co and 10% loss of Mn. This material has high value and could be collected and recycled to earlier points in the process.

To test this concept, an experiment was conducted where the pH was slowly increased to 5.5 over the course of approximately 1.5 hours using 200 g/l Na₂CO₃ solution. It was then held at this pH for 1 hour before being vacuum filtered. The clean solution was then reheated and base dosing was resumed to achieve a pH of 6.2. This was held for 1 hour before final solid/liquid separation.

### Results and Discussion

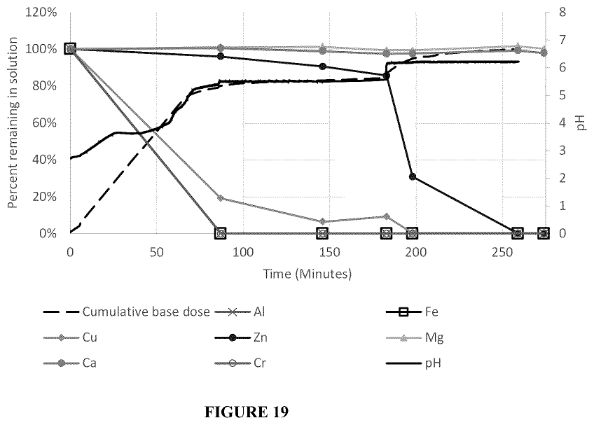

In contrast to the expected result, it was observed that significantly less material precipitated at pH 6.2 when the solid\liquid separation had been completed between the two stages. This observation was supported by the results presented in FIGS. 18 and 19. From these results it is clear that including the solid/liquid separation resulted in significantly better retention of Ni, Co and Mn without compromising impurity removal. The results of this test relative to the single stage Na₂CO₃ test are shown in Table 15.

TABLE 15
Comparison of NaOH and Na₂CO₃ base types. pH values list the
point at which all specifications from Table 11 had been met

| | Na₂CO₃ | Na₂CO₃ 2 stage |
|---|---|---|
| Al pH | 5-5.5 | 5.5 |
| Cr pH | 5 | 5.5 |
| Cu pH | 6 | 6.2 |
| Fe pH | 5 | 5.5 |
| Zn pH | 6.2 | 6.2 |
| Co loss | 12-19% | 5% |
| Ni loss | 20-28% | 9% |
| Mn loss | 6-12% | 0% |

### Formation of Co-Precipitate

The purpose of this experiment is to explore NMC precipitation—Impurity precipitation as a function of pH tests. The objective is to identify a suitable pH range and solution conditions which NMC precursors can be precipitated to achieve the appropriate main element chemistry (Ni/Co/Mn) while being selective against the impurities Ca and Mg. It was found that the weakly alkaline pH range pH 7.6-8.0), the majority of impurity ions (Ca²⁺ and Mg²⁺) will not co-precipitate with NMC precursors. The results suggest that this approach is feasible to produce NMC precursors, by adjusting the initial NMC composition in solution, alkaline type and amounts.

### Experimental

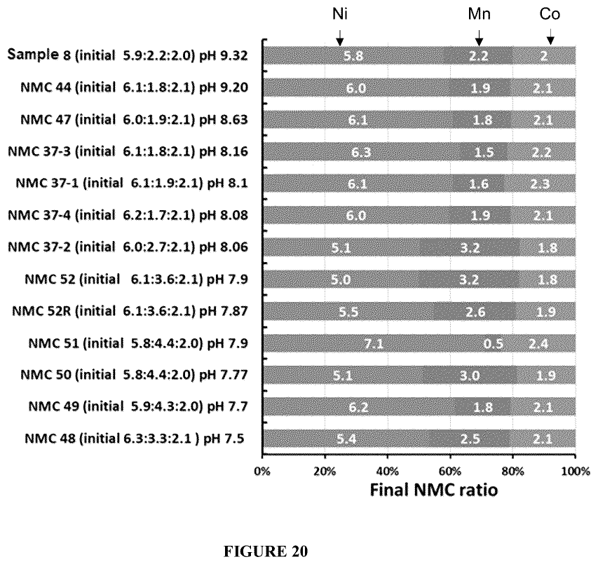

500 mL of NMC initial solution (0.2-0.24 M of total NMC, see FIG. 20 for specific samples) was fed by peristaltic pumping at a rate of 8 m/min into 1 L reactor containing 200 mL of ammonium solution (0.1 M). After 3 minutes, 480 mL of alkaline solution (0.20-0.24 M) is pumped into the same reactor at the same flowrate. At the end of 60 minutes, all the remaining liquors were pumped into the reactor. A hotplate was used to heat this reactor to 80° C. under an inert gas (N₂) atmosphere. An overhead mechanical stirrer at 800 rpm was used to vigorously mix in the 1 L reactor during the pumping transition metals and alkaline solution (1 hour). Then, stirring rate stays at 800 rpm for next 4 hours until 5:00 pm. For safety reason, the stirring rate during after hours was set up at 600 rpm for 15-16 hours. The total precipitation time is in a range of 20-21 hours. After that, the reactor was cooled down from 80° C. to room temperature. The final slurry was filtered by vacuum filtration to get obtain the precipitate. The final solution pH for different samples are listed in FIG. 20. The obtained precipitate was washed in two-stages. The first wash involves repulping the precipitate into 0.1 M NaOH solution (˜5% solid content) using magnetic stirring at 80° C. for 60 min, after which solid/liquid separation was done by vacuum filter. The second washing is to repulp the precipitate from the first washing into 2% NH₃H₂O solution (˜5% solid content) using magnetic stirring at 80° C. for 60 min, after which solid/liquid separation was done by vacuum filter to obtain the final NMC precursor solid. Then, NMC precursors were dried in the oven at 105° C. for 8-10 hours to separate free moisture. After drying, the precipitate is sent for coin cell battery preparation following lithiation. The final NMC ratio in the precursor are listed in FIG. 20.

Except for the sample 8 prepared by authentic leach solution, all the NMC 44-52 samples were prepared by the synthetic initial NMC solution, dissolving analytical grade of nickel, cobalt and manganese sulphates into DI water. Some of these synthetic initial NMC solution contain 20 mg/L Ca and 200 mg/L Mg.

The chemical compositions of NMC initial solutions contained 0.2-0.24 M of total Ni+Co+Mn (NMC). The molar NMC ratio in the NMC initial solution is specified in Y-axis labels of FIG. 20. For example, “NMC 44 (initial 6.1:1.8:2.1) pH 9.20” in FIG. 20 indicates that the initial NMC ratio in this NMC initial solution (NMC 44 sample) is 6.1:1.8:2.1. In addition, when precipitation finished, the final solution pH was equal to 9.20 for “NMC 44 (initial 6.1:1.8:2.1) pH 9.20” in FIG. 20.

### Results and Discussion

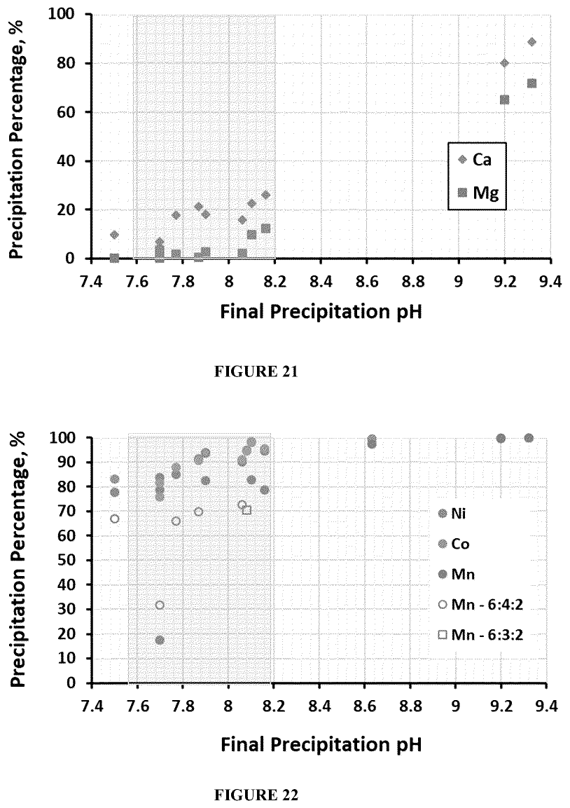

FIG. 21 shows that the precipitation extent of Ca²⁺ and Mg²⁺ (from an initial feed solution concentration of 50 and 200 mg/L respectively) increase rapidly at alkaline pH regions (8.1-9.3) to maximum 88.6% of Ca and 71.4% of Mg at pH 9.3, while the precipitation percentages of Ca²⁺ (5-18%) and Mg²⁺ (1-3%) stay low at pH<8.

FIG. 22 shows that precipitation percentages of Ni²⁺, Co²⁺ and Mn²⁺ are quite high (98-100%) when final pH >8.6. In the weakly alkaline pH region (8-8.2), the precipitation percentages of Ni²⁺ and Co²⁺ are still quite similar in the range 90-100%, while the precipitation percentage of Mn²⁺ is relatively lower than those of Ni²⁺ and Co²⁺ which makes it complex to precipitate the right chemical composition of NMC622. Specifically, the precipitation percentage of Mn²⁺ decreased from ˜80% to ˜70% when the initial Mn²⁺ concentration increased from C_{Mn}=0.02M (initial 6:2:2) to C_{Mn}=0.04M (initial 6:3:2) and 0.06M (initial 6:4:2). In the slightly alkaline pH region (7.6-8.0), the precipitation percentages of Ni²⁺ and Co²⁺ are still similar in the range 80-90%, while the precipitation percentage of Mn²⁺ is around 70% at initial C_{Mn}=0.06M (initial 6:4:2). Note that the initial concentration of Mn was varied throughout the tests to try and achieve the correct final Mn concentration in the precipitate.

There are some outlier data points for Mn precipitation percentages shown in FIG. 22. For example, at pH=7.9 (NMC 52 sample), the precipitation percentage of Mn²⁺ reached 94% which is similar to the values of Ni²⁺ and Co²⁺. This outlier is attributed to Mn oxidation from +2 to +4 by air during NMC precipitation process without N₂ gas protection (the depletion of N₂ gas cylinder). Another repeated test (NMC 52-R sample, see in Table 10) with N₂ gas protection during NMC precipitation led to the ˜70% of Mn²⁺ precipitation percentage at pH=7.87. The result confirmed this hypothesis. Further battery performance tests for NMC 52 and NMC 52-R may reveal that if N₂ protection during NMC precipitation is essential for battery performance, because the literature suggests that N₂ protection during NMC precipitation is necessary. Other outlier data at pH=7.7 is attributed to a leak in the precipitation reactor.

The results in FIGS. 21 and 22 provide guidance as to how to prepare the initial NMC solution with higher Mn²⁺ concentrations to finally achieve the co-precipitated NMC precursors with the right compositions of commercial products at slight alkaline pH region (7.6-8.0), where the precipitation percentages of Ca²⁺ and Mg²⁺ remain low.

FIG. 20 reveals the relationship between NMC ratio in initial solution and NMC ratio in final solid at different precipitation pH. The NMC ratio in the initial solution varied from NMC 6:2:2 to 6:3:2 and 6:4:2, since the precipitation percentage of Mn²⁺ is lower than those values of Ni²⁺ and Co²⁺ in the slight and weakly alkaline pH regions (pH 7.6-8.0), discussed in FIG. 22. For experimental practice, it is difficult to keep the exact NMC ratio initially by using the analytical metal sulphate salts with different hydration numbers. Therefore, Y-axis in FIG. 20 shows the exact initial NMC ratios corresponding to NMC 6:2:2, 6:3:2 and 6:4:2, the sample names and corresponding final precipitation pH, while X-axis in FIG. 20 shows the final NMC ratio in the solid NMC precursors. The results show that several NMC precursors were produced, matching the commercial NMC 622 composition including sample 8 (pH 9.32), NMC 44 (pH 9.2), NMC 47 (pH 8.63), NMC 37-4 (pH 8.08), NMC 49 (pH 7.7). There are also many NMC precursors, the final NMC ratio of which match the commercial NMC 532 including NMC 37-2 (pH 8.06), NMC 52 (pH=7.9) and NMC 50 (pH 7.77).

### Preparation of Battery Material

The purified solution from leach process has been used to precipitate NMC 622 precursor. The specific NMC co-precipitation conditions are provided in the experimental section below. After that, the obtained precursor was lithiated and calcined to produce NMC 622 cathode material. The battery performance of this NMC 622 cathode material can match the commercial NMC 622 cathode material.

### Experimental—NMC Precipitation Procedure

Specifically, the leach solution of the leach process (Sample 8-leach), the purified solution (Sample 8—purification) and the final solution (Sample 8-final) are listed in Table 16. To meet the chemical composition of NMC 622 precursor, the extra Ni and Mn sulphate salts were added into the purified solution (Sample 8—purification) to generate the Sample 8-final solution that is directly used for NMC precipitation.

TABLE 16
Solution assay for the solution (Leach, Purification and Final solution)

| mg/L | Al | Ca | Co | Cu | Fe | K | Mg | Mn | Na | Ni | S | Zn |
|---|---|---|---|---|---|---|---|---|---|---|---|---|
| Sample 8- | 47.5 | 3.8 | 5561 | 51.2 | 65.4 | 8.6 | 26.7 | 6958 | 30.8 | 10254 | 16204 | 137.1 |
| leach | | | | | | | | | | | | |
| Sample 8- | 3.7 | 6.1 | 5850 | 1.9 | 0 | 7.5 | 55.8 | 5250 | 1081.1 | 9090 | 15123 | 0.4 |
| purification | | | | | | | | | | | | |
| Sample 8- | 3.7 | 6.1 | 5850 | 1.9 | 0 | 7.5 | 55.8 | 5250 | 1081.1 | 9090 | 15123 | 0.4 |
| final | | | | | | | | | | | | |

500 mL of NMC initial solution (0.2 M of total NMC) was fed by peristaltic pump at a rate of 8 m/min into 1 L reactor containing 200 mL of ammonium solution (0.1 M). At the end of 3 minutes, 480 mL of alkaline solution (0.208 M) began to be pumped into the same reactor at the same flowrate. At the end of 60 minutes, all the liquors were pumped into the reactor. The overhead mechanical stirrer at 800 rpm was used to mix in the 1 L reactor. Hotplate was used to heat this reactor to 80° C. under the inert N₂ atmosphere. The precipitation residence time is in a range of 8-10 hours.

After that, the reactor was cooled down from 80° C. to room temperature. The final slurry was filtered by the vacuum filtration to get the precipitate. The final solution pH (or terminal pH) is 9.32. The obtained precipitate went through two-stage washing. The first washing is to repulp the precipitate into 0.1 M NaOH solution (˜5% solid content) using magnetic stirring at 80° C. for 60 min, after which solid/liquid separation was done by vacuum filter. The second washing is to repulp the precipitate from the first washing into 2% NH₃H₂O solution (˜5% solid content) using magnetic stirring at 80° C. for 60 min, after which solid/liquid separation was done by vacuum filter to obtain the final NMC precursor solid. Then, NMC precursors were dried in the oven at 105° C. for 8-10 hours, which can be sent to battery preparation. The final NMC ratio in the precursor is 5.8:2.2:2.1, which is in the range of 6:2:2. Analysis is provided in Table 17.

TABLE 17
NMC precipitation extents and solid analysis of NMC precursor before and after washing (Impurity contents
measured by parts per million (ppm); Ni, Co, Mn contents measured by weight percentage, wt %)

| | Precipitation | | | | | | | | | | | | |
|---|---|---|---|---|---|---|---|---|---|---|---|---|---|
| | Cons | Al | Ca | Co | Cu | Fe | K | Mg | Mn | Na | Ni | S | Zn |
| Solution | NMC | n/a | 88.64% | 100.0% | n/a | n/a | n/a | 71.40% | 99.93% | n/a | 99.98% | 4.72% | n/a |
| Assay | Precipitation | | | | | | | | | | | | |
| | extent, % | | | | | | | | | | | | |
| Solid | no wash | n/a | 298.2 | 10.7% | 0 | 0 | 0 | 934.3 | 12.% | 1172.9 | 31.5% | 10735.5 | 0 |
| Assay | (Sample | | | | | | | | | | | | |
| | 8-final) | | | | | | | | | | | | |
| | 1st wash | n/a | 337.3 | 12.5% | 0 | 0 | 0 | 1071.4 | 14.0% | 416.6 | 36.5% | 2182.5 | 0 |
| | (Sample | | | | | | | | | | | | |
| | 8-final) | | | | | | | | | | | | |
| | 2nd wash | n/a | 317.4 | 12.4% | 0 | 0 | 0 | 1051.5 | 13.8% | 357.1 | 35.9% | 1984.1 | 0 |
| | (Sample | | | | | | | | | | | | |
| | 8-final, | | | | | | | | | | | | |
| | final | | | | | | | | | | | | |
| | product) | | | | | | | | | | | | |

Final NMC ratio in solid -
5.8:2.2:2.1

### Results—Battery Performance

The NMC precursors obtained by the foregoing methods are then lithiated to prepare the NMC active. The precursors are first mixed with the 5 wt. %-excess stoichiometry ratio of Li₂CO₃ as the lithium source. Regarding the calcination process, the mixture is firstly precalcined at a low temperature of 400-500′C for 1 hour, ground again and then calcined at a high temperature of 850-900′C for 10 hours under the air atmosphere. The cathode is prepared by dispersing the NMC active (80 wt. %), carbon black (10 wt. %) and polyvinylidene fluoride (10 wt. %) in N-methy-2-pyrrolidinone. Then the slurry is plastered on aluminium foil, followed by drying at 100° C. for 24 hours. The electrolyte used is LiPF₆ (1 M) in EC/DMC (a mass ratio of 1:1). The cells are then packaged in an argon-filled glove box using a lithium metal anode, and the electrochemical performances of these cells are tested in the voltage range of 3.0-4.4 V.

The battery performance of Sample 8 cathode at 0.2 C show that the initial specific capacity of Sample was around 163 mAh/g (Baseline: 170 mAh/g) and the capacity remained more than 163 after 6 cycles in Table 18. The battery performance is comparable to the commercial NMC 622 batteries, the capacities of which is in the range of 165-170 mAh/g at the same charge-discharge rate. Sample cathode also shows good crystalline structure with hexagonal ordering and low Ni—Li mixing.

TABLE 18
The battery performance of for three individual
battery using Sample 8 cathode at 0.2 C

| Sample\Cycle | 1 | 2 | 3 | 4 | 5 | 6 |
|---|---|---|---|---|---|---|
| 8-Cell 1 | 161.8 | 163.5 | 161.1 | 163.2 | 162.3 | 162.1 |
| 8-Cell 2 | 162.7 | 163.8 | 163.6 | 163.7 | 164.7 | 164.2 |
| 8-Cell 3 | 164.8 | 166.1 | 163.6 | 164.4 | 163.2 | 162.6 |
| Average | 163.1 | 164.5 | 162.8 | 163.8 | 163.4 | 163.0 |

### Example 3: Precipitation in the Presence of Impurities

Mixed precipitates containing nickel, manganese and cobalt (NMC) were produced from a variety of solutions, in the presence of a broad range of impurities. The methodology utilised was able to avoid the precipitation of part or all of the present impurities and despite the presence of these impurities in the initial solution, produce a co-precipitate with electrochemical properties.

Tables 19-32 include the aqueous feed solution and supernatant following co-precipitation ratios from a series of NMC precipitation trials. In interpreting these values, it should be noted that it is a ratio of NMC: impurity and thus the smaller the number the higher the level of impurity with respect to NMC. Therefore a ratio decreasing after precipitation is proof of selectivity. The results shown in the tables therefore demonstrate selectivity for the respective element.

TABLE 19
Al

| Test ID | initial ratio | final ratio |
|---|---|---|
| Test 3 | 13521 | 1861 |
| Test 4 | 12134 | 122 |
| Test 5 | 5190 | 60 |
| Test 6 | 354598 | 11630 |
| Test 7 | 51189 | 16121 |
| Test 9 | 218.775 | 182 |

TABLE 20
Ca

| Test ID | initial ratio | final ratio |
|---|---|---|
| Test 2 | 192 | 94 |
| Test 3 | 260 | 85 |
| Test 4 | 258 | 10 |
| Test 5 | 1269 | 9 |
| Test 6 | 87 | 4 |
| Test 7 | 138 | 59 |
| Test 8 | 292 | 111 |
| Test 9 | 141 | 9 |
| Test 10 | 132 | 5 |

TABLE 21
B

| Test ID | initial ratio | final ratio |
|---|---|---|
| Test 6 | 39400 | 1454 |
| Test 8 | 2651 | 955 |
| Test 9 | 3282 | 130 |

TABLE 23
Cu

| Test ID | initial ratio | final ratio |
|---|---|---|
| Test 1 | 15412.4286 | 14572 |
| Test 2 | 898.6875 | 8396 |
| Test 3 | 1502.33333 | 232.625 |
| Test 4 | 6067 | 122 |

TABLE 24
Fe

| Test ID | initial ratio | final ratio |
|---|---|---|
| Test 3 | 6760.5 | 930.5 |
| Test 4 | 12134 | 122 |
| Test 7 | 51189 | 16121 |

TABLE 25
K

| Test ID | initial ratio | final ratio |
|---|---|---|
| Test 1 | 35962.3 | 1821.5 |
| Test 2 | 845.8 | 839.6 |
| Test 5 | 1427.1 | 5.8 |
| Test 8 | 171.4 | 61.9 |
| Test 9 | 3.3 | 0.1 |
| Test 10 | 1712.7 | 6.6 |

TABLE 22
Cr

| Test ID | initial ratio | final ratio |
|---|---|---|
| Test 6 | 39400 | 11630 |
| Test 7 | 25595 | 16121 |

TABLE 26
Li

| Test ID | initial ratio | final ratio |
|---|---|---|
| Test 8 | 8615 | 3341 |
| Test 10 | 7.96 | 0.30 |

TABLE 27
Mg

| Test ID | initial ratio | final ratio |
|---|---|---|
| Test 1 | 53944 | 14572 |
| Test 2 | 65 | 19 |
| Test 3 | 60 | 19 |
| Test 4 | 56 | 1 |
| Test 5 | 601 | 9 |
| Test 6 | 35 | 1 |
| Test 7 | 51 | 20 |
| Test 8 | 0.2 | 0.1 |
| Test 9 | 53 | 2 |
| Test 10 | 133 | 5 |

TABLE 28
Na

| Test ID | initial ratio | final ratio |
|---|---|---|
| Test 2 | 138.3 | 2.1 |
| Test 3 | 139.4 | 0.8 |
| Test 4 | 181.1 | 0.0 |
| Test 5 | 2.9 | 0.0 |
| Test 6 | 555.8 | 0.1 |
| Test 7 | 1137.5 | 0.9 |
| Test 9 | 354.8 | 0.1 |
| Test 10 | 5.3 | 0.0 |

TABLE 29
P

| Test ID | initial ratio | final ratio |
|---|---|---|
| Test 7 | 12797.3 | 2303.0 |
| Test 9 | 1381.7 | 20.6 |

TABLE 30
Pb

| Test ID | initial ratio | final ratio |
|---|---|---|
| Test 2 | 14379 | 8396 |
| Test 10 | 2570 | 90 |

TABLE 31
Si

| Test ID | initial ratio | final ratio |
|---|---|---|
| Test 6 | 4488.6 | 505.7 |
| Test 7 | 2132.9 | 1074.7 |
| Test 9 | 1640.8 | 56.8 |

TABLE 32
S

| Test ID | initial ratio | final ratio |
|---|---|---|
| Test 1 | 1.69 | 0.52 |
| Test 2 | 1.71 | 0.51 |
| Test 3 | 1.76 | 0.58 |
| Test 4 | 1.70 | 0.04 |
| Test 5 | 1.19 | 0.00 |
| Test 9 | 1.45 | 0.06 |
| Test 10 | 0.76 | 0.03 |

Table 33 shows the concentration (as a ratio of NMC:element) in an aqueous feed solution (i. e. prior to co-precipitation) of awide range of elements. This table also includes the battery testing, proving that these solutions were capable of producing an acceptable co-precipitate with electrochemical performance.

TABLE 33

| Sample | Test | | | | | | | | | |
|---|---|---|---|---|---|---|---|---|---|---|
| name | 1 | 2 | 3 | 4 | 5 | 6 | 7 | 8 | 9 | 10 |
| Ag | | | | | | 74035 | | | 13127 | |
| Al | 8299 | 7190 | 13521 | 12134 | 2854 | 444210 | 51189 | | 219 | |
| As | | | | | | 148070 | | | 3282 | |
| Ba | | | | | | | | | | |
| B | | | | | | 49357 | 3413 | 2651 | 3282 | |
| Bi | | | | | | 222105 | 51189 | | | |
| Ca | | 192 | 260 | 258 | 1269 | 108 | 138 | 292 | 141 | 132 |
| Cd | | | | | | | | | 74 | |
| Cr | | | | 12134 | 16310 | 49357 | 25595 | | 215 | |
| Cu | 15412 | 899 | 1502 | 6067 | 114170 | | | | 31 | |
| Fe | | 1598 | 6761 | 12134 | | | 51189 | 34460 | 60 | |
| K | 35962 | 846 | 15023 | | 1427 | | | 171 | 3 | 1712 |
| Li | | 14379 | 135210 | | | | | 8615 | | 8 |
| Mg | 53944 | 65 | 60 | 56 | 601 | 43 | 51 | 0 | 53 | 133 |
| Mo | | | | | | 444210 | | | | |
| Na | | 138 | 139 | 181 | 3 | 696 | 1138 | | 355 | 5 |
| P | 107887 | | 13521 | | 11417 | | 12797 | 11487 | 1382 | 2570 |
| Pb | 107887 | 14379 | | 12134 | | 12692 | 10238 | 17230 | 2387 | |
| Sb | | | | | | 148070 | | | 26253 | |
| Se | | | | | | 11105 | 10238 | 34460 | 6563 | |
| Si | | | | | | 5623 | 2133 | 204 | 1641 | |
| Sn | | | | | | 14807 | 10238 | 34460 | 13127 | |
| S | 2 | 2 | 2 | 2 | 1 | 2 | 2 | 0.1 | 1 | 1 |
| Ti | | 14379 | | | | | | | | |
| V | | | | | | 444210 | | | 205 | |
| W | | | | | | 444210 | | | | |
| Zn | | 7190 | | | 11417 | 111053 | | 3829 | | 2569 |
| Zr | | | | | | | | | 142 | |
| Initial | 177 | 164 | 131 | 138 | 161 | 163 | 141 | 75 | 95 | 128 |
| battery | | | | | | | | | | |
| capacity | | | | | | | | | | |
| (mAh/g) | | | | | | | | | | |

### Example 4: Commercial Scale

The co-precipitation process was demonstrated at commercial scale. Table 34 details the starting solution concentration (aqueous feed solution concentration) and the associated ratio with respect to nickel for each of the elements.

TABLE 34

| | concentration (mg/l) | Ni:element |
|---|---|---|
| Al | 0.4 | 16522.7 |
| Ca | 50.7 | 133.7 |
| Cd | 0.1 | 112905.0 |
| Co | 2006.1 | 3.4 |
| Cr | 0.9 | 7527.0 |
| Cu | 2.1 | 3256.9 |
| Fe | 1.0 | 6983.8 |
| K | 16.9 | 401.3 |
| Li | 52.2 | 129.7 |
| Mg | 348.0 | 19.5 |
| Mn | 5813.7 | 1.2 |
| Na | 16742.6 | 0.4 |
| Ni | 6774.3 | 1.0 |
| P | 10.5 | 646.4 |
| Pb | 4.3 | 1575.4 |
| S | 21155.8 | 0.3 |
| Zn | 12.9 | 527.2 |

This solution was co-precipitated using a sub-stoichiometric volume of sodium carbonate as a precipitating agent. The use of the sub-stoichiometric base was used to prevent the majority of Ca and Mg from precipitating during this process. This methodology resulted in precipitation extents of Ni, Mn and Co to be 95%, 80% and 95% respectively. Therefore, an additional amount of Mn had to be included in the starting solution to produce an on-specification material.

The co-precipitate from this process was subjected to a series of water and alkali washing steps to remove Na and S. The final resulting mother liquor and washed solid assays are shown in Table 35.

TABLE 35

| | Final solution (mother | Final solid |
|---|---|---|
| | liquor) concentration (mg/l) | concentration (ppm) |
| Moisture | | 64.9 |
| % | | |
| Al | 0.4 | 0.9 |
| As | | |
| Ca | 20.1 | 65.8 |
| Cd | 0.1 | 1.7 |
| Co | 197.4 | 34747.8 |
| Cr | 0.5 | 1.8 |
| Cu | 1.1 | 13.1 |
| Fe | 1.3 | 9.4 |
| K | 129.9 | 0.0 |
| Li | 6.5 | 0.0 |
| Mg | 123.9 | 131.6 |
| Mn | 638.8 | 36097.2 |
| Na | 13606.5 | 86.7 |
| Ni | 453.3 | 112718.0 |
| P | 13.1 | 13.7 |
| Pb | 2.6 | 1.8 |
| S | 11698.2 | 307.9 |
| Sc | | |
| Zn | | 3.9 |

Based on these final solution and solid compositions a clear separation can be seen between NMC and impurity elements such as Ca, Mg, Al, Cu, Cr, Fe, K, Na, P and S. This result, demonstrated at the industrial scale highlights one methodology detailed in the patent for precipitating NMC in the presence of impurities with selectivity for NMC over part or all of the impurity element. This material was lithiated, calcined and formed into a battery.

This battery displayed electrochemical performance and achieved 163 mAh/g as an initial capacity.

### Example 5: Commercial Scale

The process as described in Example 4 was repeated with the inclusion of an aging process during NMC precipitation. Table 36 details the starting concentration and the associated ratio with respect to nickel.

TABLE 36

| | concentration (mg/l) | Ni:element |
|---|---|---|
| Al | 0.3 | 95851.5 |
| As | 0.7 | 44550.7 |
| Ca | 498.1 | 63.5 |
| Cd | 0.2 | 131795.8 |
| Co | 10065.6 | 3.1 |
| Cr | 0.5 | 67300.0 |
| Cu | 2.8 | 11378.1 |
| Fe | 0.1 | 316310.0 |
| K | 4.5 | 7029.1 |
| Li | 0.1 | 316310.0 |
| Mg | 1305.8 | 24.2 |
| Mn | 10930.1 | 2.9 |
| Na | 20541.9 | 1.5 |
| Ni | 31631.0 | 1.0 |
| P | 2.4 | 13403.0 |
| Pb | 0.1 | 316310.0 |
| S | | |
| Sc | 0.1 | 316310.0 |
| Zn | 0.5 | 67300.0 |

This solution was co-precipitated with a stoichiometric base and no excess of Mn. At the end of co-precipitation, the solution was aged in tank for 48 hours. This had the benefit of re-dissolving some of the precipitated Mg, increasing the separation efficiency of Mg and Ni. Additionally, such a method also enables a greater degree of control over the precipitation extent of Mg that has often been added to NMC products as a dopant to improve cycle stability. The composition of the product produced from this process is shown in Table 37. This material was lithiated, calcinated and formed into a battery for electrochemical testing. Battery testing resulted in an initial capacity of 170 mAh/g.

TABLE 37

| | Final solid concentration (ppm) |
|---|---|
| Al | 0 |
| Ca | 794 |
| Co | 121825 |
| Mg | 496 |
| Mn | 111508 |
| Na | 60 |
| Ni | 349603 |
| S | 1587 |
| Zn | 198 |

### Example 6: Processing a Ni-Laterite Ore to Directly Make NMC

### Leaching:

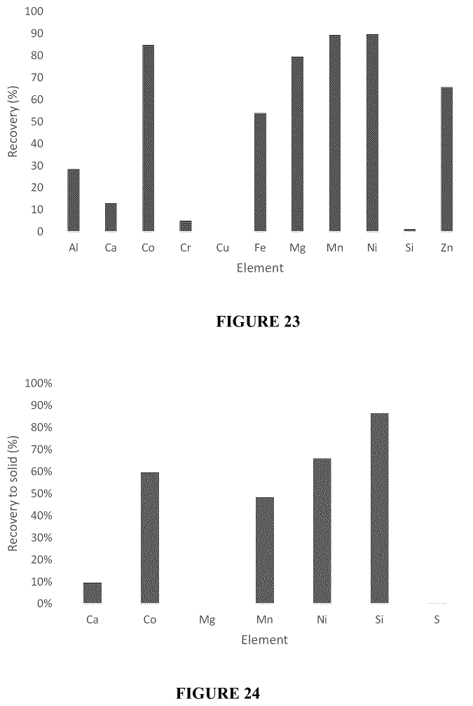

A nickel laterite ore sample was leached using sulphuric acid to produce a solution suitable for direct production of NMC precursor material. The assay of the material used is shown in Table 38. The leaching conditions used were 1:1 Mg: H₂SO₄ by mole, 10% dry solids loading, 6 hours at 80° C. Following leaching, 90% of the nickel, 80% of the magnesium and variable amounts of the impurity elements were recovered to the solution. The recoveries of all major elements are presented in FIG. 23 and the composition of the leaching solution is displayed in Table 39.

TABLE 38
Nickel laterite elemental composition

| Element | | | | | | |
|---|---|---|---|---|---|---|
| (wt. %) | Al | Ca | Co | Cr | Cu | Fe |
| Average | 0.320 | 0.083 | 0.04 | 0.810 | 0.004 | 6.910 |

| Element | | | | | |
|---|---|---|---|---|---|
| (wt. %) | Mg | Mn | Ni | Si | Zn |
| Average | 19.200 | 0.108 | 1.278 | 19.651 | 0.011 |

TABLE 39
Laterite ore leach solution composition

| Element | | | | | | | | | | | |
|---|---|---|---|---|---|---|---|---|---|---|---|
| (Mg/L) | Al | Ca | Co | Cr | Cu | Fe | Mg | Mn | Ni | Si | Zn |
| Leach | 101 | 12 | 40 | 46 | 4 | 4120 | 16910 | 95 | 1272 | 293 | 8 |
| solution | | | | | | | | | | | |

### Impurity Removal:

The pH of the solution was then used to remove impurities down to the level required to use selective co-precipitation. This was achieved by heating the filtrate obtained from the previous leaching step and increasing the pH using sodium carbonate solution. Air was sparged into the reactor to oxidise iron to promote precipitation as ferric iron. A single state was insufficient for this so a second step was conducted with 30% H₂O₂ as an oxidant. Following this the solids were separated from the purified solution. The experimental conditions used were: 75° C. at pH 5.5 held for 1 hour, 200 g/L Na₂CO₃ as the base, air and 30% H₂O₂ added as oxidant in stage 2. The composition of the final purified solution is illustrated in Table 40.

TABLE 40
Solution composition after purification

| Element | | | | | | | | | | |
|---|---|---|---|---|---|---|---|---|---|---|
| (Mg/L) | Al | Ca | Co | Cr | Cu | Fe | Mg | Mn | Ni | Zn |
| Purified | 0.3 | 12.4 | 28.5 | 0 | 0.1 | 2.4 | 15380 | 75.5 | 677.9 | 1.7 |
| solution | | | | | | | | | | |

### NMC Co-Precipitation:

Prior to NMC precipitation, the concentration of Ni was increased to 2 g/L and the cobalt and manganese were adjusted such that the solution had a 6:4:2 Ni: Mn: Co molar ratio. This ratio adjustment was done using sulphate salts. The NMC precipitation was completed according to the following procedure: 6 hours of dosing 15% Na₂CO₃ followed by and overnight hold. Repeated a second time; 75° C.; final pH 7.39. The solution concentrations of major elements before and after this process is shown in Table 41.

TABLE 11
Solution concentration before and after NMC precipitation

| Element (Mg/L) | Ca | Co | Mg | Mn | Ni |
|---|---|---|---|---|---|
| Adjusted solution | 11.8 | 542 | 15150 | 744 | 2160 |
| prior to precipitation | | | | | |
| Final solution after | 12 | 357 | 16710 | 59.2 | 920 |
| co-precipitation | | | | | |

The co-precipitate was washed using a three-step washing process that includes a water displacement wash, a water repulp wash, a sodium hydroxide repulp wash and a weak ammonia wash. The overall recovery of each major element after the completed process is shown in FIG. 24. The composition of the final solids produced is shown in Table 42. These results clearly demonstrate a high selectivity for NMC of Ca/Mg even in cases where Mg concentration is significantly larger than NMC metals. This would enable low grade sources of NMC metals such as laterites to be used directly for making NMC.

TABLE 42
Solution concentration before and after NMC co-precipitation

| Element (wt %) | Ca | Co | Mg | Mn | Ni |
|---|---|---|---|---|---|
| Final washed solid | 0.03% | 11.90% | 0.05% | 11.85% | 42.81% |

### Battery Test Results:

Three cathodes were prepared from the NMC co-precipitate sample. The resulting initial capacity was 75 mAh/g with a capacity retention after 20 cycles of 84%.

### Example 7: Processing a Mixed Sulphide Product Ore to Directly Make NMC

### Leaching:

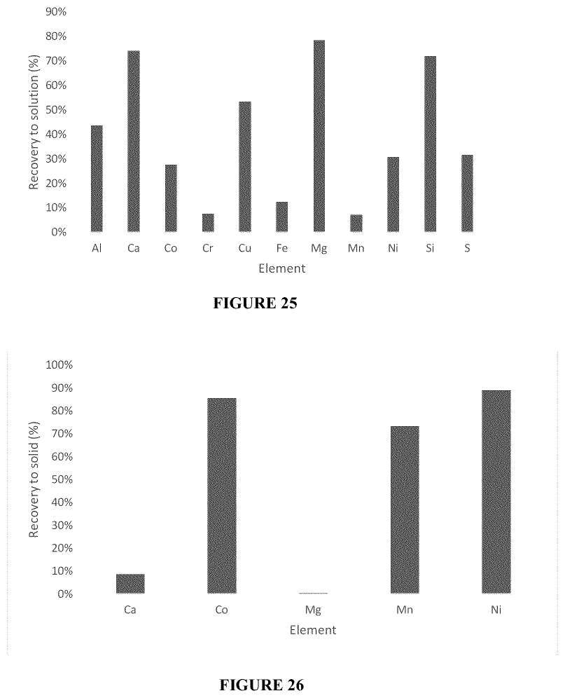

A sulphide concentrate sample was leached using sulphuric acid and air to produce a solution suitable for direct production of NMC precursor material. The assay of the material used is shown in Table 43. The experimental conditions used were: 80° C., 4 days, 10% dry solids loading, H₂SO₄ dosed to maintain pH at 2, air flowrate of 0.5 L/min. Following leaching, 30% of the nickel and variable amounts of the impurity elements were recovered. The recoveries of all major elements are presented in FIG. 25 and the composition of the leaching solution is displayed in Table 44.

TABLE 43
Elemental composition of the sulphide concentrate sample

| Element | | | | | | |
|---|---|---|---|---|---|---|
| (wt. %) | Al | Ca | Co | Cr | Cu | Fe |
| Sulphide | 0.14% | 0.18% | 0.39% | 0.01% | 0.46% | 39.90% |
| concentrate | | | | | | |

| Element | | | | | |
|---|---|---|---|---|---|
| (wt. %) | Mg | Mn | Ni | Si | S |
| Sulphide | 0.22% | 0.06% | 12.42% | 0.18% | 20.09% |
| concentrate | | | | | |

TABLE 44
Leach solution composition after sulphuric
acid leaching of the sulphide concentrate

| Element (mg/L) | Al | Ca | Co | Cr | Cu | Fe |
|---|---|---|---|---|---|---|
| Leach | 72.6 | 158.9 | 131.8 | 0.9 | 299 | 6020 |
| solution | | | | | | |

| Element (mg/L) | Mg | Mn | Ni | Si | S |
|---|---|---|---|---|---|
| Leach | 205.2 | 5.1 | 4656 | 154.1 | 7730 |
| solution | | | | | |

### Impurity Removal:

The pH of the solution was then used to remove impurities down to the level required to use selective co-precipitation. This was achieved by heating the filtrate obtained from the previous leaching step and increasing the pH using sodium carbonate solution. Air was sparged into the reactor to oxidise iron to promote precipitation as ferric iron. The experiment conditions used were: 75° C., pH increased sequentially from 3 to 4 to 5.3 to 6, 200 g/L Na₂CO₃ as the base, air sparged as oxidant.

### Nmc Precipitation:

Prior to NMC precipitation, the concentration of Ni was increased and the concentration of cobalt and manganese were adjusted such that the solution had a 6:3:2 Ni Mn: Co molar ratio. This ratio adjustment was done using high purity sulphate salts. The NMC precipitation was completed according to the following procedure: 6 hours of dosing 5% Na₂CO₃ followed by and overnight hold, 75° C., final pH 7.85. The solution concentrations before and after this process is shown in Table 45.

TABLE 45
Solution concentration before and after NMC precipitation

| Element (Mg/L) | Ca | Co | Mg | Mn | Ni | S |
|---|---|---|---|---|---|---|
| Adjusted solution | 104 | 852 | 116 | 1213 | 2799 | 44490 |
| prior to co- | | | | | | |
| precipitation | | | | | | |
| Final solution | 99 | 130 | 114 | 795 | 497.4 | 44050 |
| after co- | | | | | | |
| precipitation | | | | | | |

Following this, the co-precipitate was washed using a three-step washing process that includes a water displacement wash, a water repulp wash, a sodium hydroxide repulp wash and a weak ammonia wash. The overall recovery of each major element after the completed process is shown in FIG. 26. The composition of the final solids produced is shown in Table 46.

TABLE 46
Solid composition of final washed NMC solid

| Element (wt %) | Ca | Co | Mg | Mn | Ni |
|---|---|---|---|---|---|
| Final washed solid | 0.04% | 13.45% | 0.0% | 13.04% | 39.9% |

### Example 8: Leaching Example of a Mix Between Cobalt Concentrate and Black Mass

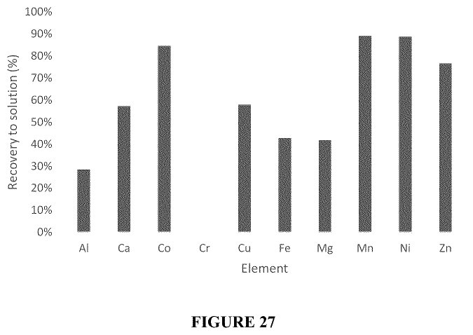

A 50% blend of cobalt concentrate and black mass was leached using SO₂ to produce a solution suitable for direct production of NMC. The assay of the material used is shown in Table 47. The experimental conditions used were: 55° C., 2 hours 40 minutes, 5% dry solids loading, SO₂ sparged to give 200% of the stoichiometric amount over 2 hours. Following leaching, 30% of the nickel and variable amounts of the impurity elements were recovered. The recoveries of all major elements are presented in FIG. 27 and the composition of the leaching solution is displayed in Table 48.

TABLE 47
Elemental composition of 50% cobalt concentrate
50% black mass blended sample

| Element (wt. %) | Al | Ca | Co | Cr | Cu |
|---|---|---|---|---|---|
| Blend | 0.2% | 0.0% | 11.6% | 0.0% | 0.2% |
| Element (wt. %) | Fe | Mg | Mn | Ni | Zn |
| Blend | 0.3% | 0.0% | 12.8% | 28.2% | 0.2% |

TABLE 48
Leach solution composition after sulphuric acid
leaching of blended cobalt concentrate/black mass

| Element (mg/L | Al | Ca | Co | Cr | Cu |
|---|---|---|---|---|---|
| Leach solution | 27.7 | 7.1 | 4104 | 0 | 30.9 |
| Element (mg/L | Fe | Mg | Mn | Ni | Zn |
| Leach solution | 48.2 | 4.8 | 4611 | 10923 | 43.5 |

Following this, the pH of the solution would be increased to 5.5 while sparging air. This condition should be held for at least one hour to allow sufficient time for Fe to precipitate. This process should be used to remove sufficient levels of impurities such as Al, Fe, Cu, Cr and Zn so that selective precipitation can be used. This solution should then have the molar ratios of Ni, Mn and Co adjusted to 6:2:2 at which point it would be suitable for the production of NMC.

### Example 9: Washing of a Co-Precipitate

Immediately following co-precipitation, the solids formed are subjected to a sequential washing procedure that can include water, basic (carbonate, hydroxide or ammonia) or acid washes. The exact washing regime chosen depends on the impurities present. In this example, an approximately 1 tonne batch of wet NMC was produced at the commercial scale. This was then subjected to a water washing at a rate of 60:1 water: dry solids by mass, followed by a caustic soda reslurry wash at 7% solids using 10% sodium hydroxide solution, followed by a final water wash at a rate of 40:1 water: dry solids by mass. The assays of this sequential procedure are displayed in Table 49. The washing steps are successful at removing some impurity elements and improving the NMC:impurity ratios for impurity elements such as Ca, Cu, K, Mg, Na, S and Zn.

TABLE 49

| | Moisture | | | | | |
|---|---|---|---|---|---|---|
| | (%) | Ca | Co | Cu | K | Li |
| Unwashed | 71.7 | 122 | 11170 | 5 | 36 | 1 |
| Water wash | 76.4 | 13 | 10723 | 4 | 0 | 1 |
| Caustic Wash | 79.6 | 43 | 11653 | 4 | 10 | 8 |
| Water wash | 77.7 | 55 | 11391 | 5 | 0 | 2 |
| | Mg | Mn | Na | Ni | S | Zn |
| Unwashed | 508 | 12206 | 15027 | 101992 | 22919 | 6 |
| Water wash | 45 | 12400 | 90 | 98753 | 9574 | 5 |
| Caustic Wash | 60 | 13426 | 999 | 104828 | 406 | 4 |
| Water wash | 64 | 13279 | 105 | 103858 | 258 | 4 |

Unless defined otherwise, all technical and scientific terms used herein have the same meaning as would be commonly understood by those of ordinary skill in the art to which this invention belongs.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method of producing a co-precipitate, the method comprising:
adjusting the pH of an aqueous feed solution comprising at least two metals and impurities, to a pH of between about 6.2 and less than 10, so as to provide a co-precipitate and a supernatant; and
separating the co-precipitate from the supernatant;
wherein:
the at least two metals are selected from nickel, cobalt and manganese;
the impurities are at least one selected from the group consisting of: arsenic, aluminium, barium, cadmium, carbon, calcium, magnesium, chromium, copper, lead, silicon, vanadium, lanthanum, lanthanides, actinium, actinides, titanium, fluorine, scandium, iron, zinc, zirconium, silver, tungsten, molybdenum, platinum, rubidium, tin, antimony, selenium, bismuth, boron, yttrium, and niobium or a combination thereof;
in the aqueous feed solution the mass ratio of the at least two metals to the impurities is less than 50,000:1;
the co-precipitate comprises:
nickel when present in the aqueous feed solution;
cobalt when present in the aqueous feed solution; and
manganese when present in the aqueous feed solution; and
the supernatant comprises at least one of said impurities; wherein the supernatant comprises more than 10 mg/L of nickel, cobalt or manganese.

2. The method of claim 1 wherein said impurities is at least one selected from the group consisting of: arsenic, aluminum, barium, cadmium, carbon, calcium, magnesium, chromium, copper, lead, silicon, vanadium, lanthanum, lanthanides, actinium, actinides, titanium, scandium, iron, zinc, zirconium, silver, tungsten, molybdenum, platinum, rubidium, tin, antimony, selenium, bismuth, boron, yttrium, and niobium or a combination thereof.

3. The method of claim 1 wherein the mass ratio in the aqueous feed solution of the at least two metals to the impurities is less than 5,000:1.

4. The method of claim 1 wherein the molar ratio of the at least two metals to alkaline earth metal impurities in the aqueous feed solution is less than 200:1.

5. The method of claim 1 wherein the molar ratio of the at least two metals to metal and metalloid impurities is less than 500,000:1.

6. The method of claim 1 wherein the pH of the feed solution is adjusted to between about 6.2 and 9.2.

7. The method of claim 1 wherein the feed solution comprises cobalt, manganese and nickel.

8. The method of claim 1 wherein prior to the step of adjusting the pH of the aqueous feed solution, the method comprises:
providing a feed mixture comprising at least one metal selected from nickel, cobalt and manganese, said feed mixture being defined as one of an oxidized feed, a reduced feed or an unoxidized feed, wherein:
an oxidized feed has more of the at least one metal in an oxidation state greater than 2 than in an oxidation state less than 2;
a reduced feed has more of the at least one metal in an oxidation state less than 2 than in an oxidation state greater than 2 or has substantially all of the at least one metal in an oxidation state of 2 and at least some of the at least one metal in the form of their sulfide; and
an unoxidized feed has substantially all of the at least one metal in an oxidation state of 2 and substantially none of the at least one metal in the form of their sulfide;
treating the feed mixture with an aqueous solution to form a leachate comprising said at least one metal, wherein the pH of the aqueous solution is such that the leachate has a terminal pH of between about 1 and about 6 and wherein:
if the feed mixture is an oxidized feed, the treating additionally comprises adding a reagent which comprises a reducing agent; and
if the feed mixture is a reduced feed, the treating additionally comprises adding a reagent which comprises an oxidizing agent;
whereby the leachate comprises at least one of nickel, cobalt and manganese in an oxidation state of 2,
wherein the leachate is used to provide the aqueous feed solution.

9. The method of claim 1, wherein the supernatant comprises more than 1000 mg/L of nickel, cobalt or manganese.

10. The method of claim 1 wherein prior to the step of adjusting the pH of the aqueous feed solution, the method comprises separating solid impurities from the feed solution using at least one separating technique selected from the group consisting of: decantation, centrifugation, filtration, cementation and sedimentation, or a combination thereof.

11. The method of claim 1 wherein prior to the step of adjusting the pH of the aqueous feed solution, the method comprises removing dissolved impurities from the feed solution using at least one separating technique selected from the group consisting of: ion exchange, precipitation, adsorption and absorption, or a combination thereof.

12. The method of claim 1 wherein prior to the step of adjusting the pH of the aqueous feed solution, the method further comprises adding one or more of cobalt, manganese and nickel to the feed solution to adjust the ratios of nickel, cobalt and manganese to provide a desired molar ratio in the co-precipitate.

13. The method of claim 12 wherein the desired ratio is 1:1:1 nickel:cobalt:manganese, 6:2:2 nickel:cobalt:manganese, 2:1:1 nickel:cobalt:manganese, 3:1:1 nickel:cobalt:manganese, 4:1:1 nickel:cobalt:manganese, 5:1:1 nickel:cobalt:manganese, 6:1:1 nickel:cobalt:manganese, 7:1:1 nickel:cobalt:manganese, 8:1:1 nickel:cobalt:manganese, 9:1:1 nickel:cobalt:manganese, 10:1:1 nickel:cobalt:manganese, 5:3:2 nickel:cobalt:manganese, 9:0.5:0.5 nickel:cobalt:manganese, or 83:5:12 nickel:cobalt:manganese.

14. The method of claim 1 wherein the step of separating the co-precipitate from the supernatant comprises decanting and/or filtering so as to isolate the co-precipitate.

15. The method of claim 14 comprising at least one step of washing the co-precipitate.

16. The method of claim 15 wherein the at least one step of washing is with an alkaline, water, acid or ammonia wash.

17. (canceled)

18. (canceled)

19. (canceled)

20. The method of claim 1, wherein the co-precipitate comprises:
(a) less than 10,000 ppm of alkaline earth metals, calculated on dry solids; or
(b) less than 10,000 ppm of metal and metalloid impurities, calculated on dry solids.

21. The method of claim 1, wherein the method further comprises scavenging the supernatant for remaining nickel and/or cobalt and/or manganese by precipitation and/or ion exchange.

22. The method of claim 1, wherein the step of adjusting the pH of the aqueous feed solution comprises adding a precipitation agent to the aqueous feed solution, wherein the precipitation agent is added in a sub-stoichiometric amount to the at least two metals.

23. The method of claim 1, wherein the method further comprises washing the co-precipitate, wherein at least 1% of the at least one of said impurities from the aqueous feed solution is present in the wash solution after the co-precipitate is washed.
